(19) United States
(12) Patent Application Publication
(10) Pub. No.: US 2025/0293835 A1
(43) Pub. Date: Sep. 18, 2025

(54) INTERFERENCE MEASUREMENT BY A NETWORK-CONTROLLED REPEATER

(71) Applicant: Lenovo (Singapore) Pte. Limited, Singapore (SG)

(72) Inventors: Majid Ghanbarinejad, Chicago, IL (US); Hyejung Jung, Northbrook, IL (US); Vijay Nangia, Woodridge, IL (US); Ahmed Hindy, Aurora, IL (US)

(73) Assignee: Lenovo (Singapore) Pte. Limited, Singapore (SG)

(21) Appl. No.: 18/860,303

(22) PCT Filed: Apr. 27, 2023
(86) PCT No.: PCT/IB2023/054331

§ 371 Date: Oct. 25, 2024

Related U.S. Application Data
(60) Provisional application No. 63/335,412, filed on Apr. 27, 2022.
(60) Provisional application No. 63/335,645, filed on Apr. 27, 2022.
(60) Provisional application No. 63/335,651, filed on Apr. 27, 2022.
(60) Provisional application No. 63/335,655, filed on Apr. 27, 2022.

(51) Int. Cl. H04L 5/00; H04B 7/06; H04B 17/309; H04B 17/318; H04W 88/12

(52) U.S. Cl. CPC H04L 5/0051; H04B 7/0626; H04B 17/328; H04B 17/346; H04W 88/12

(57) ABSTRACT

Various aspects of the present disclosure relate to a network-controlled repeater (NCR) that receives, from a base station, a first signaling indicating a reception beam and a first reference signal. The NCR receives a second reference signal from an interfering communication device, such as an interfering base station or user equipment (UE). The NCR performs a channel measurement on the first reference signal with the reception beam applied, and performs an interference measurement on the second reference signal with the reception beam applied. The NCR determines a signal strength comparison based on the channel measurement and the interference measurement, and transmits a second signaling as a report of the signal strength comparison to the base station.

### RELATED APPLICATIONS

This application claims priority to U.S. Provisional Application Ser. No. 63/335,412 filed Apr. 27, 2022 entitled “Interference Measurement By A Network-Controlled Repeater,” the disclosure of which is incorporated by reference herein in its entirety. This application also claims priority to U.S. Provisional Application Ser. No. 63/335,645 filed Apr. 27, 2022 entitled “Managing Interference with Network-Controlled Repeaters,” the disclosure of which is incorporated by reference herein in its entirety. This application also claims priority to U.S. Provisional Application Ser. No. 63/335,651 filed Apr. 27, 2022 entitled “Reducing Interference for Network-Controlled Repeaters,” the disclosure of which is incorporated by reference herein in its entirety. This application also claims priority to U.S. Provisional Application Ser. No. 63/335,655 filed Apr. 27, 2022 entitled “Interference Management with Network-Controlled Repeater,” the disclosure of which is incorporated by reference herein in its entirety.

### TECHNICAL FIELD

The present disclosure relates to wireless communications, and more specifically to managing interference from wireless communication devices.

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

A wireless communications system may include one or more wireless repeaters that receive and retransmit signals (e.g., from a base station or a UE). A wireless repeater extends the footprint or layout of cells in a cellular system for improving key performance indicators such as throughput and coverage. As a result, wireless repeaters may extend the cells beyond their originally planned boundaries.

### SUMMARY

The present disclosure relates to methods, apparatuses, and systems that support interference measurement by a network-controlled repeater (NCR). A device in a wireless communications system, such as a base station, UE, or NCR in one cell may transmit signals that interfere with signals transmitted in one or more neighboring cells. A device that transmits a signal that interferes with signals transmitted in another cell is referred to as an aggressor device and the cell that includes the aggressor device is referred to as an aggressor cell. A device whose signals are interfered with by an aggressor device is referred to as a victim device and the cell that includes the victim device is referred to as a victim cell. An entity in the aggressor cell can configure a communication indication reference signal (CIRS) associated with one or more communication elements (e.g., time-frequency resources, spatial relations, channels, signals, etc.). When the associated communication is going to be transmitted in the aggressor cell, the aggressor base station (e.g., a gNB) transmits the reference signal to indicate to nearby victim cells that there is an upcoming associated communication. The entities in the victim cell (e.g., gNB, UEs, NCRs) can measure the interference and determine whether and how much interference to expect on associated resources.

Using the described techniques, the NCR of the victim cell performs interference measurements on the reference signals, and/or a measuring entity collocated with the NCR performs the interference measurements. Accordingly, the NCR does not need to forward the reference signal to a measuring base station (e.g., gNB) or UE for measurement, which allows for less signaling overhead and more accurate measurements, while adding measurement and reporting capability to the NCR.

Some implementations of the method and apparatuses described herein may include wireless communication at an NCR (e.g., in a victim cell), and the NCR receives an indication of a reception beam and a first reference signal from a base station (e.g., in the victim cell). The NCR also receives a second reference signal from an interfering communication device, such as an interfering base station or interfering UE (e.g., in an aggressor cell). The NCR performs a channel measurement on the first reference signal with the reception beam applied, and performs an interference measurement on the second reference signal with the reception beam applied. The NCR determines a signal strength comparison based on the channel measurement and the interference measurement, and transmits a report of the signal strength comparison to the base station.

In some implementations of the method and apparatuses described herein, the NCR determines the signal strength comparison as a ratio of signal strengths associated with the first reference signal and the second reference signal. For example, the NCR determines the signal strength comparison as a signal-to-interference ratio (SIR), or as a signal-to-interference-plus-noise ratio (SINR). The NCR performs the channel measurement to determine a reference signal received power (RSRP) of the first reference signal, and performs the interference measurement to determine a RSRP of the second reference signal. The NCR transmits a channel state information (CSI) report of the signal strength comparison to the base station. In one or more implementations, the reference signal received from the base station is at least one of a synchronization signal/physical broadcast channel (SS/PBCH) block, a channel state information-reference signal (CSI-RS), or a sounding reference signal (SRS).

Some implementations of the method and apparatuses described herein may include wireless communication at a base station (e.g., in a victim cell), and the base station (e.g., a gNB) receives an indication of a reference signal and an associated communication element. The base station determines that the communication element potentially interferes with a user equipment (UE) communication via an NCR. The base station also determines a reception beam associated with the UE communication via the NCR, and transmits an indication of the reception beam to the NCR.

In some implementations of the method and apparatuses described herein with reference to the base station, the communication element is at least one of a plurality of time resources, a plurality of frequency resources, one or more spatial relations, a communication channel, or a reference signal. The plurality of time resources includes at least one of a plurality of orthogonal frequency division multiplexing (OFDM) symbols, a plurality of slots, or a time duration. The plurality of frequency resources includes at least one of a frequency band, a frequency sub-band, a carrier frequency, a component carrier, a bandwidth part, or a plurality of physical resource blocks (PRBs). Each of the one or more spatial relations includes at least one of a reference signal identifier (RS ID), a quasi-collocation (QCL) relationship with a reference signal as a source, a transmission configuration indication (TCI), or a spatial relation information parameter. The communication channel includes at least one of a physical downlink control channel (PDCCH), a physical downlink shared channel (PDSCH), a physical uplink control channel (PUCCH), or a physical uplink shared channel (PUSCH). The reference signal is at least one of a SS/PBCH block, a CSI-RS, or a sounding reference signal (SRS). In one or more implementations, the base station transmits a second reference signal to the NCR with an applied transmission beam associated with the UE communication, and receives a report from the NCR, indicating an estimate of a SINR based on an interference measurement on the reference signal and a channel measurement on the second reference signal. Alternatively, the base station transmits, to the UE, an indication for the UE to transmit a second reference signal to the NCR with an applied transmission beam associated with the UE communication, and the base station receives a report from the NCR, indicating an estimate of a SINR based on an interference measurement on the reference signal and a channel measurement on the second reference signal.

### BRIEF DESCRIPTION OF THE DRAWINGS

Various aspects of the present disclosure for interference measurement by an NCR are described with reference to the following Figures. The same numbers may be used throughout to reference like features and components shown in the Figures.

FIG. 1 illustrates an example of a wireless communications system that supports interference measurement by an NCR in accordance with aspects of the present disclosure.

FIG. 2 illustrates an example of interference through an NCR, as related to interference measurement by an NCR in accordance with aspects of the present disclosure.

FIG. 3 illustrates an example of a downlink signal in an aggressor cell causing downlink interference in a victim cell, as related to interference measurement by an NCR in accordance with aspects of the present disclosure.

FIG. 4 illustrates an example of a downlink signal in an aggressor cell causing downlink interference in a victim cell, and measurement by an NCR in the victim cell, as related to interference measurement by an NCR in accordance with aspects of the present disclosure.

FIG. 5 illustrates an example of an uplink signal in an aggressor cell causing uplink interference in a victim cell, as related to interference measurement by an NCR in accordance with aspects of the present disclosure.

FIG. 6 illustrates an example of an uplink signal in an aggressor cell causing uplink interference in a victim cell, and measurement by an NCR in the victim cell, as related to interference measurement by an NCR in accordance with aspects of the present disclosure.

FIG. 7 illustrates an example of a downlink signal in an aggressor cell causing uplink interference in a victim cell, as related to interference measurement by an NCR in accordance with aspects of the present disclosure.

FIG. 8 illustrates an example of a downlink signal in an aggressor cell causing uplink interference in a victim cell, and measurement by an NCR in the victim cell, as related to interference measurement by an NCR in accordance with aspects of the present disclosure.

FIG. 9 illustrates an example of an uplink signal in an aggressor cell causing downlink interference in a victim cell as related to interference measurement by an NCR in accordance with aspects of the present disclosure.

FIG. 10 illustrates an example of an uplink signal in an aggressor cell causing downlink interference in a victim cell, and measurement by an NCR in the victim cell, as related to interference measurement by an NCR in accordance with aspects of the present disclosure.

FIGS. 11-17 illustrate examples of systems that support managing interference with NCRs in accordance with aspects of the present disclosure.

FIGS. 18-25 illustrate examples of systems that support reducing interference for NCRs in accordance with aspects of the present disclosure.

FIGS. 26-31 illustrate examples of systems that support interference management with NCR in accordance with aspects of the present disclosure.

FIG. 32 illustrates an example block diagram of components of a device (e.g., a NCR) that supports interference measurement by an NCR in accordance with aspects of the present disclosure.

FIG. 33 illustrates an example block diagram of components of a device (e.g., a base station, gNB) that supports interference measurement by an NCR in accordance with aspects of the present disclosure.

FIGS. 34-36 illustrate flowcharts of methods that support interference measurement by an NCR in accordance with aspects of the present disclosure.

### DETAILED DESCRIPTION

Implementations of interference measurement by an NCR are described. A device in a wireless communications system that transmits a signal that interferes with signals transmitted in another cell is referred to as an aggressor device and the cell that includes the aggressor device is referred to as an aggressor cell. Similarly, a device whose signals are interfered with by an aggressor device is referred to as a victim device and the cell that includes the victim device is referred to as a victim cell. An entity in the aggressor cell can configure a CIRS associated with one or more communication elements (e.g., time-frequency resources, spatial relations, channels, signals, etc.). When the associated communication is going to be transmitted in the aggressor cell, the aggressor base station (e.g., a gNB) transmits the reference signal to indicate to nearby victim cells that there is an upcoming associated communication. The entities in the victim cell (e.g., gNB, UEs, NCRs) can measure the interference and determine whether and how much interference to expect on associated resources. In aspects of the described techniques in this disclosure, the NCR of the victim cell performs the interference measurements on the reference signals, and therefore does not need to forward the reference signal to a measuring base station (e.g., gNB) or UE for measurement, which allows for less signaling overhead and more accurate measurements, while adding measurement and reporting capability to the NCR.

While the cell footprint in a conventional cellular system is generally determined by system parameters, such as transmission power and beamforming, as well as environment factors such as buildings and obstacles, NCRs provide an additional degree of freedom to the service provider to change the footprint of a cell based on the number of NCRs and their position, their transmission power and beamforming, and other such adjustable parameters. An unintended consequence of changing the cell footprint is that the cell may then extend into the coverage area of another cell and cause excessive interference, which may not have been planned in an earlier deployment phase. Since the service provider may desire to add and remove NCRs without extensive planning each time, it is desired to enable the network to manage the interference dynamically through signaling, measurements, and taking interference mitigation actions during the operation. In the present disclosure, systems and methods are proposed for dynamic interference management among nearby cells, where NCRs may cause all or part of the interference in the aggressor cell, which may be used for interference measurements in the victim cell.

Aspects of the disclosure include an NCR (e.g., in a victim cell) that receives an indication of a reception beam and a first reference signal from a base station (e.g., in the victim cell). The NCR also receives a second reference signal from an interfering communication device, such as an interfering base station or interfering UE (e.g., in an aggressor cell). The NCR performs a channel measurement on the first reference signal with the reception beam applied, and performs an interference measurement on the second reference signal with the reception beam applied. The NCR can then determine a signal strength comparison based on the channel measurement and the interference measurement, and transmit a report of the signal strength comparison to the base station.

While a conventional radio frequency (RF) repeater presents a cost effective means of extending network coverage, it has its limitations. An RF repeater simply performs an amplify-and-forward operation without being able to take into account various factors that could improve performance. Such factors may include information on semi-static and/or dynamic downlink/uplink configuration, adaptive transmitter/receiver spatial beamforming, ON-OFF status, etc. An NCR is an enhancement over conventional RF repeaters with the capability to receive and process side control information from the network. Side control information can allow an NCR to perform its amplify-and-forward operation in a more efficient manner. Potential benefits could include mitigation of unnecessary noise amplification, transmissions and receptions with better spatial directivity, and simplified network integration.

Aspects of the present disclosure are described in the context of a wireless communications system. Aspects of the present disclosure are further illustrated and described with reference to device diagrams and flowcharts that relate to interference measurement by an NCR.

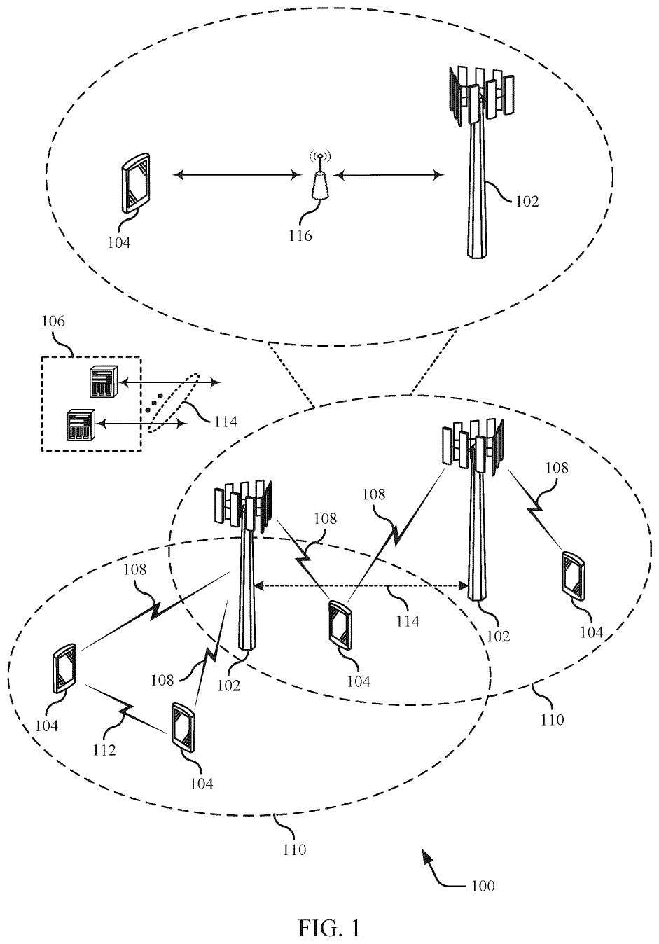

FIG. 1 illustrates an example of a wireless communications system 100 that supports interference measurement by an NCR in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to one or more implementations, the wireless communications system 100 includes a wireless repeater that is an NCR 116. It is to be appreciated that the wireless communications system 100 can include any number of NCRs 116. A base station 102 transmits and receives signals within a particular geographical distance or range, referred to as a cell. This distance or range, and thus the cell, can be extended using one or more NCRs. One or more of the NCRs 116 and base stations 102 are operable to implement various aspects of interference measurement by an NCR, as described herein. An NCR, also referred to as a smart repeater, is a repeater controlled by the network (e.g., controlled by a base station 102). For instance, in one or more implementations the NCR 116 is an analog repeater that is augmented with a side-control channel through which the NCR 116 can receive control signals from a serving base station 102 (e.g., a gNB) and apply information obtained from the control signals for beamforming, determining a direction of communication (downlink versus uplink), turning the analog relaying on and off, and so on. Multiple base stations 102 may also communicate with each other over the backhaul links 114 (e.g., via an X2, Xn, or another network interface) to exchange information associated with the wireless communications system 100 configuration and control signaling, and coordinate for interference management.

Coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable. As a result, new types of network nodes are considered to increase the flexibility of mobile operators for network deployments. For example, IAB was previously introduced as a new type of network node not requiring a wired backhaul. Another type of network node is the RF repeater to simply amplify-and-forward any signal that is received. RF repeaters are used in 2G, 3G, and 4G deployments to supplement the coverage provided by regular full-stack cells. The RF and electromagnetic compatibility (EMC) requirements are specified for RF repeaters for NR targeting both frequency range 1 (FR1) and frequency range 2 (FR2).

While an RF repeater presents a cost effective means of extending network coverage, it has its limitations. An RF repeater simply performs an amplify-and-forward operation without being able to take into account various factors that could improve performance. Such factors may include information on semi-static and/or dynamic downlink/uplink configuration, adaptive transmitter/receiver spatial beamforming, ON-OFF status, etc. An NCR is an enhancement over conventional RF repeaters with the capability to receive and process side control information from the network. Side control information can allow an NCR to perform its amplify-and-forward operation in a more efficient manner. Potential benefits could include mitigation of unnecessary noise amplification, transmissions and receptions with better spatial directivity, and simplified network integration.

In aspects of this disclosure, the following for NCRs is taken into consideration. NCRs are inband RF repeaters used for extension of network coverage on FRI and FR2 bands, while FR2 deployments may be prioritized for both outdoor and outdoor-to-indoor (O2I) scenarios. Other aspects are considered for only single hop stationary NCRs; the NCRs are transparent to UEs; and the NCRs can maintain the gNB-repeater link and repeater-UE link simultaneously. Cost efficiency is a consideration point for NCRs. In aspects of this disclosure, the following for NCRs is taken into consideration. The study and identification of which side control information below is used for NCRs including assumption of maximum transmission power. This side control information may include beamforming information, timing information to align transmission or reception boundaries of NCR, information on downlink-uplink (DL-UL) time division duplex (TDD) configuration, ON-OFF information for efficient interference management and improved energy efficiency, and/or power control information for efficient interference management (as the 2nd priority). The study and identification of identify of layer 1 (L1) or layer 2 (L2) signaling (including its configuration) to carry the side control information is also taken into consideration. In aspects of this disclosure, identification and authorization of NCRs is also taken into consideration.

Remote interference management takes into account the atmospheric ducting phenomenon, caused by lower densities at higher altitudes in the Earth's atmosphere, which causes a reduced refractive index, causing the signals to bend back towards the Earth. A signal trapped in the atmospheric duct can reach distances far greater than normal. In TDD networks with the same UL/DL slot configuration, and in the absence of atmospheric ducting, a guard period is used to avoid the interference between UL and DL transmissions in different cells. However, when the atmospheric ducting phenomenon happens, radio signals can travel a relatively long distance, and the propagation delay exceeds the guard period. Consequently, the DL signals of an aggressor cell can interfere with the UL signals of a victim cell that is far away from the aggressor. Such interference is termed as remote interference. The further the aggressor is to the victim, the more UL symbols of the victim will be impacted.

A remote interference scenario may involve a number of victim and aggressor cells, where the gNBs execute remote interference management (RIM) coordination on behalf of their respective cells. Aggressor and victim gNBs can be grouped into semi-static sets, where each cell is assigned a set ID, and is configured with a RIM reference signal (RIM-RS) and the radio resources associated with the set ID. Each aggressor gNB can be configured with multiple set IDs and each victim gNB can be configured with multiple set IDs, whereas each cell can have at most one victim set ID and one aggressor set ID. Consequently, each gNB can be an aggressor and a victim at the same time.

To mitigate remote interference, the network enables RIM frameworks for coordination between victim and aggressor gNBs. The coordination communication in RIM frameworks can be wireless- or backhaul-based. The backhaul-based RIM framework uses a combination of wireless and backhaul communication, while in the wireless framework, the communication is purely wireless. In both frameworks, all gNBs in a victim set simultaneously transmit an identical RIM reference signal carrying the victim set ID over the air.

In the wireless framework, upon reception of the RIM reference signal from the victim set, aggressor gNBs undertake RIM measures, and send back a RIM reference signal carrying the aggressor set ID. The RIM reference signal sent by the aggressor is able to provide information whether the atmospheric ducting phenomenon exists. The victim gNBs realize the atmospheric ducting phenomenon have ceased upon not receiving any reference signal sent from aggressors.

In the RIM backhaul framework, upon reception of the RIM reference signal from the victim set, aggressor gNBs undertake RIM measures, and establish backhaul coordination towards the victim gNB set. The backhaul messages are sent from individual aggressor gNBs to an individual victim gNB, where the signaling is transparent to the core network. The RIM backhaul messages from aggressor to victim gNBs carry the indication about the detection or disappearance of a RIM reference signal. Based on the indication from the backhaul message, the victim gNBs determine whether the atmospheric ducting and the consequent remote interference have ceased. In both frameworks, upon determining that the atmospheric ducting has disappeared, the victim gNBs stop transmitting the RIM reference signal.

Cross-link interference management takes into account when different TDD DL/UL patterns are used between neighboring cells, where UL transmission in one cell may interfere with DL reception in another cell, which is referred to as cross-link interference (CLI). To mitigate CLI, gNBs can exchange and coordinate their intended TDD DL-UL configurations over Xn and F1 interfaces, and the victim UEs can be configured to perform CLI measurements. There are two types of CLI measurements: a sounding reference signal-reference signal received power (SRS-RSRP) measurement in which the UE measures SRS-RSRP over SRS resources of aggressor UE(s); and CLI-received signal strength indicator (RSSI) measurement in which the UE measures the total received power observed over RSSI resources. Layer 3 filtering applies to CLI measurement results and both event triggered and periodic reporting are supported.

In aspects of interference measurement by an NCR, a base station (e.g., a gNB) connected to an NCR configures one or more reference signals for informing one or multiple cells in a vicinity of potentially upcoming interference. Several implementations and examples for interference management in a cellular system that includes one or more NCRs are described herein. Notably, various ones of the techniques described in the present disclosure may be implemented in combination with one another, such as related to any features of Managing Interference with Network-Controlled Repeaters, Reducing Interference for Network-Controlled Repeaters, and/or Interference Management with Network-Controlled Repeater.

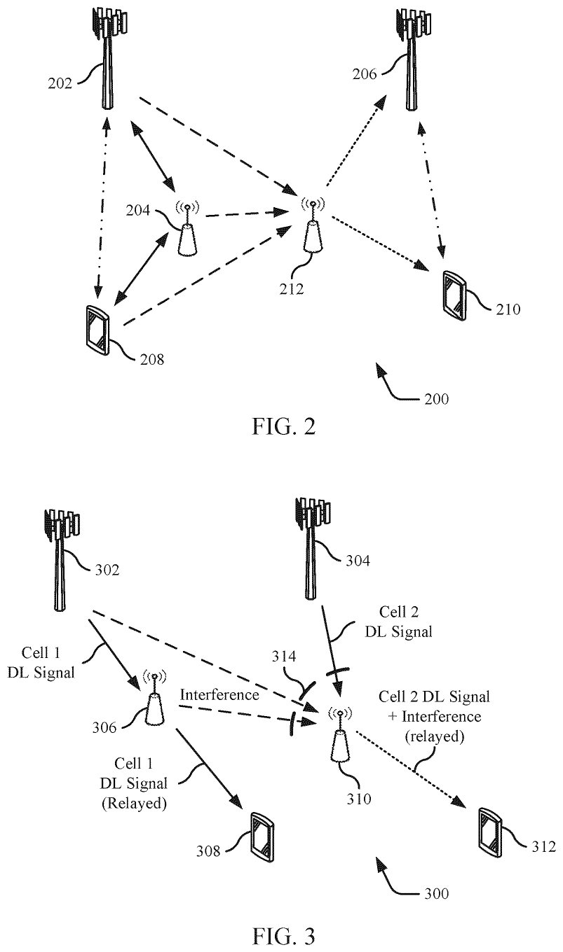

FIG. 2 illustrates an example 200 of interference through an NCR that supports interference measurement by an NCR in accordance with aspects of the present disclosure. In the example 200, a base station 202 is connected to an NCR 204 whose communication may interfere with the communication of nearby base station 206. The base station 202 may serve a UE 208 directly, indirectly via the NCR 204, or a combination thereof. The base station 206 may serve a UE 210, and the base station 202 is also connected to an NCR 212. A signal transmitted by the base station 202 and potentially repeated by the NCR 204 to the UE 208 is called a downlink signal. A signal transmitted by the UE 208 and potentially repeated by the NCR 204 to the base station 202 is called an uplink signal.

In the example 200, good or desired signals (e.g., strong signals) are illustrated with solid-line arrows, such as between the base station 202 and the NCR 204, and between the NCR 204 and the UE 208. Insignificant or weak signals (e.g., due to distance) are illustrated with an alternating long and short dashed arrow, such as between the base station 202 and the UE 208, and between the base station 206 and the UE 210. Significant or strong interference signals (e.g., due to close distance) are illustrated with long-dashed arrows, such as between the NCR 204 and the NCR 212. A good or desired signal combined with an interference signal is illustrated with short-dashed arrows, such as between the NCR 212 and the base station 206, and/or between the NCR 212 and the UE 210.

In this example 200, the base station 202, NCR 204, and UE 208 are represented as aggressor devices, while the base station 206, the NCR 212, and the UE 210 are represented as victim devices. However, it is to be noted that in some situations the base station 206, the NCR 212, and/or the UE 210 transmit interference signals that are received by one or more of the base station 202, the NCR 204, or the UE 208. In such situations, the base station 206, the NCR 212, or the UE 210 are then the aggressor devices, while the base station 202, the NCR 204, and the UE 208 are the victim devices. In one or more implementations, the following steps are executed by the various entities (e.g., base stations, UEs, NCRs), and some steps may be omitted, permuted, or repeated in some implementations.

In one or more implementations related to a first step, a base station configures a reference signal, referred to as a CIRS, associated with one or more communication elements. A communication element may take various forms. For example, a communication element may be a downlink and/or uplink resource in the time domain, such as one or multiple symbols, one or multiple slots, one or multiple subframes, one or multiple frames, OFDM symbols, a time interval in milliseconds or seconds, and so forth. By way of another example, a communication element may be a downlink and/or uplink resource in the frequency domain, such as a frequency band, a sub-band, one or multiple carriers or component carriers (CCs), one or multiple bandwidth parts (BWPs), an active BWP, one or multiple physical resource blocks (PRBs), one or multiple resource block groups (RBGs), and so forth. By way of another example, a communication element may be a downlink and/or uplink channel, such as a PDCCH/control resource set (CORESET), PDSCH, cell group-PDSCH (CG-PDSCH), PUCCH, PUSCH, semi-persistent scheduling (SPS), and so forth.

By way of another example, a communication element may be a downlink and/or uplink reference signal, such as a SS/PBCH block, a CSI-RS, a SRS, and so forth. By way of another example, a communication element may be a spatial parameter, such as one or multiple beams, one or multiple beam directions, one or multiple beam-widths, one or multiple QCL Type D parameters each with a reference signal as a source, one or multiple TCI state IDs each comprising a QCL Type D parameter, a coverage area (e.g., determined/indicated by geographical coordinates), and so forth. By way of another example, a communication element may be a QCL relationship, such as one or multiple QCL Type A, B, C, D parameters each with a reference signal as a source, one or multiple TCI state IDs each comprising a QCL Type A/B/CD parameter, and so forth.

If the communication element is in the downlink, the CIRS may be a downlink reference signal such as a CSI-RS. If the communication is in the uplink, the CIRS may be an uplink reference signal such as an SRS. Note that the phrase “communication indication reference signal” (CIRS) is used herein for ease of reference. The reference signal may be referred to by a more generic term such as CSI-RS or SRS.

In one or more implementations related to a second step, the base station 202 transmits a message to the base station 206, for example on an NG-C or Xn interface. The message includes information of the CIRS, information of the associated communication element, or a combination thereof. The message may indicate the association between the CIRS and the communication element implicitly or explicitly. This signaling may be implemented in any of a variety of manners, such as using techniques of managing interference with NCRs.

In one or more implementations related to a first part of a third step, the base station 202 determines whether a communication will occur, or is possible to occur, in association with the communication element. For example, if the communication element is a downlink resource, a communication by the base station 202 is scheduled on the resource or will potentially occur on the resource. By way of another example, if the communication element is an uplink resource, a communication by the UE 208 is scheduled on the resource or will potentially occur on the resource. By way of another example, if the communication element is a downlink channel, a communication will (potentially) occur on the channel by the base station 202. By way of another example, if the communication element is an uplink channel, a communication will (potentially) occur on the channel by the UE 208. By way of another example, if the communication element is a downlink reference signal, the base station 202 will (potentially) transmit the reference signal. By way of another example, if the communication element is an uplink reference signal, the UE 208 will (potentially) transmit the reference signal, or the UE 208 is triggered to transmit the reference signal. By way of another example, if the communication element is a spatial parameter, the base station 202 or the UE 208 transmit a signal while applying the spatial parameter (e.g., beam). By way of another example, if the communication element is a QCL relationship, the base station 202 or the UE 208 transmit a signal to which the QCL relationship is applied.

In one or more implementations related to a second part of a third step, upon determining that the communication will occur, or is possible to occur, the CIRS is transmitted according to the following. If the communication and/or the CIRS is in the downlink, the base station 202 transmits the CIRS. If the communication and/or the CIRS is in the uplink, the base station 202 triggers the UE 208 to transmit the CIRS and/or the UE 208 transmits the CIRS. If the base station 202 triggers the UE 208 to transmit the CIRS, the triggering may be performed by the base station 202 transmitting a control message such as a downlink control information (DCI) message indicating to the UE 208 to transmit the CIRS. Otherwise, the base station 202 may send a configuration message to the UE 208, where the configuration message indicates to the UE 208 to transmit the CIRS in association with the communication. The configuration will be semi-static, and as a result, a dynamic signaling for triggering the UE 208 is not needed.

In some implementations, the base station 202 or the UE 208 transmit the CIRS while applying one or multiple parameters associated with the communication. For example, in downlink, the base station 202 may transmit the CIRS while applying a beam, a transmit power, and/or a timing identical to a beam, a transmit power, and/or a timing that is going to be applied for transmitting this communication. By way of another example, in uplink, the UE 208 may transmit the CIRS while applying a beam, a transmit power, and/or a timing identical to a beam, a transmit power, and/or a timing that is going to be applied for transmitting this communication. This behavior may be pre-configured, configured by the network (e.g., by the base station 202), or signaled by the network (e.g., by the base station 202).

Furthermore, the NCR 204 may repeat the CIRS according to a configuration or signaling by the network (e.g., by the base station 202). For example, the NCR 204 may receive the CIRS signal from its transmitter (the base station 202 in downlink or the UE 208 in uplink) and forward the signal to another entity (e.g., to the UE 208 in downlink or to the base station 202 in uplink). In this case, the NCR 204 may be configured or signaled by the network (e.g., by the base station 202) to forward the signal while applying a beam, a transmit power, and/or a timing identical to a beam, a transmit power, and/or a timing that is going to be applied for forwarding the communication.

In one or more implementations related to a fourth step, the base station 206 may perform a measurement on the resources associated with the CIRS, as indicated in the message from the base station 202 (in the second step above), in order to obtain an interference value. This value may then be used as an estimate of the interference that the associated communication is going to cause in the neighboring cell provided by the base station 206. Additionally or alternatively, the base station 206 may configure the UE 210, or signal to the UE 210, to perform a measurement on the resources associated with the CIRS in order to obtain an interference value. This value may then be used as an estimate of the interference that the associated communication is going to cause on the UE 210.

In the above described four steps, the reference signal identified as CIRS is used to inform the neighboring entities/cells ahead of time about an upcoming interference by an associated communication. Since this process of informing the neighboring entities/cells is through an over-the-air (OTA) signal, information of association between the signal (CIRS) and the communication should be conveyed to the neighboring entities/cells ahead of time so they know to perform the measurement on the CIRS and take the obtained value as an estimate of upcoming interference.

In one or more implementations, multiple CIRS may be configured in association with multiple communication elements. In this case, the association between the CIRS and the communication elements may be one-to-one, or otherwise specified by the standard or indicated by the network. Additionally or alternatively, multiple replicas of a communication may be transmitted, where at least a first replica of the communication is intended for a direct communication between the base station 202 and the UE 208 and at least a second replica of the communication is intended for an indirect communication through the NCR 204. In this case, multiple replicas of the CIRS may be transmitted in association with the replicas of the communication, i.e., at least a first replica of the CIRS is transmitted directly and at least a second replica of the CIRS is repeated by the NCR 204. Additionally or alternatively, instead of multiple replicas of the CIRS, multiple CIRS may be transmitted, where each CIRS is associated with one replica of the associated communication. Additionally or alternatively, a communication and/or the associated CIRS may occur on a sidelink instead of a downlink or an uplink. In this case, the communication element may be a sidelink resource, a sidelink channel, and the like. The NCR may be a sidelink NCR or sidelink relay in those cases.

As discussed above, a reference signal, referred to as a CIRS, is used to inform the neighboring entities or cells ahead of time about an upcoming interference by an associated communication. According to various implementations, a base station or a UE in a neighboring cell may perform a measurement on the CIRS to determine whether and how much interference to expect from an associated communication. As discussed in more detail below, in one or more implementations an interference measurement on a reference signal is performed by the NCR at the victim cell.

For example, consider a first base station connected to a first NCR whose communication may interfere with communication of a nearby second base station. The first base station may serve a first UE directly, indirectly via the first NCR, or a combination thereof. The second base station may serve a second UE directly, indirectly via the second NCR, or a combination thereof. A signal transmitted by the first base station and potentially repeated by the first NCR to the first UE is called a DL signal. A signal transmitted by the first UE and potentially repeated by the first NCR to the first base station is called a UL signal.

FIG. 3 illustrates an example of a system 300 that supports interference measurement by an NCR in accordance with aspects of the present disclosure. The system 300 illustrates an example of a DL signal in an aggressor cell, DL interference in a victim cell, and DL repeating by one or more NCRs. In the system 300, both a base station 302 (in cell 1) and a base station 304 (in cell 2) transmit DL signals. An NCR 306 may relay cell 1 DL signals to the UE 308 and an NCR 310 may relay cell 2 DL signals to a UE 312. Meanwhile, cell 1 DL signals, directly from the base station 302 and/or relayed by the NCR 306, may interfere with cell 2 DL signals at the NCR 310, which are then relayed to the UE 312. In the system 300, a potential direct interference at the UE 312 by DL signals from the base station 302 and/or the NCR 306 are omitted for brevity. A receive (RX) beam 314 for the NCR 310 is also illustrated using a dashed arc.

In FIG. 3 good or desired signals (e.g., strong signals) are illustrated with solid-line arrows, such as between the base station 302 and the NCR 306, and between the NCR 306 and the UE 308. Significant or strong interference signals (e.g., due to close distance) are illustrated with long-dashed arrows, such as between the NCR 306 and the NCR 310, or between the base station 302 and the NCR 310. A good or desired signal combined with an interference signal is illustrated with short-dashed arrows, such as between the NCR 310 and the UE 312. The interference problem in the system 300 is addressed as follows.

In several implementations, the base station 302 configures a downlink CIRS, such as an SS/PBCH block or a CSI-RS, in association with a downlink communication element as discussed above. For ease of reference, and without intending to limit the scope, the reference signal is assumed to be a CSI-RS and the downlink communication element is simply called the DL communication/signal. The signal of the DL communication may be transmitted by the base station 302 and received by the UE 308. The DL signal may or may not be repeated by the NCR 306. In one or more implementations, the base station 302 may transmit at least two replicas of the DL signal, one directly to the UE 308 and one indirectly through the NCR 306. The at least two replicas may be multiplexed in time (TDM), frequency (FDM), and/or through multiple antennas on same time and/or frequency resources (e.g., SDM/multi-panel).

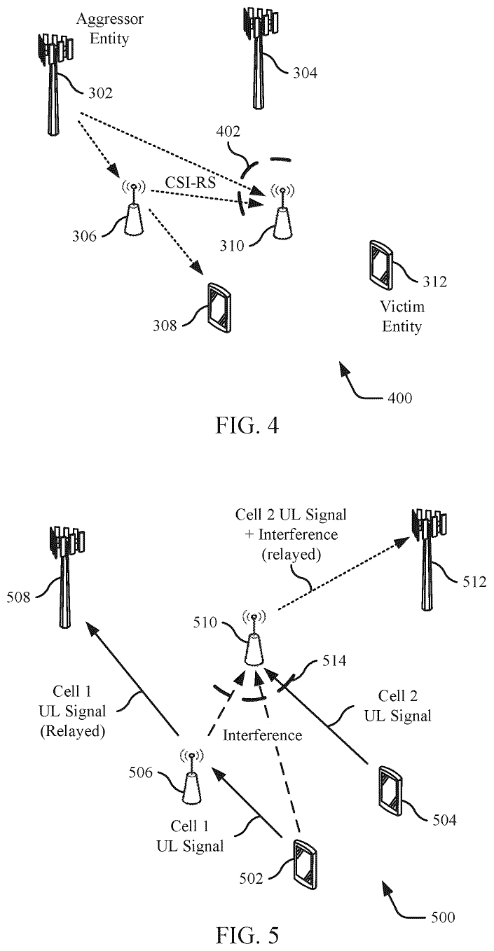

In one or more implementations, the NCR 310 receives the CSI-RS, according to a configuration/signaling, and performs an interference measurement on the CSI-RS in order to determine whether an associated DL communication from the base station 302 will interfere with desired communication at any UE, such as at the UE 312. The NCR 310 may obtain an estimate of the interference through the interference as well. The following FIG. 4 illustrates examples of these implementations.

FIG. 4 illustrates an example of a system 400 that supports interference measurement by an NCR in accordance with aspects of the present disclosure. The system 400 illustrates an example of a DL signal in an aggressor cell, DL interference in a victim cell, and measurement by the NCR 310 in the victim cell, as well as addresses the interference discussed with reference to the system 300 of FIG. 3. The base station 302 is illustrated as the aggressor entity or device, and the UE 312 is illustrated as the victim entity or device. The system 400 also illustrates, using a dashed arc, a RX beam 402 of the NCR 310, and the DL interference management is performed at the NCR 310.

A motivation for this approach in the system 400 is that the DL interference from a nearby cell is measured by the NCR 310 in the victim cell, which allows for a lower signaling overhead and complexity, according to which interference measurement is performed at a base station or a UE. The NCR 310 may obtain an estimate of the interference provided that parameters such as NCR RX beamforming are applied properly. In this case, the following parameters may be indicated or determined without an explicit indication to assist with measuring the interference at the NCR 310.

With respect to the NCR RX beam 402, the base station 304 may configure/signal the NCR 310 to apply a specific RX beam when receiving the CSI-RS signal. In some implementations, the NCR 310 may be configured/signaled to apply the RX beam the NCR 310 uses when receiving a DL signal from the base station 304. In one or more implementations, the NCR 310 may determine to apply one or multiple RX beams associated with one or multiple RX beam parameters that the NCR 310 may apply to receive a DL signal from the base station 304. The one or multiple RX beam parameters may be indicated explicitly by the base station 304, or determined implicitly by the NCR 310 without an indication, to be identical to one or multiple RX beam parameters the NCR 310 may have used in a latest relaying of a DL communication from the base station 304 as a source and/or to the UE 312 as a destination.

In one example, the base station 304 may indicate to the NCR 310 to apply one or multiple RX beams associated with one or multiple RX beam parameters used in a latest relaying of a DL communication from the base station 304 to the UE 312. The DL communication may be a control communication (e.g., a PDCCH), a data communication (e.g., a PDSCH), a downlink reference signal, or the like. In another example, the NCR 310 may apply one or multiple RX beams associated with one or multiple RX beam parameters used in a latest relaying of a DL communication from the base station 304 to the UE 312 without receiving an explicit indication.

Additionally or alternatively, the NCR 310 may determine to apply one or multiple RX beams associated with a latest UE 312 beam report. The UE 312 beam report may be any CSI report comprising a beam index, such as a reference signal resource indicator (e.g., SS/PBCH block resource indicator (SSBRI), CSI-RS resource indicator (CRI), SRS resource locator (SRI)), where the UE 312 beam report may be associated with a CSI acquisition for a channel with the base station 304. This channel may be a direct channel between the base station 304 and the UE 312 or an indirect channel through the NCR 310.

In one or more implementations, the NCR 310 receives the CSI-RS and performs a measurement to obtain an estimate of the interference that an associated DL communication from base station 302 may cause on any UE, such as the UE 312 (e.g., the victim entity). Additionally, the NCR 310 may receive a downlink reference signal, such as a second CSI-RS from the base station 304 in order to perform a channel measurement and obtain an estimate of the desired signal strength. The NCR 310 may apply a same RX beam for receiving the second CSI-RS from the base station 304 as the RX beam that the NCR 310 applies for receiving the CSI-RS from cell 1 (either directly from the base station 302 or indirectly through the NCR 306). Then, the NCR 310 may compute a CSI quantity, such as an SIR or an SINR based on the obtained signal strength estimate and interference estimate. The CSI quantity may then be reported to the base station 304, for example, via a CSI reporting message.

FIG. 5 illustrates an example of a system 500 that supports interference measurement by an NCR in accordance with aspects of the present disclosure. The system 500 illustrates an example of a UL signal in an aggressor cell, UL interference in a victim cell, and UL repeating by one or more NCRs. In system 500, both a UE 502 (in cell 1) and a UE 504 (in cell 2) transmit UL signals. An NCR 506 may relay cell 1 UL signals to a base station 508 and an NCR 510 may relay cell 2 UL signals to a base station 512. Meanwhile, cell 1 UL signals, directly from the UE 502 and/or relayed by the NCR 506, may interfere with cell 2 UL signals at the NCR 510, which are then relayed to the base station 512. In the system 500, a potential direct interference at the base station 512 by UL signals from the UE 502 and/or from the NCR 506 are omitted for brevity. A RX beam 514 for the NCR 510 is also illustrated using a dashed arc.

In FIG. 5, good or desired signals (e.g., strong signals) are illustrated with solid-line arrows, such as between the UE 502 and the NCR 506, and between the NCR 506 and the base station 508. Significant or strong interference signals (e.g., due to close distance) are illustrated with long-dashed arrows, such as between the UE 502 and the NCR 510, and between the NCR 506 and the NCR 510. A good or desired signal combined with an interference signal is illustrated with short-dashed arrows, such as between the NCR 510 and the base station 512.

In several implementations, the base station 508 configures an uplink CIRS, such as an SRS, in association with an uplink communication element as discussed above. For ease of reference, and without intending to limit the scope, the reference signal is assumed to be an SRS and the uplink communication element is simply called the UL communication/signal. The signal of the UL communication may be transmitted by the UE 502 and received by the base station 508. The UL signal may or may not be repeated by the NCR 506. In one or more implementations, the UE 502 may transmit at least two replicas of the UL signal, one directly to the base station 508 and one indirectly through the NCR 506. The at least two replicas may be multiplexed in time (TDM), frequency (FDM), and/or through multiple antennas on same time and/or frequency resources, such as space division multiplexing (SDM) or multi-panel.

In one or more implementations, the NCR 510 receives the SRS, according to a configuration/signaling, and performs an interference measurement on the SRS in order to determine whether an associated UL communication from UE 502 will interfere with desired communication at any base station, such as base station 512. The NCR 510 may obtain an estimate of the interference through the interference as well.

FIG. 6 illustrates an example of a system 600 that supports interference measurement by an NCR in accordance with aspects of the present disclosure. The system 600 illustrates an example of an UL signal in an aggressor cell, UL interference in a victim cell, and measurement by a victim entity, as well as addresses the interference discussed with reference to system 500 of FIG. 5. The UE 502 is illustrated as the aggressor entity or device, and the base station 512 is illustrated as the victim entity or device. The system 600 also illustrates, using a dashed arc, a RX beam 602 of the NCR 510, and the UL interference management is performed at the NCR 510.

A motivation for this approach in the system 600 is that the UL interference from a nearby cell is measured by the NCR 510 in the victim cell, which allows a lower signaling overhead and complexity, according to which interference measurement is performed at a base station or a UE. The NCR 510 may obtain an estimate of the interference provided that parameters, such as NCR RX beamforming, are applied properly. In this case, the following parameters may be indicated or determined without an explicit indication to assist with measuring the interference at the NCR 510.

With respect to the NCR RX beam, the base station 512 may configure/signal the NCR 510 to apply a specific RX beam when receiving the SRS signal. In some implementations, the NCR 510 may be configured/signaled to apply the RX beam the NCR 510 uses when receiving a UL signal from the UE 504. In one or more implementations, the NCR 510 may determine to apply one or multiple RX beams associated with one or multiple RX beam parameters that the NCR 510 may apply to receive a UL signal from the UE 504. The one or multiple RX beam parameters may be indicated explicitly by the base station 512, or determined implicitly by the NCR 510 without an indication, to be identical to one or multiple RX beam parameters the NCR 510 may have used in a latest relaying of a UL communication from the UE 504 as a source and/or to the base station 512 as a destination.

In one example, the base station 512 may indicate to the NCR 510 to apply one or multiple RX beams associated with one or multiple RX beam parameters used in a latest relaying of a UL communication from the UE 504 to the base station 512. The UL communication may be a control communication (e.g., a PUCCH), a data communication (e.g., a PUSCH), an uplink reference signal, or the like. In another example, the NCR 510 may apply one or multiple RX beams associated with one or multiple RX beam parameters used in a latest relaying of a UL communication from the UE 504 to the base station 512 without receiving an explicit indication. Additionally or alternatively, the NCR 510 may determine to apply one or multiple RX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. This channel may be a direct channel between the base station 512 and the UE 504 or an indirect channel through the NCR 510.

In one or more implementations, the NCR 510 receives the SRS and performs a measurement to obtain an estimate of the interference that an associated UL communication from UE1 may cause on any base station, such as base station 512. Additionally, NCR 510 may receive an uplink reference signal such as a second SRS from the UE 504 in order to perform a channel measurement and obtain an estimate of the desired signal strength. The NCR 510 may apply a same RX beam for receiving the second SRS from the UE 504 as the RX beam of the NCR 510 applies to receiving the SRS from cell 1 (either directly from UE 502 or indirectly through NCR 506). Then, the NCR 510 may compute a CSI quantity, such as an SIR or an SINR based on the obtained signal strength estimate and interference estimate. The CSI quantity may then be reported to base station 512, for example, via a CSI reporting message.

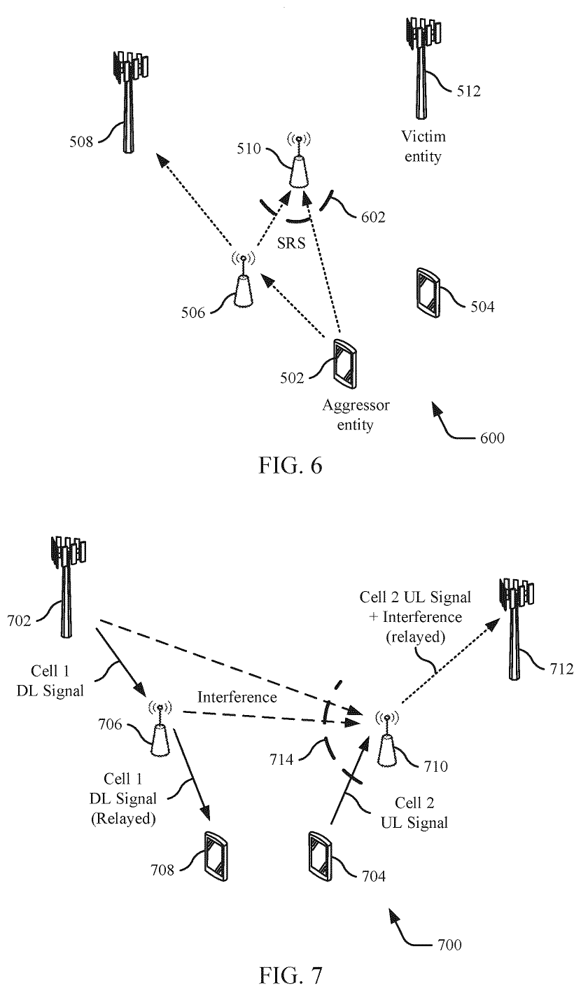

FIG. 7 illustrates an example of a system 700 that supports interference measurement by an NCR in accordance with aspects of the present disclosure. The system 700 illustrates an example of a DL signal in an aggressor cell, UL interference in a victim cell, and UL repeating by one or more NCRs. In system 700, a base station 702 (in cell 1) transmits DL signals and a UE 704 (in cell 2) transmits UL signals. An NCR 706 may relay the cell 1 DL signals to a UE 708, and an NCR 710 may relay the cell 2 UL signals to a base station 712. Meanwhile, cell 1 DL signals, directly from the base station 702 and/or relayed by the NCR 706, may interfere with cell 2 UL signals at the NCR 710, which are then relayed to the base station 712. In this system 700, a potential direct interference at the base station 712 by the DL signals from the base station 702 and/or the NCR 706 are omitted for brevity. A RX beam 714 for the NCR 710 is also illustrated using a dashed arc.

In FIG. 7, good or desired signals (e.g., strong signals) are illustrated with solid-line arrows, such as between the base station 702 and the NCR 706, and between the NCR 706 and the UE 708. Significant or strong interference signals (e.g., due to close distance) are illustrated with long-dashed arrows, such as between the NCR 706 and the NCR 710, or between the base station 702 and the NCR 710. A good or desired signal combined with an interference signal is illustrated with short-dashed arrows, such as between the NCR 710 and the base station 712. The interference problem in the system 700 is addressed as follows.

In implementations, the base station 702 configures a downlink CIRS, such as an SS/PBCH block or a CSI-RS, in association with a downlink communication element as discussed above. For ease of reference, and without intending to limit the scope, the reference signal is assumed to be a CSI-RS and the downlink communication element is simply called the DL communication/signal. The signal of the DL communication may be transmitted by the base station 702 and received by the UE 708. The DL signal may or may not be repeated by the NCR 706. In one or more implementations, the base station 702 may transmit at least two replicas of the DL signal, one directly to the UE 708 and one indirectly through the NCR 706. The at least two replicas may be multiplexed in time (TDM), frequency (FDM), and/or through multiple antennas on same time and/or frequency resources (e.g., SDM/multi-panel).

In one or more implementations, the NCR 710 receives the CSI-RS, according to a configuration/signaling, and performs an interference measurement on the CSI-RS in order to determine whether an associated DL communication from the base station 702 will interfere with desired communication at any base station, such as at base station 712. The NCR 710 may obtain an estimate of the interference through the interference as well.

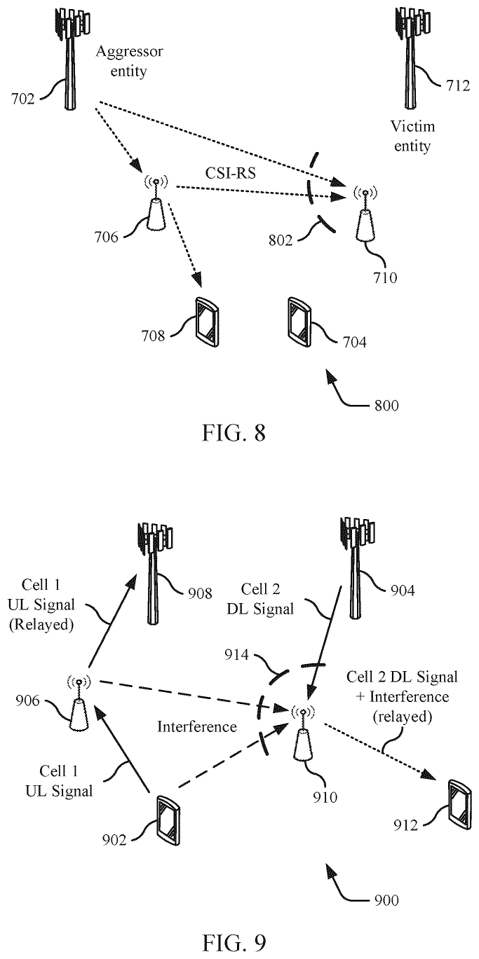

FIG. 8 illustrates an example of a system 800 that supports interference measurement by an NCR in accordance with aspects of the present disclosure. The system 800 illustrates an example of a DL signal in an aggressor cell, UL interference in a victim cell, and measurement by an NCR 710 in the victim cell, as well as addresses the interference discussed with reference to system 700 of FIG. 7. The base station 702 is illustrated as the aggressor entity or device, and the base station 712 is illustrated as the victim entity or device. The system 800 also illustrates, using a dashed arc, a RX beam 802 of the NCR 710, and the interference measurement is performed at the NCR 710.

A motivation for this approach in the system 800 is that the UL interference from a nearby cell is measured by the NCR 710 in the victim cell, which allows a lower signaling overhead and complexity, according to an interference measurement performed at a base station or a UE. The NCR may obtain an estimate of the interference provided that parameters such as NCR RX beamforming are applied properly. In this case, the following parameters may be indicated or determined without an explicit indication to assist with measuring the interference at the NCR 710.

With respect to the NCR RX beam, the base station 712 may configure/signal the NCR 710 to apply a specific RX beam when receiving the CSI-RS signal. In some implementations, the NCR 710 may be configured/signaled to apply the RX beam that the NCR 710 uses when receiving an UL signal from the UE 704. In one or more implementations, the NCR 710 may determine to apply one or multiple RX beams associated with one or multiple RX beam parameters that the NCR 710 may apply to receive an UL signal from the UE 704. The one or multiple RX beam parameters may be indicated explicitly by the base station 712, or determined implicitly by the NCR 710 without an indication, to be identical to one or multiple RX beam parameters the NCR 710 may have used in a latest relaying of a UL communication from the UE 704 as a source and/or to the base station 712 as a destination.

In one example, the base station 712 may indicate to the NCR 710 to apply one or multiple RX beams associated with one or multiple RX beam parameters used in a latest relaying of an UL communication from the UE 704 to the base station 712. The UL communication may be a control communication (e.g., a PUCCH), a data communication (e.g., a PUSCH), an uplink reference signal, or the like. In another example, the NCR 710 may apply one or multiple RX beams associated with one or multiple RX beam parameters used in a latest relaying of a UL communication from the UE 704 to the base station 712 without receiving an explicit indication.

Additionally or alternatively, the NCR 710 may determine to apply one or multiple RX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. This channel may be a direct channel between the base station 712 and the UE 704 or an indirect channel through the NCR 710.

In one or more implementations, the NCR 710 receives the CSI-RS and performs a measurement to obtain an estimate of the interference that an associated DL communication from the base station 702 may cause on any base station, such as base station 712. Additionally, the NCR 710 may receive an UL reference signal, such as an SRS from UE 704 in order to perform a channel measurement and obtain an estimate of the desired signal strength. The NCR 710 may apply a same RX beam for receiving the SRS from the UE 704 as the RX beam that the NCR 710 applies for receiving the CSI-RS from cell 1 (either directly from the base station 702 or indirectly through the NCR 706). Then, the NCR 710 may compute a CSI quantity such as an SIR or an SINR based on the obtained signal strength estimate and interference estimate. The CSI quantity may then be reported to the base station 712, for example, via a CSI reporting message.

FIG. 9 illustrates an example of a system 900 that supports interference measurement by an NCR in accordance with aspects of the present disclosure. The system 900 illustrates an example of an UL signal in an aggressor cell, DL interference in a victim cell, and DL repeating by one or more NCRs. In the system 900, a UE 902 (in cell 1) transmits UL signals and a base station 904 (in cell 2) transmits DL signals. An NCR 906 may relay cell 1 UL signals to a base station 908 (in cell 1) and an NCR 910 may relay cell 2 DL signals to a UE 912 (in cell 2). Meanwhile, cell 1 UL signals, directly from the UE 902 and/or relayed by the NCR 906, may interfere with cell 2 DL signals at the NCR 910, which are then relayed to the UE 912. In the system 900, a potential direct interference at the UE 912 by DL signals from the base station 908 and/or the NCR 906 are omitted for brevity. A RX beam 914 for the NCR 910 is also illustrated using a dashed arc.

In FIG. 9, good or desired signals (e.g., strong signals) are illustrated with solid-line arrows, such as between the UE 902 and the NCR 906, and between the NCR 906 and the base station 908. Significant or strong interference signals (e.g., due to close distance) are illustrated with long-dashed arrows, such as between the NCR 906 and the NCR 910, or between the UE 902 and the NCR 910. A good or desired signal combined with an interference signal is illustrated with short-dashed arrows, such as between the NCR 910 and the UE 912. The interference problem in the system 900 is addressed as follows.

In several implementations, the base station 908 configures an uplink CIRS, such as an SRS, in association with a downlink communication element as discussed above. For ease of reference, and without intending to limit the scope, the reference signal is assumed to be an SRS and the uplink communication element is simply called the UL communication/signal. The signal of the UL communication may be transmitted by the UE 902 and received by the base station 908. The UL signal may or may not be repeated by the NCR 906. In one or more implementations, the UE 902 may transmit at least two replicas of the UL signal, one directly to the base station 908 and one indirectly through the NCR 906. The at least two replicas may be multiplexed in time (TDM), frequency (FDM), and/or through multiple antennas on same time and/or frequency resources (e.g., SDM/multi-panel).

In one or more implementations, the NCR 910 receives the SRS, according to a configuration/signaling, and performs an interference measurement on the SRS in order to determine whether an associated UL communication from UE 902 will interfere with desired communication at any UE, such as UE 912. The NCR 910 may obtain an estimate of the interference through the interference as well.

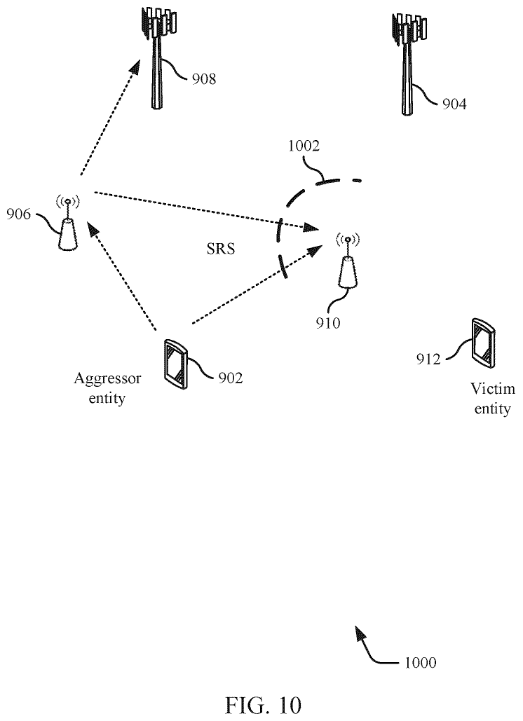

FIG. 10 illustrates an example of a system 1000 that supports interference measurement by an NCR in accordance with aspects of the present disclosure. The system 1000 illustrates an example of an UL signal in an aggressor cell, DL interference in a victim cell, and measurement by an NCR in the victim cell, as well as addresses the interference discussed with reference to system 900 of FIG. 9. The UE 902 is illustrated as the aggressor entity or device, and the UE 912 is illustrated as the victim entity or device. The system 1000 also illustrates, using a dashed arc, a RX beam 1002 of the NCR 910, and the interference measurement is performed at the NCR 910.

A motivation for this approach is that the DL interference from a nearby cell is measured by the NCR 910 in the victim cell, which allows a lower signaling overhead and complexity, according to an interference measurement performed at a base station or a UE. The NCR 910 may obtain an estimate of the interference provided that parameters such as NCR RX beamforming are applied properly. In this case, the following parameters may be indicated or determined without an explicit indication to assist with measuring the interference at UE 912.

With respect to the NCR RX beam, the base station 904 may configure/signal the NCR 910 to apply a specific RX beam when receiving the SRS signal. In some implementations, the NCR 910 may be configured/signaled to apply the RX beam that the NCR 910 uses when receiving a DL signal from the base station 904. In one or more implementations, the NCR 910 may determine to apply one or multiple RX beams associated with one or multiple RX beam parameters that the NCR 910 may apply to receive a DL signal from the base station 904. The one or multiple RX beam parameters may be indicated explicitly by the base station 904, or determined implicitly by the NCR 910 without an indication, to be identical to one or multiple RX beam parameters the NCR 910 may have used in a latest relaying of a DL communication from the base station 904 as a source and/or to the UE 912 as a destination.

In one example, the base station 904 may indicate to the NCR 910 to apply one or multiple RX beams associated with one or multiple RX beam parameters used in a latest relaying of a DL communication from the base station 904 to the UE 912. The DL communication may be a control communication (e.g., a PDCCH), a data communication (e.g., a PDSCH), a downlink reference signal, or the like. In another example, the NCR 910 may apply one or multiple RX beams associated with one or multiple RX beam parameters used in a latest relaying of a DL communication from the base station 904 to the UE 912 without receiving an explicit indication. Additionally or alternatively, the NCR 910 may determine to apply one or multiple RX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. The said channel may be a direct channel between the base station 904 and the UE 912 or an indirect channel through the NCR 910.

In one or more implementations, the NCR 910 receives the SRS and performs a measurement to obtain an estimate of the interference that an associated UL communication from UE 902 may cause on any base station, such as base station 904. Additionally, the NCR 910 may receive a downlink reference signal such as a CSI-RS from the base station 904 in order to perform a channel measurement and obtain an estimate of the desired signal strength. The NCR 910 may apply a same RX beam for receiving the CSI-RS from the base station 904 as the RX beam that the NCR 910 applies for receiving the SRS from cell 1 (either directly from UE 902 or indirectly through NCR 906). Then, the NCR 910 may compute a channel state information (CSI) quantity, such as an SIR or an SINR based on the obtained signal strength estimate and interference estimate. The CSI quantity may then be reported to the base station 904, for example, via a CSI reporting message.

One or more implementations of the techniques discussed herein include performing interference measurements in a victim cell based on reference signals transmitted and relayed in a nearby aggressor cell. Therefore, it is assumed that there is coordination among cells on the reference signals and their association with communications in the aggressor cell. Inter-cell coordination may be implemented through signaling with the core network or through direct signaling among base stations.

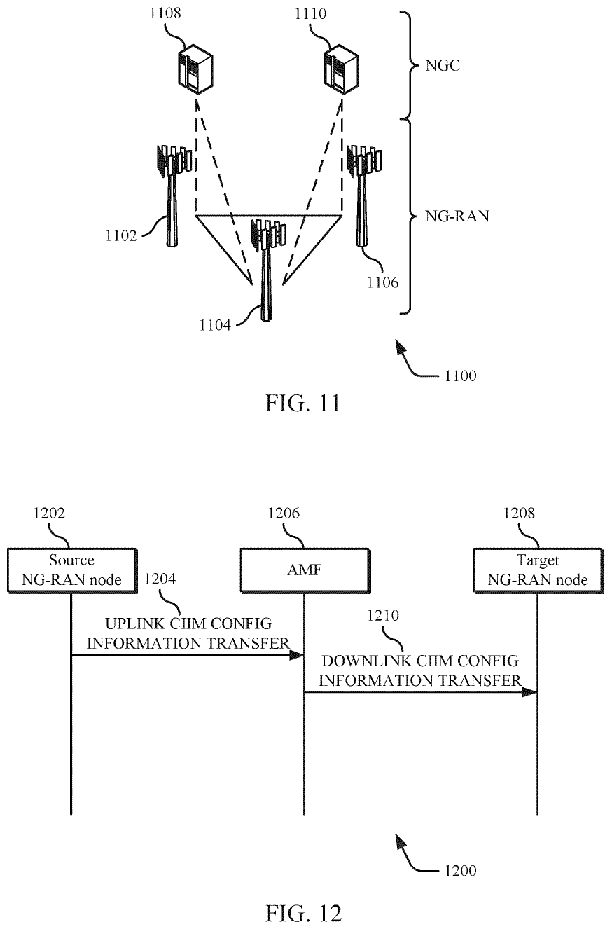

FIG. 11 illustrates an example of a system 1100 that supports managing interference with NCRs in accordance with aspects of the present disclosure. This example includes interfaces among base stations and the core network. The system 1100 illustrates base stations (e.g., gNBs) 1102, 1104, and 1106 are connected to the core network (e.g., 5G core (5GC, NGC)) through the NG interface, illustrated with dashed lines. The core network includes an AMF/UPF 1108 and an AMF/UPF 1110. The NG interface comprises the control-plane interface NG-C that connects the gNB-CU-CP to the AMF and the user-plane interface NG-U that connects the gNB-CU-UP to the user plane function (UPF). The base stations 1102, 1104, and 1106 are also connected to each other through the Xn interface, illustrate with solid lines.

Coordination among cells for interference management may be implemented through the core network by using the NG-C interface indirectly or through the Xn interface directly. In the discussion below, signaling for coordination among base stations by using either or both NG-C and Xn interfaces is described and behavior of the cell entities (e.g., base stations, NCRs, etc.) in response to the signaling is described. Interference management through use of a reference signal such as a communication indication reference signal is referred to as communication indication interference management (CIIM) for ease of reference. In some implementations, the proposed CIIM procedures may be an extension of other interference management procedures such as remote interference management (RIM).

It should be noted that the techniques discussed herein are not limited in scope to the 5G architectures and interfaces, and they may be applied to other systems such as 6G systems with potential differences in architecture, interfaces, and terminology. In one or more implementations, inter-cell coordination is performed through signaling with a core entity such an AMF. Information transfer procedures may be performed by signaling on an interface such as NG-C. The term “RAN node” may refer to a base station (e.g., gNB), an IAB donor, or any other network entity capable of performing the procedure.

FIG. 12 illustrates an example of a system 1200 that supports managing interference with NCRs in accordance with aspects of the present disclosure. This example includes a configuration information transfer procedure. The system 1200 illustrates a source RAN node 1202 may initiate an Uplink CIIM Configuration Information Transfer procedure by sending an UPLINK CIIM CONFIG INFORMATION TRANSFER message 1204 to an AMF 1206. The purpose of this procedure is to transfer CIIM configuration information from the source RAN node 1202 to the AMF 1206.

In one or more implementations, the AMF 1206 may not interpret the transferred CIIM configuration information. In such implementations, upon reception of the UPLINK CIIM CONFIG INFORMATION TRANSFER message, the AMF 1206 may transparently transfer it towards a target RAN node 1208 indicated by the message, for example through a Target RAN Node ID IE comprised by the message.

The AMF may initiate the Downlink CIIM Configuration Information Transfer procedure by sending a DOWNLINK CIIM CONFIG INFORMATION TRANSFER message 1210 to the target RAN node 1208. The target RAN node 1208 may use the CIIM configuration information in the received DOWNLINK CIIM CONFIG INFORMATION TRANSFER message 1210 for executing the CIIM methods proposed herein. The purpose of the procedure is to transfer CIIM configuration information from the AMF 1206 to the target RAN node 1208.

In one or more implementations, the AMF 1206 may process the information in order to determine one or multiple target RAN nodes to which it may forward the CIIM configuration information. For example, the AMF 1206 may forward the information to one or multiple RAN nodes based on their position. E.g., the AMF 1206 may determine to forward the information to all RAN nodes within a radius of the position of the source RAN node 1202. The position of the source RAN node and/or the radius may be included in the Uplink CIIM Configuration Information Transfer message. Alternatively, the AMF 1206 may obtain the position and/or the radius through other means. As yet another alternative, the AMF 1206 may forward the information to one or multiple RAN nodes within a geographical area. The AMF 1206 may select the geographical area from a plurality of geographical areas based on source RAN node 1202's position. If the source RAN node 1202 is positioned in multiple geographical areas, the AMF 1206 may select the union of the RAN nodes in all or several of the multiple geographical areas or, alternatively, one geographical area in which the source RAN node 1202 is closest to the center of the one geographical area.

By way of another example, the AMF 1206 may forward the information to one or multiple RAN nodes that the AMF 1206 determines to be neighbors of the source RAN node 1202. The neighbor relationship may be determined based on factors that may affect inter-cell interference among cells provided by the RAN nodes. For example, in an urban environment where many obstacles are expected to exist among RAN nodes, inter-cell interference may be considered mitigated at larger distances compared to a suburban or rural environment.

In yet another example, the AMF 1206 may consider positions of NCRs served by RAN nodes in order to determine which RAN nodes may be in an interference range of the source RAN node or any of the NCRs connected to the source RAN node 1202. In yet another example, the AMF 1206 may forward the CIIM configuration information to a set of RAN nodes as configured or preconfigured by the network. The set of RAN nodes may be similar to the gNB Set ID used for remote interference management.

In one or more implementations of the above procedures, the source RAN node 1202 may be an aggressor base station (e.g., base station 202 of FIG. 2) and the target RAN node may be a victim base station (e.g., base station 206 of FIG. 2). Either or both the above procedures may be UE-associated or non-UE-associated, which may depend on the configuration of an associated CIRS, the transmitter of the CIRS, whether the CIRS is beamformed or otherwise targeting a particular UE or group of UEs, and so on. Each of the uplink CIIM configuration information transfer message and the downlink CIIM configuration information transfer message may comprise a CIIM Configuration Information Transfer IE.

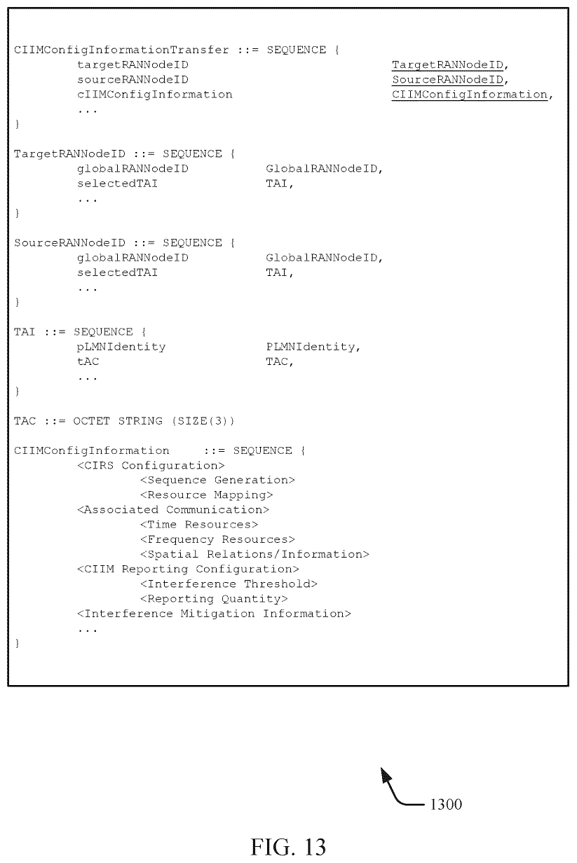

FIG. 13 illustrates an example of a system 1300 that supports managing interference with NCRs in accordance with aspects of the present disclosure. This example is shown using abstract syntax notation one (ASN.1) code, although it is to be appreciated that the IE may be in any of a variety of forms. The system 1300 illustrates the CIIMConfigInformationTransfer IE includes a target RAN node ID and a source RAN node ID, each of which includes a global RAN node ID and a tracking area identity (TAI). In other examples, each of the target RAN node ID and source node ID may be a plurality of RAN node IDs.

The IE may further include CIIM configuration information, which may include CIRS configuration information, information of one or multiple associated communication elements, CIIM reporting configuration, and so on. The IE may also comprise information on interference mitigation options, for example whether the source RAN node intends to reduce transmission power, avoid certain spatial directions, turn off an NCR at certain times or limit the operation of the NCR at certain times, and so on.

Upon receiving the CIIM configuration information, the target RAN node may use the information to perform a measurement on the configured CIRS in order to determine whether and how much the source RAN node may interfere with its communication. If the target RAN node detects that there is significant interference associated with the CIRS, the target RAN node may take any one or more of various actions.

In one or more implementations, the target RAN node avoids collision. The target RAN node avoids scheduling a communication in the target cell that may overlap with the associated communication indicated in the CIIM configuration information. Additionally or alternatively, the target RAN node performs link adaptation. The target RAN node takes the interference into account for link adaptation when scheduling a communication that may overlap with the associated communication indicated in the CIIM configuration information.

Additionally or alternatively, the target RAN node performs beam adaptation. The target RAN node applies a different beamforming for transmissions and/or receptions at the base station and/or the UE in order to avoid or mitigate the interference. Additionally or alternatively, the target RAN node reports interference. The target RAN node informs the source RAN node and/or the network of the interference. This may be done, for example, by sending a report message including a reporting quantity such as an RSRP associated with the CIRS if it is higher than a threshold. The reporting quantity and the threshold may be indicated by the CIIM configuration message.

In the case that the target RAN node reports a high interference back to the source RAN node, the source RAN node may respond by reporting whether it has taken an action to mitigate the interference. Examples of interference mitigation techniques are reducing power, changing beamforming to beams that are less likely to interfere with other cells in the vicinity, turning off an NCR during certain time duration(s), and reducing the NCR power for certain resources.

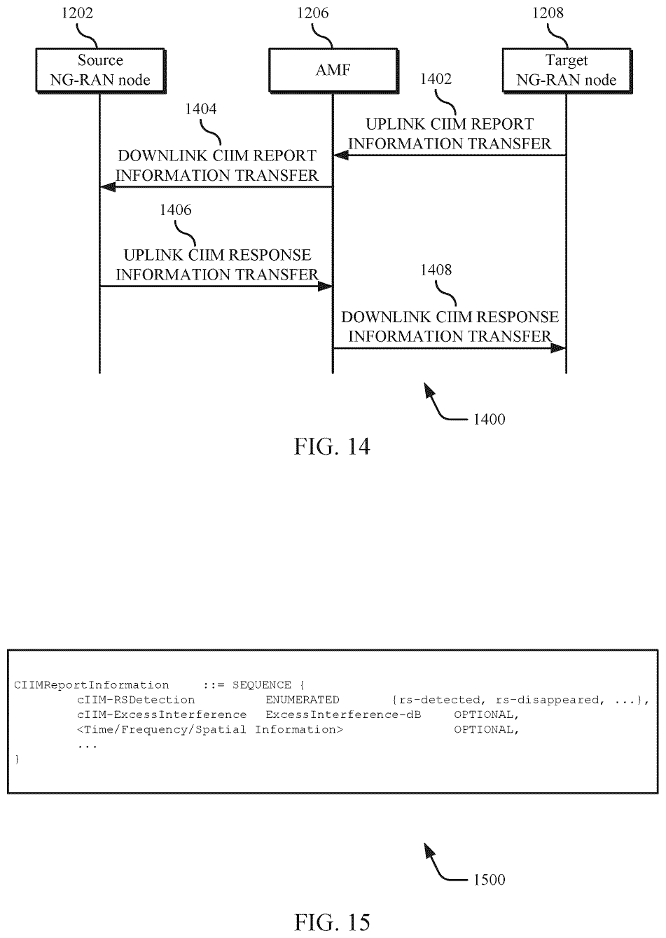

FIG. 14 illustrates an example of a system 1400 that supports managing interference with NCRs in accordance with aspects of the present disclosure. This example includes a signaling procedure for report/response information transfer in accordance with aspects of the present disclosure. The system 1400 illustrates the target RAN node sends a report message to the AMF 1206, illustrated as UPLINK CIIM REPORT INFORMATION TRANSFER message 1402. The AMF 1206 forwards the received report message to the source RAN node 1202 as DOWNLINK CIIM REPORT INFORMATION TRANSFER message 1404. The source RAN node 1202 generates and sends a response message to the AMF 1206, illustrated as UPLINK CIIM RESPONSE INFORMATION TRANSFER message 1406. The AMF 1206 forwards the received response message to the target RAN node as DOWNLINK CIIM RESPONSE INFORMATION TRANSFER message 1408. Each of the UPLINK/DOWNLINK CIIM REPORT INFORMATION TRANSFER messages may comprise a CIIM Report Information IE.

FIG. 15 illustrates an example of a system 1500 that supports managing interference with NCRs in accordance with aspects of the present disclosure. This example includes a report information IE. The system 1500 illustrates the report message may include one or more of: whether the target RAN node detects the CIRS, which may be an indication of interference in the cell of the target RAN node; an amount of excess interference detected on the CIRS, e.g., an amount of interference in excess of the interference threshold indicated in the CIIM configuration information or in excess of an acceptable interference for the target RAN node; or resources in time, frequency, and/or spatial domains where the excess interference occurs. Returning to FIG. 14, each of the UPLINK/DOWNLINK CIIM RESPONSE INFORMATION TRANSFER messages may comprise a CIIM Response Information IE.

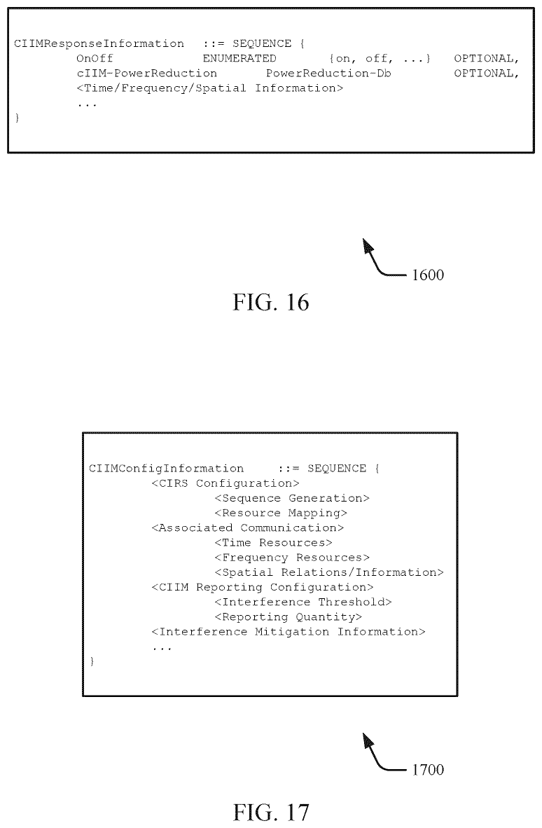

FIG. 16 illustrates an example of a system 1600 that supports managing interference with NCRs in accordance with aspects of the present disclosure. This example includes a response information IE. The system 1600 illustrates in the response message the source RAN node may respond to the target RAN node that it has turned off (or on) an associated communication (for example, an associated NCR transmitting the communication) or it has reduced the power of an associated communication. The associated communication may be indicated by resources in time, frequency, and/or spatial domains.

Additionally or alternatively, the process of configuring a CIRS and/or initiating an information transfer procedure for CIIM may be initiated by a victim base station rather than an aggressor base station. In this case, a base station that detects a high interference may inform the network, for example through an NG-C signaling with the AMF, that one or multiple cells in the vicinity are causing a large interference. The AMF may then forward this information to other base stations, for example based on neighbor relationship information or based on geographical positions. In response, an aggressor base station may configure a CIRS and perform an uplink CIIM configuration information transfer. Other signaling and methods may then follow as described above.

In one or more implementations, inter-cell coordination can be performed through direct signaling among base stations, e.g., on an Xn interface. For example, an aggressor base station may send a CIIM Configuration Information IE to one or multiple potential victim base stations.

FIG. 17 illustrates an example of a system 1700 that supports managing interference with NCRs in accordance with aspects of the present disclosure. This example includes a configuration information IE in accordance with aspects of the present disclosure. The system 1700 illustrates the configuration information IE may include CIIM configuration information, analogous to the discussion above regarding example 1300 of FIG. 13. In response, a victim base station may send a CIIM Report Information IE back to the aggressor base station, such as illustrated in the example 1500 of FIG. 15. Then, in response to the report, the aggressor base station may send a CIIM Response Information IE to the victim base station, such as illustrated in the example 1600 of FIG. 16.

Additionally or alternatively, a CIIM signaling may be initiated by a victim base station rather than an aggressor base station. In this case, a base station that detects a high interference may inform base stations in the vicinity, for example based on neighbor relationship information or based on geographical positions. In response, an aggressor base station may configure a CIRS and send the CIIM Configuration Information. Other signaling and methods may then follow as described above. Additionally or alternatively, a combination of signaling through the core and direct signaling among base stations may be used. For example, an initial information transfer may be used to exchange CIIM information among aggressor and victim base stations. Then, the base stations may perform report and response signaling as described above through Xn signaling. The base stations may further update CIIM configuration information through NG-C or Xn signaling.

As discussed above, a reference signal, referred to as a CIRS, is used to inform the neighboring entities or cells ahead of time about an upcoming interference by an associated communication. According to various implementations, a base station or a UE in a neighboring cell may perform a measurement on the CIRS to determine whether and how much interference to expect from an associated communication. As discussed in more detail below, in one or more implementations an interference measurement on a reference signal is performed through the NCR by a victim entity such as a victim base station or victim UE.

For example, consider a first base station connected to a first NCR whose communication may interfere with communication of a nearby second base station. The first base station may serve a first UE directly, indirectly via the first NCR, or a combination thereof. The second base station may serve a second UE directly, indirectly via a second NCR, or a combination thereof. A signal transmitted by the first base station and potentially repeated by the first NCR to the first UE is called a DL signal. A signal transmitted by the first UE and potentially repeated by the first NCR to the first base station is called a UL signal.

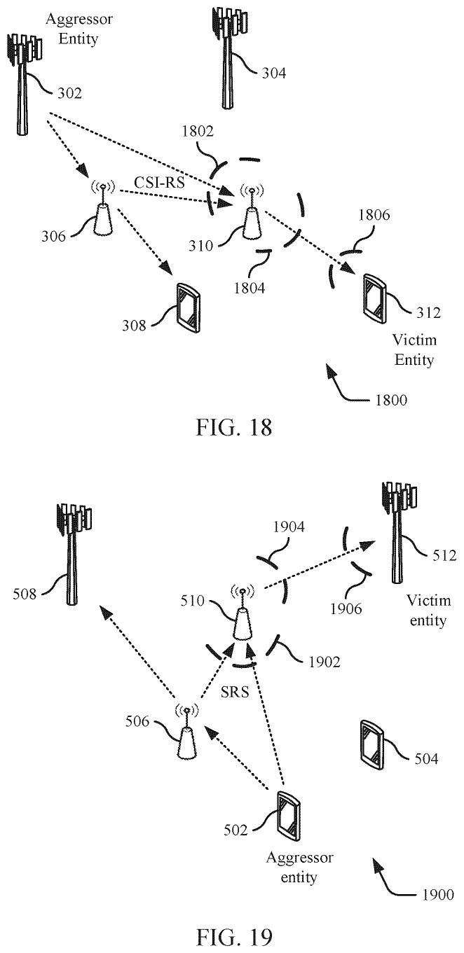

FIG. 18 illustrates an example of a system 1800 that supports reducing interference for NCRs in accordance with aspects of the present disclosure. The system 1800 illustrates an example of a DL signal in an aggressor cell, DL interference in a victim cell, and measurement by a victim entity, and addresses the interference discussed with reference to system 300 of FIG. 3. The base station 302 is illustrated as the aggressor entity or device, and the UE 312 is illustrated as the victim entity or device. The system 1800 also illustrates, using dashed arcs, a RX beam 1802 of the NCR 310, a transmit (TX) beam 1804 of the NCR 310, and a RX beam 1806 of the UE 312. DL interference management is performed at the UE 312.

A motivation for this approach in the system 1800 is that the DL interference from a nearby cell is measured by the victim UE directly, i.e., the measuring entity is identical to, or collocated with, the victim entity. Hence, the DL reference signal experiences a similar channel as the DL interference provided that parameters such as NCR beamforming and power/gain as well as UE beamforming are applied properly. In this case, the following parameters may be indicated or determined without an explicit indication to assist with measuring the interference at the UE 312. With respect to the NCR RX beam, the base station 304 may configure/signal the NCR 310 to apply a specific RX beam when receiving the CSI-RS signal. In some implementations, the NCR 310 may be configured/signaled to apply the RX beam the NCR 310 uses when receiving a DL signal from the base station 304.

In one or more implementations, the NCR 310 may determine to apply one or multiple RX beams associated with one or multiple RX beam parameters that the NCR 310 may apply to receive a DL signal from the base station 304. The one or multiple RX beam parameters may be indicated explicitly by the base station 304, or determined implicitly by the NCR 310 without an indication, to be identical to one or multiple RX beam parameters the NCR 310 may have used in a latest relaying of a DL communication from the base station 304 as a source and/or to the UE 312 as a destination.

In one example, the base station 304 may indicate to the NCR 310 to apply one or multiple RX beams associated with one or multiple RX beam parameters used in a latest relaying of a DL communication from the base station 304 to the UE 312. The DL communication may be a control communication (e.g., a PDCCH), a data communication (e.g., a PDSCH), a downlink reference signal, or the like. In another example, the NCR 310 may apply one or multiple RX beams associated with one or multiple RX beam parameters used in a latest relaying of a DL communication from the base station 304 to the UE 312 without receiving an explicit indication.

Additionally or alternatively, the NCR 310 may determine to apply one or multiple RX beams associated with a latest UE 312 beam report. The UE 312 beam report may be any CSI report comprising a beam index, such as a reference signal resource indicator (e.g., SS/PBCH block resource indicator (SSBRI), CSI-RS resource indicator (CRI), SRS resource locator (SRI)), where the UE 312 beam report may be associated with a CSI acquisition for a channel with the base station 304. This channel may be a direct channel between the base station 304 and the UE 312 or an indirect channel through the NCR 310.

With respect to the NCR TX beam, the base station 304 may configure/signal the NCR 310 to apply a specific TX beam when forwarding the CSI-RS signal. In some implementations, the NCR 310 may be configured/signaled to apply the TX beam the NCR 310 uses when forwarding a DL signal to the UE 312. In one or more implementations, the NCR 310 may determine to apply one or multiple TX beams associated with one or multiple TX beam parameters that the NCR 310 may apply to forward a DL signal to the UE 312. The one or multiple TX beam parameters may be indicated explicitly by the base station 304, or determined implicitly by the NCR 310 without an indication, to be identical to one or multiple TX beam parameters the NCR 310 may have used in a latest relaying of a DL communication from the base station 304 as a source and/or to the UE 312 as a destination.

In one example, the base station 304 may indicate to the NCR 310 to apply one or multiple TX beams associated with one or multiple TX beam parameters used in a latest relaying of a DL communication from the base station 304 to the UE 312. The DL communication may be a control communication (e.g., a PDCCH), a data communication (e.g., a PDSCH), a downlink reference signal, or the like. In another example, the NCR 310 may apply one or multiple TX beams associated with one or multiple TX beam parameters used in a latest relaying of a DL communication from the base station 304 to the UE 312 without receiving an explicit indication.

Additionally or alternatively, the NCR 310 may determine to apply one or multiple TX beams associated with a latest UE 312 beam report. The UE 312 beam report may be any CSI report comprising a beam index, such as a reference signal resource indicator (e.g., SSBRI, CRI, SRI), where the UE 312 beam report may be associated with a CSI acquisition for a channel with the base station 304. This channel may be a direct channel between the base station 304 and the UE 312 or an indirect channel through the NCR 310.

With respect to the NCR power/gain, the base station 304 may configure/signal the NCR 310 to apply a specific power/gain when forwarding the CSI-RS signal to the UE 312. In some implementations, the NCR 310 may be configured/signaled to apply the gain/power that the NCR 310 uses when forwarding a DL signal from the base station 304 and/or to the UE 312. In one or more implementations, the NCR 310 may determine to apply a power/gain that the NCR 310 may apply to forward a DL signal from the base station 304 and/or to the UE 312. The power/gain may be indicated explicitly by the base station 304, or determined implicitly by the NCR 310 without an indication, to be identical to a power/gain that the NCR 310 may have used in a latest relaying of a DL communication from the base station 304 as a source and/or to the UE 312 as a destination.

In one example, the base station 304 may indicate to the NCR 310 to apply a power/gain used in a latest relaying of a DL communication from the base station 304 to the UE 312. The DL communication may be a control communication (e.g., a PDCCH), a data communication (e.g., a PDSCH), a downlink reference signal, or the like. In another example, the NCR 310 may apply a power/gain used in a latest relaying of a DL communication from the base station 304 to the UE 312 without receiving an explicit indication. Additionally or alternatively, the NCR 310 may determine to apply a power/gain associated with a latest signaling of a downlink power/gain control.

With respect to the UE RX beam, the base station 304 may configure/signal the UE 312 to apply a specific RX beam when receiving the CSI-RS signal. In some implementations, the UE 312 may be configured/signaled to apply the RX beam the UE 312 uses when receiving a DL signal from the NCR 310 or the base station 304. In one or more implementations, the UE 312 may determine to apply one or multiple RX beams associated with one or multiple RX beam parameters that the UE 312 may apply to receive a DL signal from the base station 304. The one or multiple RX beam parameters may be indicated explicitly by the base station 304, or determined implicitly by the UE 312 without an indication, to be identical to one or multiple RX beam parameters the UE 312 may have used in a latest DL communication from the base station 304 as a source, through the NCR 310 as a relay, and/or to the UE 312 as a destination.

In one example, the base station 304 may indicate to the UE 312 to apply one or multiple RX beams associated with one or multiple RX beam parameters used in a latest DL communication from the base station 304 to the UE 312, either directly or through the NCR 310. The DL communication may be a control communication (e.g., a PDCCH), a data communication (e.g., a PDSCH), a downlink reference signal, or the like. In another example, the UE 312 may apply one or multiple RX beams associated with one or multiple RX beam parameters used in a latest DL communication from the base station 304 to the UE 312, either directly or through the NCR 310, without receiving an explicit indication.

Additionally or alternatively, the UE 312 may determine to apply one or multiple RX beams associated with a latest UE 312 beam report. The UE 312 beam report may be any CSI report comprising a beam index, such as a reference signal resource indicator (e.g., SSBRI, CRI, SRI), where the UE 312 beam report may be associated with a CSI acquisition for a channel with the base station 304. This channel may be a direct channel between the base station 304 and the UE 312 or an indirect channel through the NCR 310. Next, the UE 312 receives the forwarded CSI-RS and performs a measurement to obtain an estimate of the interference that an associated DL communication from the base station 302 may cause on the UE 312.

FIG. 19 illustrates an example of a system 1900 that supports reducing interference for NCRs in accordance with aspects of the present disclosure. The system 1900 illustrates an example of a UL signal in an aggressor cell, UL interference in a victim cell, and measurement by a victim entity, and addresses the interference discussed with reference to system 500 of FIG. 5. The UE 502 is illustrated as the aggressor entity or device, and the base station 512 is illustrated as the victim entity or device. The system 1900 also illustrates, using dashed arcs, a RX beam 1902 of the NCR 510, a TX beam 1904 of the NCR 510, and a RX beam 1906 of the base station 512. UL interference management is performed at the base station 512.

A motivation for this approach in the system 1900 is that the UL interference from a nearby cell is measured by the victim base station directly, i.e., the measuring entity is identical to, or collocated with, the victim entity. Hence, the UL reference signal experiences a similar channel as the UL interference provided that parameters such as NCR beamforming and power/gain as well as base station beamforming are applied properly. In this case, the following parameters may be indicated or determined without an explicit indication to assist with measuring the interference at the base station 512.

With respect to the NCR RX beam, the base station 512 may configure/signal the NCR 510 to apply a specific RX beam when receiving the SRS signal. In some implementations, the NCR 510 may be configured/signaled to apply the RX beam the NCR 510 uses when receiving a UL signal from the UE 504. In one or more implementations, the NCR 510 may determine to apply one or multiple RX beams associated with one or multiple RX beam parameters that the NCR 510 may apply to receive a UL signal from the UE 504. The one or multiple RX beam parameters may be indicated explicitly by the base station 512, or determined implicitly by the NCR 510 without an indication, to be identical to one or multiple RX beam parameters the NCR 510 may have used in a latest relaying of a UL communication from the UE 504 as a source and/or to the base station 512 as a destination.

In one example, the base station 512 may indicate to the NCR 510 to apply one or multiple RX beams associated with one or multiple RX beam parameters used in a latest relaying of a UL communication from the UE 504 to the base station 512. The UL communication may be a control communication (e.g., a PUCCH), a data communication (e.g., a PUSCH), an uplink reference signal, or the like. In another example, the NCR 510 may apply one or multiple RX beams associated with one or multiple RX beam parameters used in a latest relaying of a UL communication from the UE 504 to the base station 512 without receiving an explicit indication.

Additionally or alternatively, the NCR 510 may determine to apply one or multiple RX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. This channel may be a direct channel between the base station 512 and the UE 504 or an indirect channel through the NCR 510.

With respect to the NCR TX beam, the base station 512 may configure/signal the NCR 510 to apply a specific TX beam when forwarding the SRS signal. In some implementations, the NCR 510 may be configured/signaled to apply the TX beam the NCR 510 uses when forwarding a UL signal to the base station 512. In one or more implementations, the NCR 510 may determine to apply one or multiple TX beams associated with one or multiple TX beam parameters that the NCR 510 may apply to forward a UL signal to the base station 512. The one or multiple TX beam parameters may be indicated explicitly by the base station 512, or determined implicitly by the NCR 510 without an indication, to be identical to one or multiple TX beam parameters the NCR 510 may have used in a latest relaying of a UL communication from the base station 512 as a source and/or to the UE 504 as a destination.

In one example, the base station 512 may indicate to the NCR 510 to apply one or multiple TX beams associated with one or multiple TX beam parameters used in a latest relaying of a UL communication from the base station 512 to the UE 504. The UL communication may be a control communication (e.g., a PUCCH), a data communication (e.g., a PUSCH), an uplink reference signal, or the like. In another example, the NCR 510 may apply one or multiple TX beams associated with one or multiple TX beam parameters used in a latest relaying of a UL communication from the UE 504 to the base station 512 without receiving an explicit indication.

Additionally or alternatively, the NCR 510 may determine to apply one or multiple TX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. This channel may be a direct channel between the base station 512 and the UE 504 or an indirect channel through the NCR 510.

With respect to the NCR power/gain, the base station 512 may configure/signal the NCR 510 to apply a specific power/gain when forwarding the SRS signal to the base station 512. In some implementations, the NCR 510 may be configured/signaled to apply the gain/power that the NCR 510 uses when forwarding a UL signal from the UE 504 and/or to the base station 512. In one or more implementations, the NCR 510 may determine to apply a power/gain that the NCR 510 may apply to forward a UL signal from the UE 504 and/or to the base station 512. The power/gain may be indicated explicitly by the base station 512, or determined implicitly by the NCR 510 without an indication, to be identical to a power/gain that the NCR 510 may have used in a latest relaying of a UL communication from the UE 504 as a source and/or to the base station 512 as a destination.

In one example, the base station 512 may indicate to the NCR 510 to apply a power/gain used in a latest relaying of a UL communication from the UE 504 to the base station 512. The UL communication may be a control communication (e.g., a PUCCH), a data communication (e.g., a PUSCH), a downlink reference signal, or the like. In another example, the NCR 510 may apply a power/gain used in a latest relaying of a UL communication from the UE 504 to the base station 512 without receiving an explicit indication. Additionally or alternatively, the NCR 510 may determine to apply a power/gain associated with a latest signaling of an uplink power/gain control.

With respect to the base station RX beam, the base station 512 may apply a specific beam when receiving the SRS signal. In some implementations, the base station 512 may apply the beam the base station 512 uses when receiving a UL signal from the NCR 510 or the UE 504. In one or more implementations, the base station 512 may determine to apply one or multiple RX beams associated with one or multiple RX beam parameters that the base station 512 may apply to receive a UL signal from the UE 504. The one or multiple RX beam parameters may be determined to be identical to one or multiple RX beam parameters the base station 512 may have used in a latest UL communication from the UE 504 as a source, through the NCR 510 as a relay, and/or to the base station 512 as a destination.

In one example, the base station 512 may determine to apply one or multiple RX beams associated with one or multiple RX beam parameters used in a latest UL communication from the UE 504 to the base station 512, either directly or through the NCR 510. The UL communication may be a control communication (e.g., a PUCCH), a data communication (e.g., a PUSCH), a downlink reference signal, or the like. Additionally or alternatively, the base station 512 may determine to apply one or multiple RX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. This channel may be a direct channel between the base station 512 and the UE 504 or an indirect channel through the NCR 510. Next, the base station 512 receives the forwarded SRS and performs a measurement to obtain an estimate of the interference an associated UL communication from the UE 502 may cause on the base station 512.

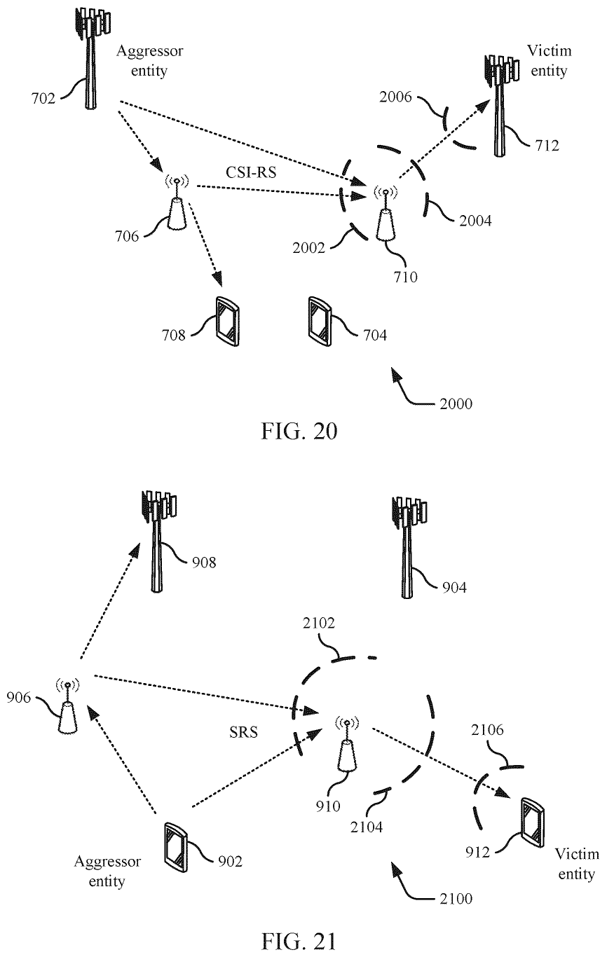

FIG. 20 illustrates an example of a system 2000 that supports reducing interference for NCRs in accordance with aspects of the present disclosure. The system 2000 illustrates an example of a DL signal in an aggressor cell, UL interference in a victim cell, and measurement by a victim entity, and addresses the interference discussed with reference to system 700 of FIG. 7. The base station 702 is illustrated as the aggressor entity or device, and the base station 712 is illustrated as the victim entity or device. The system 2000 also illustrates, using dashed arcs, a RX beam 2002 of the NCR 710, a TX beam 2004 of the NCR 710, and a RX beam 2006 of the base station 712. UL interference management is performed at the base station 712.

A motivation for this approach in the system 2000 is that the UL interference from a nearby cell is measured by the victim base station directly, i.e., the measuring entity is identical to, or collocated with, the victim entity. Hence, the DL reference signal experiences a similar channel as the UL interference provided that parameters such as NCR beamforming and power/gain as well as the base station beamforming are applied properly. In this case, the following parameters may be indicated or determined without an explicit indication to assist with measuring the interference at the base station 712.

With respect to the NCR RX beam, the base station 712 may configure/signal the NCR 710 to apply a specific RX beam when receiving the CSI-RS signal. In some implementations, the NCR 710 may be configured/signaled to apply the RX beam the NCR 710 uses when receiving a UL signal from the UE 704. In one or more implementations, the NCR 710 may determine to apply one or multiple RX beams associated with one or multiple RX beam parameters that the NCR 710 may apply to receive a UL signal from the UE 704. The one or multiple RX beam parameters may be indicated explicitly by the base station 712, or determined implicitly by the NCR 710 without an indication, to be identical to one or multiple RX beam parameters the NCR 710 may have used in a latest relaying of a UL communication from the UE 704 as a source and/or to the base station 712 as a destination.

In one example, the base station 712 may indicate to the NCR 710 to apply one or multiple RX beams associated with one or multiple RX beam parameters used in a latest relaying of a UL communication from the UE 704 to the base station 712. The UL communication may be a control communication (e.g., a PUCCH), a data communication (e.g., a PUSCH), an uplink reference signal, or the like. In another example, the NCR 710 may apply one or multiple RX beams associated with one or multiple RX beam parameters used in a latest relaying of a UL communication from the UE 704 to the base station 712 without receiving an explicit indication.

Additionally or alternatively, the NCR 710 may determine to apply one or multiple RX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. This channel may be a direct channel between the base station 712 and the UE 704 or an indirect channel through the NCR 710.

With respect to the NCR TX beam, the base station 712 may configure/signal the NCR 710 to apply a specific TX beam when forwarding the CSI-RS signal. In some implementations, the NCR 710 may be configured/signaled to apply the TX beam the NCR 710 uses when forwarding a UL signal to the base station 712. In one or more implementations, the NCR 710 may determine to apply one or multiple TX beams associated with one or multiple TX beam parameters that the NCR 710 may apply to forward a UL signal to the base station 712. The one or multiple TX beam parameters may be indicated explicitly by the base station 712, or determined implicitly by the NCR 710 without an indication, to be identical to one or multiple TX beam parameters the NCR 710 may have used in a latest relaying of a UL communication from the base station 712 as a source and/or to the UE 704 as a destination.

In one example, the base station 712 may indicate to the NCR 710 to apply one or multiple TX beams associated with one or multiple TX beam parameters used in a latest relaying of a UL communication from the base station 712 to the UE 704. The UL communication may be a control communication (e.g., a PUCCH), a data communication (e.g., a PUSCH), an uplink reference signal, or the like. In another example, the NCR 710 may apply one or multiple TX beams associated with one or multiple TX beam parameters used in a latest relaying of a UL communication from the UE 704 to the base station 712 without receiving an explicit indication. Additionally or alternatively, the NCR 710 may determine to apply one or multiple TX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. The said channel may be a direct channel between the base station 712 and the UE 704 or an indirect channel through the NCR 710.

With respect to the NCR power/gain, the base station 712 may configure/signal the NCR 710 to apply a specific power/gain when forwarding the CSI-RS signal to the base station 712. In some implementations, the NCR 710 may be configured/signaled to apply the gain/power that the NCR 710 uses when forwarding a UL signal from the UE 704 and/or to the base station 712. In one or more implementations, the NCR 710 may determine to apply a power/gain that the NCR 710 may apply to forward a UL signal from the UE 704 and/or to the base station 712. The power/gain may be indicated explicitly by the base station 712, or determined implicitly by the NCR 710 without an indication, to be identical to a power/gain that the NCR 710 may have used in a latest relaying of a UL communication from the UE 704 as a source and/or to the base station 712 as a destination.

In one example, the base station 712 may indicate to the NCR 710 to apply a power/gain used in a latest relaying of a UL communication from the UE 704 to the base station 712. The UL communication may be a control communication (e.g., a PUCCH), a data communication (e.g., a PUSCH), a downlink reference signal, or the like. In another example, the NCR 710 may apply a power/gain used in a latest relaying of a UL communication from the UE 704 to the base station 712 without receiving an explicit indication. Additionally or alternatively, the NCR 710 may determine to apply a power/gain associated with a latest signaling of an uplink power/gain control.

With respect to the base station RX beam, the base station 712 may apply a specific beam when receiving the CSI-RS signal. In some implementations, the base station 712 may apply the beam the base station 712 uses when receiving a UL signal from the NCR 710 or the UE 704. In one or more implementations, the base station 712 may determine to apply one or multiple RX beams associated with one or multiple RX beam parameters that the base station 712 may apply to receive a UL signal from the UE 704. The one or multiple RX beam parameters may be determined to be identical to one or multiple RX beam parameters the base station 712 may have used in a latest UL communication from the UE 704 as a source, through the NCR 710 as a relay, and/or to the base station 712 as a destination.

In one example, the base station 712 may determine to apply one or multiple RX beams associated with one or multiple RX beam parameters used in a latest UL communication from the UE 704 to the base station 712, either directly or through the NCR 710. The UL communication may be a control communication (e.g., a PUCCH), a data communication (e.g., a PUSCH), a downlink reference signal, or the like. Additionally or alternatively, the base station 712 may determine to apply one or multiple RX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. The said channel may be a direct channel between the base station 712 and the UE 704 or an indirect channel through the NCR 710. Next, the base station 712 receives the forwarded CSI-RS and performs a measurement to obtain an estimate of the interference an associated DL communication from the base station 702 may cause on the base station 712.

FIG. 21 illustrates an example of a system 2100 that supports reducing interference for NCRs in accordance with aspects of the present disclosure. The system 2100 illustrates an example of a UL signal in an aggressor cell, DL interference in a victim cell, and measurement by a victim entity, and addresses the interference discussed with reference to system 900 of FIG. 9. The UE 902 is illustrated as the aggressor entity or device, and the UE 912 is illustrated as the victim entity or device. The system 2100 also illustrates, using dashed arcs, a RX beam 2102 of the NCR 910, a TX beam 2104 of the NCR 910, and a RX beam 2106 of the UE 912. DL interference management is performed at the UE 912.

A motivation for this approach in the system 1000 is that the DL interference from a nearby cell is measured by the victim UE directly, i.e., the measuring entity is identical to, or collocated with, the victim entity. Hence, the UL reference signal experiences a similar channel as the DL interference provided that parameters such as NCR beamforming and power/gain as well as UE beamforming are applied properly. The UE 912 may apply methods of UE-UE cross-link interference (CLI) measurement for obtaining an estimate of the interference. In this case, the following parameters may be indicated or determined without an explicit indication to assist with measuring the interference at the UE 912.

With respect to the NCR RX beam, the base station 904 may configure/signal the NCR 910 to apply a specific RX beam when receiving the SRS signal. In some implementations, the NCR 910 may be configured/signaled to apply the RX beam the NCR 910 uses when receiving a DL signal from the base station 904. In one or more implementations, the NCR 910 may determine to apply one or multiple RX beams associated with one or multiple RX beam parameters that the NCR 910 may apply to receive a DL signal from the base station 904. The one or multiple RX beam parameters may be indicated explicitly by the base station 904, or determined implicitly by the NCR 910 without an indication, to be identical to one or multiple RX beam parameters the NCR 910 may have used in a latest relaying of a DL communication from the base station 904 as a source and/or to the UE 912 as a destination.

In one example, the base station 904 may indicate to the NCR 910 to apply one or multiple RX beams associated with one or multiple RX beam parameters used in a latest relaying of a DL communication from the base station 904 to the UE 912. The DL communication may be a control communication (e.g., a PDCCH), a data communication (e.g., a PDSCH), a downlink reference signal, or the like. In another example, the NCR 910 may apply one or multiple RX beams associated with one or multiple RX beam parameters used in a latest relaying of a DL communication from the base station 904 to the UE 912 without receiving an explicit indication.

Additionally or alternatively, the NCR 910 may determine to apply one or multiple RX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. The said channel may be a direct channel between the base station 904 and the UE 912 or an indirect channel through the NCR 910. With respect to the NCR TX beam, the base station 904 may configure/signal the NCR 910 to apply a specific TX beam when forwarding the SRS signal. In some implementations, the NCR 910 may be configured/signaled to apply the TX beam the NCR 910 uses when forwarding a DL signal to the UE 912.

In one or more implementations, the NCR 910 may determine to apply one or multiple TX beams associated with one or multiple TX beam parameters that the NCR 910 may apply to forward a DL signal to the UE 912. The one or multiple TX beam parameters may be indicated explicitly by the base station 904, or determined implicitly by the NCR 910 without an indication, to be identical to one or multiple TX beam parameters the NCR 910 may have used in a latest relaying of a DL communication from the base station 904 as a source and/or to the UE 912 as a destination. In one example, the base station 904 may indicate to the NCR 910 to apply one or multiple TX beams associated with one or multiple TX beam parameters used in a latest relaying of a DL communication from the base station 904 to the UE 912. The DL communication may be a control communication (e.g., a PDCCH), a data communication (e.g., a PDSCH), a downlink reference signal, or the like.

In another example, the NCR 910 may apply one or multiple TX beams associated with one or multiple TX beam parameters used in a latest relaying of a DL communication from the base station 904 to the UE 912 without receiving an explicit indication. Additionally or alternatively, the NCR 910 may determine to apply one or multiple TX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. The said channel may be a direct channel between the base station 904 and the UE 912 or an indirect channel through the NCR 910.

With respect to the NCR power/gain, the base station 904 may configure/signal the NCR 910 to apply a specific power/gain when forwarding the SRS signal to the UE 912. In some implementations, the NCR 910 may be configured/signaled to apply the gain/power that the NCR 910 uses when forwarding a DL signal from the base station 904 and/or to the UE 912. In one or more implementations, the NCR 910 may determine to apply a power/gain that the NCR 910 may apply to forward a DL signal from the base station 904 and/or to the UE 912. The power/gain may be indicated explicitly by the base station 904, or determined implicitly by the NCR 910 without an indication, to be identical to a power/gain that the NCR 910 may have used in a latest relaying of a DL communication from the base station 904 as a source and/or to the UE 912 as a destination.

In one example, the base station 904 may indicate to the NCR 910 to apply a power/gain used in a latest relaying of a DL communication from the base station 904 to the UE 912. The DL communication may be a control communication (e.g., a PDCCH), a data communication (e.g., a PDSCH), a downlink reference signal, or the like. In another example, the NCR 910 may apply a power/gain used in a latest relaying of a DL communication from the base station 904 to the UE 912 without receiving an explicit indication. Additionally or alternatively, the NCR 910 may determine to apply a power/gain associated with a latest signaling of a downlink power/gain control.

With respect to the UE RX beam, the base station 904 may configure/signal the UE 912 to apply a specific RX beam when receiving the SRS signal. In some implementations, the UE 912 may be configured/signaled to apply the RX beam the UE 912 uses when receiving a DL signal from the NCR 910 or the base station 904. In one or more implementations, the UE 912 may determine to apply one or multiple RX beams associated with one or multiple RX beam parameters that the UE 912 may apply to receive a DL signal from the base station 904. The one or multiple RX beam parameters may be indicated explicitly by the base station 904, or determined implicitly by the UE 912 without an indication, to be identical to one or multiple RX beam parameters the UE 912 may have used in a latest DL communication from the base station 904 as a source, through the NCR 910 as a relay, and/or to the UE 912 as a destination.

In one example, the base station 904 may indicate to the UE 912 to apply one or multiple RX beams associated with one or multiple RX beam parameters used in a latest DL communication from the base station 904 to the UE 912, either directly or through the NCR 910. The DL communication may be a control communication (e.g., a PDCCH), a data communication (e.g., a PDSCH), a downlink reference signal, or the like. In another example, the UE 912 may apply one or multiple RX beams associated with one or multiple RX beam parameters used in a latest DL communication from the base station 904 to the UE 912, either directly or through the NCR 910, without receiving an explicit indication.

Additionally or alternatively, the UE 912 may determine to apply one or multiple RX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. The said channel may be a direct channel between the base station 904 and the UE 912 or an indirect channel through the NCR 910. Next, the UE 912 receives the forwarded SRS and performs a measurement to obtain an estimate of the interference that an associated UL communication from the UE 902 may cause on the UE 912.

As discussed above, a reference signal, referred to as a CIRS, is used to inform the neighboring entities or cells ahead of time about an upcoming interference by an associated communication. According to different implementations, a base station or a UE in a neighboring cell may perform a measurement on the CIRS to determine whether and how much interference to expect from an associated communication. As discussed in more detail below, in one or more implementations an interference measurement on a reference signal is performed through the NCR by an entity other than the victim base station or victim UE. For example, consider a first base station connected to a first NCR whose communication may interfere with communication of a nearby second base station. The first base station may serve a first UE directly, indirectly via the first NCR, or a combination thereof. The second base station may serve a second UE directly, indirectly via the second NCR, or a combination thereof. A signal transmitted by the first base station and potentially repeated by the first NCR to the first UE is called a DL signal. A signal transmitted by the first UE and potentially repeated by the first NCR to the first base station is called a UL signal.

Referring again to the system 300 of FIG. 3, in several implementations, the base station 302 configures a downlink CIRS, such as an SS/PBCH block or a CSI-RS, in association with a downlink communication element as discussed above. For ease of reference and better illustration, and without intending to limit the scope, the reference signal is assumed a CSI-RS and the downlink communication element is simply called the DL communication/signal. The signal of the DL communication may be transmitted by base station 302 and received by the UE 308. The DL signal may or may not be repeated by the NCR 306.

In one or more implementations, the base station 302 may transmit at least two replicas of the DL signal, one directly to the UE 308 and one indirectly through the NCR 306. The at least two replicas may be multiplexed in time (TDM), frequency (FDM), and/or through multiple antennas on same time and/or frequency resources (SDM/multi-panel). In one or more implementations, the NCR 310 receives the CSI-RS, according to a configuration/signaling, and forwards the signal to the base station 304. Then, the base station 304 performs an interference measurement on the CSI-RS in order to determine whether an associated DL communication from the base station 302 will interfere with desired communication at any UE served through the NCR 310. The base station 304 may obtain an estimate of the interference through the measurement as well.

FIG. 22 illustrates an example of a system 2200 that supports reducing interference for NCRs in accordance with aspects of the present disclosure. The system 2200 illustrates an example of a DL signal in an aggressor cell, DL interference in a victim cell, and measurement by another entity (e.g., an entity other than a victim entity), and addresses the interference discussed with reference to system 300 of FIG. 3. The base station 302 is illustrated as the aggressor entity or device, and the UE 312 is illustrated as the victim entity or device. The system 2200 also illustrates, using dashed arcs, a RX and TX beam 2202 of the NCR 310, and a RX beam 2204 of the base station 304. DL interference management is performed at the base station 304.

A motivation for this approach is that the DL interference from a nearby cell is measured by the base station in the victim cell instead of the victim UE(s). This allows the base station to obtain a firsthand estimate of the interference without requiring a reporting from any UEs. Furthermore, the base station may use the information of the obtained estimate for scheduling and link adaptation with any UE served through the NCR in the victim cell. This flexibility comes at the cost of additional complexity as the measuring entity, in this case, is not identical to, or collocated with, the victim entity itself. In this case, the following parameters may be indicated or determined without an explicit indication to assist with measuring the interference at a UE by the base station 304.

With respect to the NCR RX beam, the base station 304 may configure/signal the NCR 310 to apply a specific RX beam when receiving the CSI-RS signal. In some implementations, the NCR 310 may be configured/signaled to apply the RX beam the NCR 310 uses when receiving a DL signal from the base station 304. In one or more implementations, the NCR 310 may determine to apply one or multiple RX beams associated with one or multiple RX beam parameters that the NCR 310 may apply to receive a DL signal from the base station 304. The one or multiple RX beam parameters may be indicated explicitly by the base station 304, or determined implicitly by the NCR 310 without an indication, to be identical to one or multiple RX beam parameters the NCR 310 may have used in a latest relaying of a DL communication from the base station 304 as a source and/or to the UE 312 as a destination.

In one example, the base station 304 may indicate to the NCR 310 to apply one or multiple RX beams associated with one or multiple RX beam parameters used in a latest relaying of a DL communication from the base station 304 to the UE 312. The DL communication may be a control communication (e.g., a PDCCH), a data communication (e.g., a PDSCH), a downlink reference signal, or the like. In another example, the NCR 310 may apply one or multiple RX beams associated with one or multiple RX beam parameters used in a latest relaying of a DL communication from the base station 304 to the UE 312 without receiving an explicit indication.

Additionally or alternatively, the NCR 310 may determine to apply one or multiple RX beams associated with a latest UE 312 beam report. The UE 312 beam report may be any CSI report comprising a beam index, such as a reference signal resource indicator (e.g., SSBRI, CRI, SRI), where the UE 312 beam report may be associated with a CSI acquisition for a channel with the base station 304. This channel may be a direct channel between the base station 304 and the UE 312 or an indirect channel through the NCR 310.

With respect to the NCR TX beam, the base station 304 may configure/signal the NCR 310 to apply a specific TX beam when forwarding the CSI-RS signal. In some implementations, the NCR 310 may be configured/signaled to apply the TX beam the NCR 310 uses when forwarding a UL signal to the base station 304. In one or more implementations, the NCR 310 may determine to apply one or multiple TX beams associated with one or multiple TX beam parameters that the NCR 310 may apply to forward a UL signal to the base station 304. The one or multiple TX beam parameters may be indicated explicitly by the base station 304, or determined implicitly by the NCR 310 without an indication, to be identical to one or multiple TX beam parameters the NCR 310 may have used in a latest relaying of a UL communication from the UE 312 as a source and/or to the base station 304 as a destination.

In one example, the base station 304 may indicate to the NCR 310 to apply one or multiple TX beams associated with one or multiple TX beam parameters used in a latest relaying of a UL communication from the base station 304 to the UE 312. The UL communication may be a control communication (e.g., a PUCCH), a data communication (e.g., a PUSCH), an uplink reference signal, or the like. In another example, the NCR 310 may apply one or multiple TX beams associated with one or multiple TX beam parameters used in a latest relaying of a UL communication from the UE 312 to the base station 304 without receiving an explicit indication.

Additionally or alternatively, the NCR 310 may determine to apply one or multiple TX beams associated with a latest UE 312 beam report. The UE 312 beam report may be any CSI report comprising a beam index, such as a reference signal resource indicator (e.g., SSBRI, CRI, SRI), where the UE 312 beam report may be associated with a CSI acquisition for a channel with the base station 304. The said channel may be a direct channel between the base station 304 and the UE 312 or an indirect channel through the NCR 310.

A potential issue that appears in this case is that, due to channel reciprocity, the antenna panel(s) used to apply the NCR 310 TX beam(s) to forward the CSI-RS to the base station 304 may be identical to, or overlap with, the antenna panel(s) used to apply the NCR 310 RX beam(s) to receive the CSI-RS. If this is the case, the NCR 310 may not be able to perform the receiving and forwarding operations simultaneously unless at least one of the following conditions holds: the antenna panel(s) are capable of full-duplex (FD) operation; or the NCR 310 is capable of receiving the CSI-RS through the RX beam(s), storing (buffering) samples of the CSI-RS, and then forwarding the CSI-RS samples through the TX beam(s) at a later time.

In one or more implementations, the base station 304 may configure/signal the NCR 310 to forward the CSI-RS to the base station 304 if the NCR 310 has a full-duplex capability. Additionally or alternatively, the base station 304 may configure/signal the NCR 310 to forward the CSI-RS to the base station 304 if the NCR 310 has a capability to store (buffer) signals. The base station 304 may be informed of the aforementioned capabilities (full-duplex operation and/or signal buffering) of the NCR 310 by at least one of the following: a capability signaling from the NCR 310 at the time of establishing a control link between the NCR 310 and the base station 304; a capability signaling from the NCR 310 in response to an inquiry for the capability information from the base station 304; or the base station 304 (pre-) configuration or a network configuration. Addressing this issue by performing interference measurement at the NCR 310 itself is discussed in more detail below.

With respect to NCR power/gain, the base station 304 may configure/signal the NCR 310 to apply a specific power/gain when forwarding the CSI-RS signal to the base station 304. In one or more implementations, the NCR 310 may be configured/signaled to apply at least one of the following: the gain/power the NCR 310 uses when forwarding a UL signal from the UE 312 and/or to the base station 304, the gain/power the NCR 310 uses when forwarding a DL signal from the base station 304 and/or to the UE 312, or a function of either or both of the above. In one or more implementations, the NCR 310 may determine to apply a power/gain that the NCR 310 may apply to forward a UL signal from the UE 312 and/or to the base station 304. The power/gain may be indicated explicitly by the base station 304, or determined implicitly by the NCR 310 without an indication, to be identical to a power/gain that the NCR 310 may have used in a latest relaying of a UL communication from the UE 312 as a source and/or to the base station 304 as a destination.

In one example, the base station 304 may indicate to the NCR 310 to apply a power/gain used in a latest relaying of a UL communication from the UE 312 to the base station 304. The UL communication may be a control communication (e.g., a PUCCH), a data communication (e.g., a PUSCH), a downlink reference signal, or the like. In another example, the NCR 310 may apply a power/gain used in a latest relaying of a UL communication from the UE 312 to the base station 304 without receiving an explicit indication.

Additionally or alternatively, the NCR 310 may determine to apply a power/gain that the NCR 310 may apply to forward a DL signal from the base station 304 and/or to the UE 312. The power/gain may be indicated explicitly by the base station 304, or determined implicitly by the NCR 310 without an indication, to be identical to a power/gain that the NCR 310 may have used in a latest relaying of a DL communication from the base station 304 as a source and/or to the UE 312 as a destination. In one example, the base station 304 may indicate to the NCR 310 to apply a power/gain used in a latest relaying of a DL communication from the base station 304 to the UE 312. The DL communication may be a control communication (e.g., a PDCCH), a data communication (e.g., a PDSCH), a downlink reference signal, or the like. In another example, the NCR 310 may apply a power/gain used in a latest relaying of a DL communication from the base station 304 to the UE 312 without receiving an explicit indication.

A potential issue with both of the above implementations is that applying the gain/power without additional information does not allow the measuring entity to obtain an estimate of interference at the victim entity. It should be noted that in some of the discussions above (e.g., the system 400 of FIG. 4), the measuring entity is identical to, or collocated with, the victim entity. Hence, it may be assumed that the reference signal (dubbed CIRS here) transmitted by an aggressor entity experiences a similar channel as interference from the aggressor entity (provided that beamforming and power/gain parameters are applied properly). However, in the system 1100, due to the difference between NCR 310−base station 304 channel and the NCR 310−UE 312 channel, additional information is used in order to obtain an estimate of the actual interference at the victim entity based on the measurement on the reference signal at the measuring entity.

Let H_rb2 and H_ru2 denote the channel state of the NCR 310-base station 304 link and the NCR 310-UE 312 link, respectively. (H=channel, r=NCR, b=base station (e.g., gNB), u=UE). Provided that beamforming parameters are applied properly, their effect may be taken into account such that they may be omitted here. For example, if identical beamforming is applied for interference measurement and associated communication, their effect may cancel out. Here, the reference signal experiences an additional H_rb2 for measurement at the measuring entity (the base station 304), while the actual interfering communication will experience an additional H_ru2 at the victim entity (the UE 312) instead. Therefore, assuming that the channel state is multiplicative in the Fourier domain, the interference estimate at the base station 304 is multiplied by H_ru2/H_rb2 in order to obtain an estimate of the actual interference at the UE 312.

In one example, if only an amplitude of the interference is desired, the relationship between the measured interference at the base station 304 and the actual interference at the UE 312 may be obtained by: I_u2=I_b2+PL_ru2−PL_rb2. In this equation I_u2 is the actual interference at the UE 312 in dBm (or dBW); I_b2 is the measured power of the reference signal at the base station 304 in dBm (or dBW); PL_ru2 is the pathloss of the NCR2-UE2 link in dB; and PL_rb2 is the pathloss of the NCR2−the base station 304 link in dB. This difference can be taken into account in any of a variety of different manners.

In one or more implementations, the base station 304 obtains information of the difference, for example through CSI measurements at the base station 304, CSI measurement and reporting by the UE 312, CSI measurement and reporting by the NCR 310, or a combination thereof. Then, the base station 304 applies the difference in the interference estimation computations. Additionally or alternatively, the base station 304 obtains information of the difference, for example through CSI measurements at the base station 304, CSI measurement and reporting by the UE 312, CSI measurement and reporting by the NCR 310, or a combination thereof. Then, the base station 304 may configure/signal the NCR 310 to apply the difference in the power/gain when forwarding the CSI-RS to the base station 304. Additionally or alternatively, the NCR 310 obtains information of the difference, for example through CSI measurement and indication by the base station 304, CSI measurement at reporting by the UE 312, CSI measurement by the NCR 310, or a combination thereof. Then, the NCR 310 may apply the difference in the power/gain when forwarding the CSI-RS to the base station 304. This applying the difference may be with or without an indication from the base station 304.

Another potential issue appearing here is related to the full-duplex operation. As mentioned earlier, beamforming may use full-duplex operation by one or multiple antenna panel(s) at the NCR 310. In a full-duplex setup, the range of power/gain variation for transmitting a signal may be constrained by the power of the signal being received. As a result, the power/gain parameter may be constrained when forwarding the CSI-RS to the base station 304. In one or more implementations, the NCR 310 may apply a power/gain difference if it satisfies a constraint on power offset, self-interference, or the like. Otherwise, if the constraint is not satisfied, the NCR 310 may not apply the power/gain difference. In one implementation, the NCR 310 may transmit an error message indicating to the base station 304 that the constraint is not satisfied. Additionally or alternatively, the NCR 310 may not expect to apply a power/gain difference that does not satisfy a constraint on power offset, self-interference, or the like. In this case, the NCR 310 may inform the base station 304 of the constraint by a signaling such as a capability signaling.

With respect to the base station RX beam, the base station 304 may apply a specific RX beam when receiving the CSI-RS signal. In some implementations, the base station 304 may apply the RX beam the base station 304 uses when receiving a UL signal from the NCR 310 or the UE 312. In one or more implementations, the base station 304 may determine to apply one or multiple RX beams associated with one or multiple RX beam parameters that the base station 304 may apply to receive a UL signal from the UE 312. The one or multiple RX beam parameters may be determined to be identical to one or multiple RX beam parameters the base station 304 may have used in a latest UL communication from the UE 312 as a source, through the NCR 310 as a relay, and/or to the base station 304 as a destination.

In one example, the base station 304 may determine to apply one or multiple RX beams associated with one or multiple RX beam parameters used in a latest UL communication from the UE 312 to the base station 304, either directly or through the NCR 310. The UL communication may be a control communication (e.g., a PUCCH), a data communication (e.g., a PUSCH), an uplink reference signal, or the like. Additionally or alternatively, the base station 304 may determine to apply one or multiple RX beams associated with a latest UE2 beam report. The UE 312 beam report may be any CSI report comprising a beam index, such as a reference signal resource indicator (e.g., SSBRI, CRI, SRI), where the UE 312 beam report may be associated with a CSI acquisition for a channel with the base station 304. The said channel may be a direct channel between the base station 304 and the UE 312 or an indirect channel through the NCR 310. Next, the base station 304 receives the forwarded CSI-RS and performs a measurement to obtain an estimate of the interference an associated DL communication from the base station 302 may cause on any UE served by the base station 304 through the NCR 310.

Referring again to system 500 of FIG. 5, in several implementations, the base station 508 configures an uplink CIRS, such as an SRS, in association with an uplink communication element as discussed above. For ease of reference and better illustration, and without intending to limit the scope, the reference signal is assumed an SRS and the uplink communication element is simply called the UL communication/signal in this subsection. The signal of the UL communication may be transmitted by the UE 502 and received by the base station 508. The UL signal may or may not be repeated by the NCR 506. In one or more implementations, the UE 502 may transmit at least two replicas of the UL signal, one directly to the base station 508 and one indirectly through the NCR 506. The at least two replicas may be multiplexed in time (TDM), frequency (FDM), and/or through multiple antennas on same time and/or frequency resources (SDM/multi-panel). In one or more implementations, the NCR 510 receives the SRS according to a configuration/signaling and forwards the signal to the UE 504. Then, the UE 504 performs an interference measurement on the SRS in order to determine whether an associated UL communication from the UE 502 will interfere with desired communication at any base station. The UE 504 may obtain an estimate of the interference through the measurement as well.

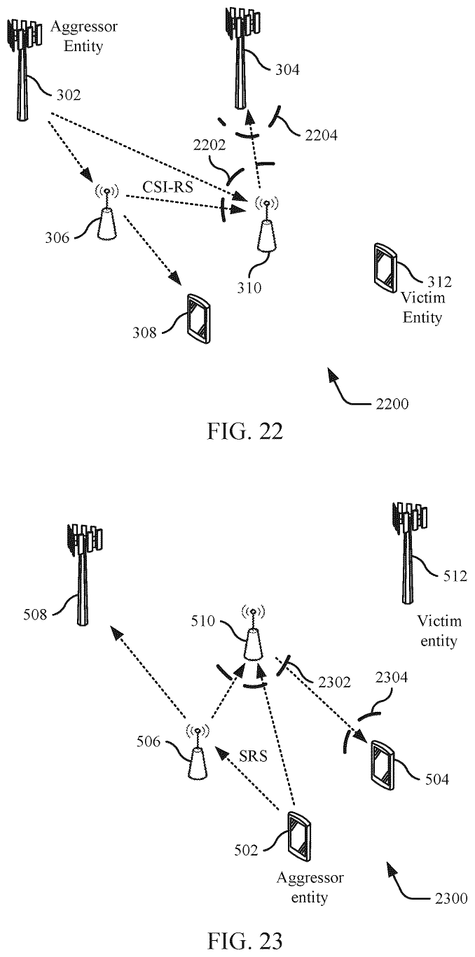

FIG. 23 illustrates an example of a system 2300 that supports reducing interference for NCRs in accordance with aspects of the present disclosure. The system 2300 illustrates an example of a UL signal in an aggressor cell, UL interference in a victim cell, and measurement by another entity (e.g., an entity other than a victim entity), and addresses the interference discussed with reference to system 500 of FIG. 5. The UE 502 is illustrated as the aggressor entity or device, and the base station 512 is illustrated as the victim entity or device. The system 2300 also illustrates, using dashed arcs, a RX and TX beam 2302 of the NCR 510, and a RX beam 2304 of the UE 504. UL interference management is performed at the UE 504.

A motivation for this approach is that the UL interference from a nearby cell is measured by the UE in the victim cell, which allows the victim base station to reuse cross-link interference (CLI) mechanisms that are normally used for UE-UE interference management. This allows the base station to delegate the task of interference measurement to UEs, which may free valuable resources of the base station, especially when a large number of NCRs are connected to the base station and measuring interference from moving UEs in the aggressor cell may be a resource-consuming task. In this case, the following parameters may be indicated or determined without an explicit indication to assist with measuring the interference at a base station by the UE 504.

With respect to the NCR RX beam, the base station 512 may configure/signal the NCR 510 to apply a specific RX beam when receiving the SRS signal. In some implementations, the NCR 510 may be configured/signaled to apply the RX beam the NCR 510 uses when receiving a UL signal from the UE 504. In one or more implementations, the NCR 510 may determine to apply one or multiple RX beams associated with one or multiple RX beam parameters that the NCR 510 may apply to receive a UL signal from the UE 504. The one or multiple RX beam parameters may be indicated explicitly by the base station 512, or determined implicitly by the NCR 510 without an indication, to be identical to one or multiple RX beam parameters the NCR 510 may have used in a latest relaying of a UL communication from the UE 504 as a source and/or to the base station 512 as a destination.

In one example, the base station 512 may indicate to the NCR 510 to apply one or multiple RX beams associated with one or multiple RX beam parameters used in a latest relaying of a UL communication from the UE 504 to the base station 512. The UL communication may be a control communication (e.g., a PUCCH), a data communication (e.g., a PUSCH), an uplink reference signal, or the like. In another example, the NCR 510 may apply one or multiple RX beams associated with one or multiple RX beam parameters used in a latest relaying of a UL communication from the UE 504 to the base station 512 without receiving an explicit indication. Additionally or alternatively, the NCR 510 may determine to apply one or multiple RX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. This channel may be a direct channel between the base station 512 and the UE 504 or an indirect channel through the NCR 510.

With respect to the NCR TX beam, the base station 512 may configure/signal the NCR 510 to apply a specific TX beam when forwarding the SRS signal. In some implementations, the NCR 510 may be configured/signaled to apply the TX beam the NCR 510 uses when forwarding a DL signal to the UE 504. In one or more implementations, the NCR 510 may determine to apply one or multiple TX beams associated with one or multiple TX beam parameters that the NCR 510 may apply to forward a DL signal to the UE 504. The one or multiple TX beam parameters may be indicated explicitly by the base station 512, or determined implicitly by the NCR 510 without an indication, to be identical to one or multiple TX beam parameters the NCR 510 may have used in a latest relaying of a DL communication from the base station 512 as a source and/or to the UE 504 as a destination.

In one example, the base station 512 may indicate to the NCR 510 to apply one or multiple TX beams associated with one or multiple TX beam parameters used in a latest relaying of a DL communication from the UE 504 to the base station 512. The DL communication may be a control communication (e.g., a PDCCH), a data communication (e.g., a PDSCH), a downlink reference signal, or the like. In another example, the NCR 510 may apply one or multiple TX beams associated with one or multiple TX beam parameters used in a latest relaying of a DL communication from the base station 512 to the UE 504 without receiving an explicit indication. Additionally or alternatively, the NCR 510 may determine to apply one or multiple TX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. This channel may be a direct channel between the base station 512 and the UE 504 or an indirect channel through the NCR 510.

A potential issue that appears in this case is that, due to channel reciprocity, the antenna panel(s) used to apply the NCR 510 TX beam(s) to forward the SRS to the UE 504 may be identical to, or overlap with, the antenna panel(s) used to apply the NCR 510 RX beam(s) to receive the SRS. If this is the case, the NCR 510 may not be able to perform the receiving and forwarding operations simultaneously unless at least one of the following conditions holds: the antenna panel(s) are capable of full-duplex (FD) operation; or the NCR 510 is capable of receiving the SRS through the RX beam(s), storing (buffering) samples of the SRS, and then forwarding the SRS samples through the TX beam(s) at a later time.

In one or more implementations, the base station 512 may configure/signal the NCR 510 to forward the SRS to the UE 504 if the NCR 510 has a full-duplex capability. Additionally or alternatively, the base station 512 may configure/signal the NCR 510 to forward the SRS to the UE 504 if the NCR 510 has a capability to store (buffer) signals. The base station 512 may be informed of the aforementioned capabilities (full-duplex operation and/or signal buffering) of the NCR 510 by at least one of the following: a capability signaling from the NCR 510 at the time of establishing a control link between the NCR 510 and the base station 512; a capability signaling from the NCR 510 in response to an inquiry for the capability information from the base station 512; or the base station 512 (pre-) configuration or a network configuration. Addressing this issue by performing interference measurement at the NCR 510 itself is discussed in more detail below.

With respect to NCR power/gain, the base station 512 may configure/signal the NCR 510 to apply a specific power/gain when forwarding the SRS signal to the UE 504. In one or more implementations, the NCR 510 may be configured/signaled to apply at least one of the following: the gain/power the NCR 510 uses when forwarding a UL signal from the UE 504 and/or to the base station 512, the gain/power the NCR 510 uses when forwarding a DL signal from the base station 512 and/or to the UE 504, or a function of either or both of the above. In one or more implementations, the NCR 510 may determine to apply a power/gain that the NCR 510 may apply to forward a UL signal from the UE 504 and/or to the base station 512. The power/gain may be indicated explicitly by the base station 512, or determined implicitly by the NCR 510 without an indication, to be identical to a power/gain that the NCR 510 may have used in a latest relaying of a UL communication from the UE 504 as a source and/or to the base station 512 as a destination.

In one example, the base station 512 may indicate to the NCR 510 to apply a power/gain used in a latest relaying of a UL communication from the UE 504 to the base station 512. The UL communication may be a control communication (e.g., a PUCCH), a data communication (e.g., a PUSCH), a downlink reference signal, or the like. In another example, the NCR 510 may apply a power/gain used in a latest relaying of a UL communication from the UE 504 to the base station 512 without receiving an explicit indication.

Additionally or alternatively, the NCR 510 may determine to apply a power/gain that the NCR 510 may apply to forward a DL signal from the base station 512 and/or to the UE 504. The power/gain may be indicated explicitly by the base station 512, or determined implicitly by the NCR 510 without an indication, to be identical to a power/gain that the NCR 510 may have used in a latest relaying of a DL communication from the base station 512 as a source and/or to the UE 504 as a destination. In one example, the base station 512 may indicate to the NCR 510 to apply a power/gain used in a latest relaying of a DL communication from the base station 512 to the UE 504. The DL communication may be a control communication (e.g., a PDCCH), a data communication (e.g., a PDSCH), a downlink reference signal, or the like. In another example, the NCR 510 may apply a power/gain used in a latest relaying of a DL communication from the base station 512 to the UE 504 without receiving an explicit indication.

A potential issue with both of the above implementations is that applying the gain/power without additional information does not allow the measuring entity to obtain an estimate of interference at the victim entity. It should be noted that in some of the discussions above, the measuring entity is identical to, or collocated with, the victim entity. Hence, it may be assumed that the reference signal (dubbed CIRS here) transmitted by an aggressor entity experiences a similar channel as interference from the aggressor entity (provided that beamforming and power/gain parameters are applied properly). However, in the system 1200, due to the difference between the NCR 510−base station 512 channel and the NCR 510−UE 504 channel, additional information is used in order to obtain an estimate of the actual interference at the victim entity based on the measurement on the reference signal at the measuring entity.

Let H_rb2 and H_ru2 denote the channel state of the NCR 510−base station 512 link and the NCR 510−UE 504 link, respectively. (H=channel, r=NCR, b=base station (e.g., gNB), u=UE). Provided that beamforming parameters are applied properly, their effect may be taken into account such that they may be omitted here. For example, if identical beamforming is applied for interference measurement and associated communication, their effect may cancel out. Here, the reference signal experiences an additional H_ru2 for measurement at the measuring entity (the UE 504), while the actual interfering communication will experience an additional H_rb2 at the victim entity (the base station 512) instead. Therefore, assuming that the channel state is multiplicative in the Fourier domain, the interference estimate at the UE 504 should be multiplied by H_rb2/H_ru2 in order to obtain an estimate of the actual interference at the base station 512.

In one example, if only an amplitude of the interference is desired, the relationship between the measured interference at the UE 504 and the actual interference at the base station 512 may be obtained by: I_b2=I_u2+PL_rb2−PL_ru2. In this equation: I_b2 is the actual interference at the base station 512 in dBm (or dBW); I_u2 is the measured power of the reference signal at the UE 504 in dBm (or dBW); PL_rb2 is the pathloss of the NCR 510−base station 512 link in dB; and PL_ru2 is the pathloss of the NCR 510−UE 504 link in dB. This difference can be taken into account in any of a variety of different manners.

In one or more implementations, the UE 504 transmits a report message to the base station 512, where the report message comprises an interference estimate based on the UE 504 measurement without partial or no adjustment according to the above. Then, the base station 512 obtains information of the aforementioned (channel state) difference, for example through CSI measurements at the base station 512, CSI measurement and reporting by the UE 504, CSI measurement and reporting by the NCR 510, or a combination thereof. Then, the base station 512 applies the difference to the reported interference estimate.

Additionally or alternatively, the base station 512 obtains information of the difference, for example through CSI measurements at the base station 512, CSI measurement and reporting by the UE 504, CSI measurement and reporting by the NCR 510, or a combination thereof. Then, the base station 512 may configure/signal the NCR 510 to apply the difference in the power/gain when forwarding the SRS to the UE 504. Additionally or alternatively, the NCR 510 obtains information of the difference, for example through CSI measurement and indication by the base station 512, CSI measurement at reporting by the UE 504, CSI measurement by the NCR 510, or a combination thereof. Then, the NCR 510 may apply the difference in the power/gain when forwarding the SRS to the UE 504. This applying the difference may be with or without an indication from the base station 512.

Another potential issue appearing here is related to the full-duplex operation. As mentioned earlier, beamforming may use full-duplex operation by one or multiple antenna panel(s) at the NCR 510. In a full-duplex setup, the range of power/gain variation for transmitting a signal may be constrained by the power of the signal being received. As a result, the power/gain parameter may be constrained when forwarding the SRS to the UE 504. In one or more implementations, the NCR 510 may apply a power/gain difference if it satisfies a constraint on power offset, self-interference, or the like. Otherwise, if the constraint is not satisfied, the NCR 510 may not apply the power/gain difference. In one implementations, the NCR 510 may transmit an error message indicating to the base station 512 that the constraint is not satisfied. Additionally or alternatively, the NCR 510 may not expect to apply a power/gain difference that does not satisfy a constraint on power offset, self-interference, or the like. In this case, the NCR 510 may inform the base station 512 of the constraint by a signaling such as a capability signaling.

With respect to the UE RX beam, the UE 504 may apply a specific RX beam when receiving the SRS signal. In some implementations, the UE 504 may apply the beam the UE 504 uses when receiving a DL signal from the NCR 510 or the base station 512. In one or more implementations, the UE 504 may determine to apply one or multiple RX beams associated with one or multiple RX beam parameters that the UE 504 may apply to receive a DL signal from the base station 512. The one or multiple RX beam parameters may be determined to be identical to one or multiple RX beam parameters the UE 504 may have used in a latest DL communication from the base station 512 as a source, through the NCR 510 as a relay, and/or to the UE 504 as a destination.

In one example, the UE 504 may determine to apply one or multiple RX beams associated with one or multiple RX beam parameters used in a latest DL communication from the base station 512 to the UE 504, either directly or through the NCR 510. The DL communication may be a control communication (e.g., a PDCCH), a data communication (e.g., a PDSCH), a downlink reference signal, or the like. Additionally or alternatively, the base station 512 may determine to apply one or multiple RX beams associated with a latest UE 504 beam report. The UE 504 beam report may be any CSI report comprising a beam index, such as a reference signal resource indicator (e.g., SSBRI, CRI, SRI), where the UE 504 beam report may be associated with a CSI acquisition for a channel with the base station 512. The said channel may be a direct channel between the base station 512 and the UE 504 or an indirect channel through the NCR 510. Next, the UE 504 receives the forwarded SRS and performs a measurement to obtain an estimate of the interference an associated UL communication from the UE 502 may cause on any base station serving the UE 504 through the NCR 510.

Referring again to the system 700 of FIG. 7, in several implementations the base station 702 configures a downlink CIRS, such as an SS/PBCH block or a CSI-RS, in association with downlink communication element as discussed above. For ease of reference and better illustration, and without intending to limit the scope, the reference signal is assumed a CSI-RS and the downlink communication element is simply called the DL communication/signal. The signal of the DL communication may be transmitted by the base station 702 and received by the UE 708. The DL signal may or may not be repeated by the NCR 706.

In one or more implementations, the base station 702 may transmit at least two replicas of the DL signal, one directly to the UE 708 and one indirectly through the NCR 706. The at least two replicas may be multiplexed in time (TDM), frequency (FDM), and/or through multiple antennas on same time and/or frequency resources (SDM/multi-panel). In one or more implementations, the NCR 710 receives the CSI-RS according to a configuration/signaling and forwards the signal to the UE 704. Then, the UE 704 performs an interference measurement on the CSI-RS in order to determine whether an associated DL communication from the base station 702 will interfere with desired communication at any base station. The UE 704 may obtain an estimate of the interference through the measurement as well.

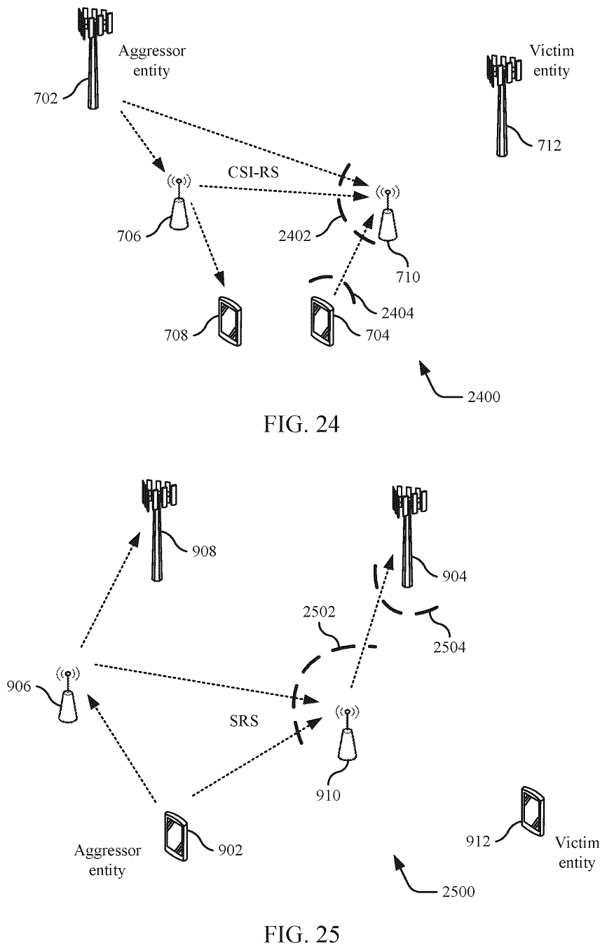

FIG. 24 illustrates an example of a system 2400 that supports reducing interference for NCRs in accordance with aspects of the present disclosure. The system 2400 illustrates an example of a DL signal in an aggressor cell, UL interference in a victim cell, and measurement by another entity (e.g., an entity other than a victim entity), and addresses the interference discussed with reference to system 700 of FIG. 7. The base station 702 is illustrated as the aggressor entity or device, and the base station 712 is illustrated as the victim entity or device. The system 2400 also illustrates, using dashed arcs, a RX and TX beam 2402 of the NCR 710, and a RX beam 2404 of the UE 704. DL interference management is performed at the UE 704.

A motivation for this approach is that the DL interference from a nearby cell is measured by the UE in the victim cell, which allows the victim base station to reuse inter-cell interference (ICI) mechanisms. This allows the base station to delegate the task of interference measurement to UEs, which may free valuable resources of the base station, especially when a large number of NCRs are connected to the base station and measuring interference from the base station or NCRs in the aggressor cell may be a resource-consuming task. In this case, the following parameters may be indicated or determined without an explicit indication to assist with measuring the interference at a base station by the UE 704.

With respect to the NCR RX beam, the base station 712 may configure/signal the NCR 710 to apply a specific RX beam when receiving the CSI-RS signal. In some implementations, the NCR 710 may be configured/signaled to apply the RX beam the NCR 710 uses when receiving a UL signal from the UE 704. In one or more implementations, the NCR 710 may determine to apply one or multiple RX beams associated with one or multiple RX beam parameters that the NCR 710 may apply to receive a UL signal from the UE 704. The one or multiple RX beam parameters may be indicated explicitly by the base station 712, or determined implicitly by the NCR 710 without an indication, to be identical to one or multiple RX beam parameters the NCR 710 may have used in a latest relaying of a UL communication from the UE 704 as a source and/or to the base station 712 as a destination.

In one example, the base station 712 may indicate to the NCR 710 to apply one or multiple RX beams associated with one or multiple RX beam parameters used in a latest relaying of a UL communication from the UE 704 to the base station 712. The UL communication may be a control communication (e.g., a PUCCH), a data communication (e.g., a PUSCH), an uplink reference signal, or the like. In another example, the NCR 710 may apply one or multiple RX beams associated with one or multiple RX beam parameters used in a latest relaying of a UL communication from the UE 704 to the base station 712 without receiving an explicit indication. Additionally or alternatively, the NCR 710 may determine to apply one or multiple RX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. This channel may be a direct channel between the base station 712 and the UE 704 or an indirect channel through the NCR 710.

With respect to the NCR TX beam, the base station 712 may configure/signal the NCR 710 to apply a specific TX beam when forwarding the CSI-RS signal. In some implementations, the NCR 710 may be configured/signaled to apply the TX beam the NCR 710 uses when forwarding a DL signal to the UE 704. In one or more implementations, the NCR 710 may determine to apply one or multiple TX beams associated with one or multiple TX beam parameters that the NCR 710 may apply to forward a DL signal to the UE 704. The one or multiple TX beam parameters may be indicated explicitly by the base station 712, or determined implicitly by the NCR 710 without an indication, to be identical to one or multiple TX beam parameters the NCR 710 may have used in a latest relaying of a DL communication from the base station 712 as a source and/or to the UE 704 as a destination.

In one example, the base station 712 may indicate to the NCR 710 to apply one or multiple TX beams associated with one or multiple TX beam parameters used in a latest relaying of a DL communication from the UE 704 to the base station 712. The DL communication may be a control communication (e.g., a PDCCH), a data communication (e.g., a PDSCH), a downlink reference signal, or the like. In another example, the NCR 710 may apply one or multiple TX beams associated with one or multiple TX beam parameters used in a latest relaying of a DL communication from the base station 712 to the UE 704 without receiving an explicit indication. Additionally or alternatively, the NCR 710 may determine to apply one or multiple TX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. The said channel may be a direct channel between the base station 712 and the UE 704 or an indirect channel through the NCR 710.

A potential issue that appears in this case is that, due to channel reciprocity, the antenna panel(s) used to apply the NCR 710 TX beam(s) to forward the CSI-RS to the UE 704 may be identical to, or overlap with, the antenna panel(s) used to apply the NCR 710 RX beam(s) to receive the CSI-RS. If this is the case, the NCR 710 may not be able to perform the receiving and forwarding operations simultaneously unless at least one of the following conditions holds: the antenna panel(s) are capable of full-duplex (FD) operation; or the NCR 710 is capable of receiving the CSI-RS through the RX beam(s), storing (buffering) samples of the CSI-RS, and then forwarding the CSI-RS samples through the TX beam(s) at a later time. In one or more implementations, the base station 712 may configure/signal the NCR 710 to forward the CSI-RS to the UE 704 if the NCR 710 has a full-duplex capability. Additionally or alternatively, the base station 712 may configure/signal the NCR 710 to forward the CSI-RS to the UE 704 if the NCR 710 has a capability to store (buffer) signals.

The base station 712 may be informed of the aforementioned capabilities (full-duplex operation and/or signal buffering) of the NCR 710 by at least one of the following: a capability signaling from the NCR 710 at the time of establishing a control link between the NCR 710 and the base station 712; a capability signaling from the NCR 710 in response to an inquiry for the capability information from the base station 712; or a base station 712 (pre-) configuration or a network configuration. Addressing this issue by performing interference measurement at the NCR 710 itself is discussed in more detail below.

With respect to NCR power/gain, the base station 712 may configure/signal the NCR 710 to apply a specific power/gain when forwarding the CSI-RS signal to the UE 704. In one or more implementations, the NCR 710 may be configured/signaled to apply at least one of the following: the gain/power the NCR 710 uses when forwarding a UL signal from the UE 704 and/or to the base station 712, the gain/power the NCR 710 uses when forwarding a DL signal from the base station 712 and/or to the UE 704, or a function of either or both of the above. In one or more implementations, the NCR 710 may determine to apply a power/gain that the NCR 710 may apply to forward a UL signal from the UE 704 and/or to the base station 712. The power/gain may be indicated explicitly by the base station 712, or determined implicitly by the NCR 710 without an indication, to be identical to a power/gain that the NCR 710 may have used in a latest relaying of a UL communication from the UE 704 as a source and/or to the base station 712 as a destination.

In one example, the base station 712 may indicate to the NCR 710 to apply a power/gain used in a latest relaying of a UL communication from the UE 704 to the base station 712. The UL communication may be a control communication (e.g., a PUCCH), a data communication (e.g., a PUSCH), a downlink reference signal, or the like. In another example, the NCR 710 may apply a power/gain used in a latest relaying of a UL communication from the UE 704 to the base station 712 without receiving an explicit indication. Additionally or alternatively, the NCR 710 may determine to apply a power/gain that the NCR 710 may apply to forward a DL signal from the base station 712 and/or to the UE 704. The power/gain may be indicated explicitly by the base station 712, or determined implicitly by the NCR 710 without an indication, to be identical to a power/gain that the NCR 710 may have used in a latest relaying of a DL communication from the base station 712 as a source and/or to the UE 704 as a destination.

In one example, the base station 712 may indicate to the NCR 710 to apply a power/gain used in a latest relaying of a DL communication from the base station 712 to the UE 704. The DL communication may be a control communication (e.g., a PDCCH), a data communication (e.g., a PDSCH), a downlink reference signal, or the like. In another example, the NCR 710 may apply a power/gain used in a latest relaying of a DL communication from the base station 712 to the UE 704 without receiving an explicit indication.

A potential issue with both of the above implementations is that applying the gain/power without additional information does not allow the measuring entity to obtain an estimate of interference at the victim entity. It should be noted that in some of the discussions above (e.g., the system 800 of FIG. 8), the measuring entity is identical to, or collocated with, the victim entity. Hence, it may be assumed that the reference signal (dubbed CIRS here) transmitted by an aggressor entity experiences a similar channel as interference from the aggressor entity (provided that beamforming and power/gain parameters are applied properly). However, in the system 1300, due to the difference between the NCR 710−base station 712 channel and the NCR 710−UE 704 channel, additional information is needed in order to obtain an estimate of the actual interference at the victim entity based on the measurement on the reference signal at the measuring entity.

Let H_rb2 and H_ru2 denote the channel state of the NCR 710−base station 712 link and the NCR 710−UE 704 link, respectively. (H-channel, r=NCR, b=base station (e.g., gNB), u-UE). Provided that beamforming parameters are applied properly, their effect may be taken into account such that they may be omitted here. For example, if identical beamforming is applied for interference measurement and associated communication, their effect may cancel out. Here, the reference signal experiences an additional H_ru2 for measurement at the measuring entity (the UE 704), while the actual interfering communication will experience an additional H_rb2 at the victim entity (the base station 712) instead. Therefore, assuming that the channel state is multiplicative in the Fourier domain, the interference estimate at the UE 704 should be multiplied by H_rb2/H_ru2 in order to obtain an estimate of the actual interference at the base station 712.

In one example, if only an amplitude of the interference is desired, the relationship between the measured interference at the UE 704 and the actual interference at the base station 712 may be obtained by: I_b2=I_u2+PL_rb2−PL_ru2. In this equation: I_b2 is the actual interference at the base station 712 in dBm (or dBW); I_u2 is the measured power of the reference signal at the UE 704 in dBm (or dBW); PL_rb2 is the pathloss of the NCR 710−base station 712 link in dB; and PL_ru2 is the pathloss of the NCR 710−UE 704 link in dB. This difference can be taken into account in any of a variety of different manners.

In one or more implementations, the UE 704 transmits a report message to the base station 712, where the report message comprises an interference estimate based on the UE 704 measurement without partial or no adjustment according to the above. Then, the base station 712 obtains information of the aforementioned (channel state) difference, for example through CSI measurements at the base station 712, CSI measurement and reporting by the UE 704, CSI measurement and reporting by the NCR 710, or a combination thereof. Then, the base station 712 applies the difference to the reported interference estimate.

Additionally or alternatively, the base station 712 obtains information of the difference, for example through CSI measurements at the base station 712, CSI measurement and reporting by the UE 704, CSI measurement and reporting by the NCR 710, or a combination thereof. Then, the base station 712 may configure/signal the NCR 710 to apply the difference in the power/gain when forwarding the CSI-RS to the UE 704. Additionally or alternatively, the NCR 710 obtains information of the difference, for example through CSI measurement and indication by the base station 712, CSI measurement at reporting by the UE 704, CSI measurement by the NCR 710, or a combination thereof. Then, the NCR 710 may apply the difference in the power/gain when forwarding the CSI-RS to the UE 704. This applying the difference may be with or without an indication from the base station 712.

Another potential issue appearing here is related to the full-duplex operation. As mentioned earlier, beamforming may require full-duplex operation by one or multiple antenna panel(s) at the NCR 710. In a full-duplex setup, the range of power/gain variation for transmitting a signal may be constrained by the power of the signal being received. As a result, the power/gain parameter may be constrained when forwarding the CSI-RS to the UE 704. In one or more implementations, the NCR 710 may apply a power/gain difference if it satisfies a constraint on power offset, self-interference, or the like. Otherwise, if the constraint is not satisfied, the NCR 710 may not apply the power/gain difference. In one implementation, the NCR 710 may transmit an error message indicating to the base station 712 that the constraint is not satisfied. Additionally or alternatively, the NCR 710 may not expect to apply a power/gain difference that does not satisfy a constraint on power offset, self-interference, or the like. In this case, the NCR 710 may inform the base station 712 of the constraint by a signaling such as a capability signaling.

With respect to the UE RX beam, the UE 704 may apply a specific RX beam when receiving the CSI-RS signal. In some implementations, the UE 704 may apply the beam the UE 704 uses when receiving a DL signal from the NCR 710 or the base station 712. In one or more implementations, the UE 704 may determine to apply one or multiple RX beams associated with one or multiple RX beam parameters that the UE 704 may apply to receive a DL signal from the base station 712. The one or multiple RX beam parameters may be determined to be identical to one or multiple RX beam parameters the UE 704 may have used in a latest DL communication from the base station 712 as a source, through the NCR 710 as a relay, and/or to the UE 704 as a destination. In one example, the UE 704 may determine to apply one or multiple RX beams associated with one or multiple RX beam parameters used in a latest DL communication from the base station 712 to the UE 704, either directly or through the NCR 710. The DL communication may be a control communication (e.g., a PDCCH), a data communication (e.g., a PDSCH), a downlink reference signal, or the like.

Additionally or alternatively, the base station 712 may determine to apply one or multiple RX beams associated with a latest UE 704 beam report. The UE 704 beam report may be any CSI report comprising a beam index, such as a reference signal resource indicator (e.g., SSBRI, CRI, SRI), where the UE 704 beam report may be associated with a CSI acquisition for a channel with the base station 712. The said channel may be a direct channel between the base station 712 and the UE 704 or an indirect channel through the NCR 710. Next, the UE 704 receives the forwarded CSI-RS and performs a measurement to obtain an estimate of the interference an associated DL communication from the base station 702 may cause on any base station serving the UE 704 through the NCR 710.

Referring again to the system 900 of FIG. 9, in several implementations, the base station 908 configures an uplink CIRS, such as an SRS, in association with an uplink communication element as discussed above. For ease of reference and better illustration, and without intending to limit the scope, the reference signal is assumed an SRS and the uplink communication element is simply called the UL communication/signal. The signal of the UL communication may be transmitted by the UE 902 and received by the base station 908. The UL signal may or may not be repeated by the NCR 906.

In one or more implementations, the UE 902 may transmit at least two replicas of the UL signal, one directly to the base station 908 and one indirectly through the NCR 906. The at least two replicas may be multiplexed in time (TDM), frequency (FDM), and/or through multiple antennas on same time and/or frequency resources (SDM/multi-panel). In one or more implementations, the NCR 910 receives the SRS, according to a configuration/signaling, and forwards the signal to the base station 904. Then, the base station 904 performs an interference measurement on the SRS in order to determine whether an associated UL communication from UE 902 will interfere with desired communication at any UE served through the NCR 910. The base station 904 may obtain an estimate of the interference through the measurement as well.

FIG. 25 illustrates an example of a system 2500 that supports reducing interference for NCRs in accordance with aspects of the present disclosure. The system 2500 illustrates an example of a UL signal in an aggressor cell, DL interference in a victim cell, and measurement by another entity (e.g., an entity other than a victim entity), and addresses the interference discussed with reference to system 900 of FIG. 9. The UE 902 is illustrated as the aggressor entity or device, and the UE 912 is illustrated as the victim entity or device. The system 2500 also illustrates, using dashed arcs, a RX and TX beam 2502 of the NCR 910, and a RX beam 2504 of the base station 904. DL interference management is performed at the base station 904.

A motivation for this approach is that the DL interference from a nearby cell is measured by the base station in the victim cell instead of the victim UE(s). This allows the base station to obtain a firsthand estimate of the interference without requiring a reporting from any UEs. Furthermore, the base station may use the information of the obtained estimate for scheduling and link adaptation with any UE served through the NCR. This flexibility comes at the cost of additional complexity as the measuring entity, in this case, is not identical to, or collocated with, the victim entity itself. In this case, the following parameters may be indicated or determined without an explicit indication to assist with measuring the interference at a UE by the base station 904.

With respect to the NCR RX beam, the base station 904 may configure/signal the NCR 910 to apply a specific RX beam when receiving the SRS signal. In some implementations, the NCR 910 may be configured/signaled to apply the RX beam the NCR 910 uses when receiving a DL signal from the base station 904. In one or more implementations, the NCR 910 may determine to apply one or multiple RX beams associated with one or multiple RX beam parameters that the NCR 910 may apply to receive a DL signal from the base station 904. The one or multiple RX beam parameters may be indicated explicitly by the base station 904, or determined implicitly by the NCR 910 without an indication, to be identical to one or multiple RX beam parameters the NCR 910 may have used in a latest relaying of a DL communication from the base station 904 as a source and/or to the UE 912 as a destination.

In one example, the base station 904 may indicate to the NCR 910 to apply one or multiple RX beams associated with one or multiple RX beam parameters used in a latest relaying of a DL communication from the base station 904 to the UE 912. The DL communication may be a control communication (e.g., a PDCCH), a data communication (e.g., a PDSCH), a downlink reference signal, or the like. In another example, the NCR 910 may apply one or multiple RX beams associated with one or multiple RX beam parameters used in a latest relaying of a DL communication from the base station 904 to the UE 912 without receiving an explicit indication. Additionally or alternatively, the NCR 910 may determine to apply one or multiple RX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. The said channel may be a direct channel between the base station 904 and the UE 912 or an indirect channel through the NCR 910.

With respect to the NCR TX beam, the base station 904 may configure/signal the NCR 910 to apply a specific TX beam when forwarding the SRS signal. In some implementations, the NCR 910 may be configured/signaled to apply the TX beam the NCR 910 uses when forwarding a UL signal to the base station 904. In one or more implementations, the NCR 910 may determine to apply one or multiple TX beams associated with one or multiple TX beam parameters that the NCR 910 may apply to forward a UL signal to the base station 904. The one or multiple TX beam parameters may be indicated explicitly by the base station 904, or determined implicitly by the NCR 910 without an indication, to be identical to one or multiple TX beam parameters the NCR 910 may have used in a latest relaying of a UL communication from the UE 912 as a source and/or to the base station 904 as a destination.

In one example, the base station 904 may indicate to the NCR 910 to apply one or multiple TX beams associated with one or multiple TX beam parameters used in a latest relaying of a UL communication from the base station 904 to the UE 912. The UL communication may be a control communication (e.g., a PUCCH), a data communication (e.g., a PUSCH), an uplink reference signal, or the like. In another example, the NCR 910 may apply one or multiple TX beams associated with one or multiple TX beam parameters used in a latest relaying of a UL communication from the UE 912 to the base station 904 without receiving an explicit indication.

Additionally or alternatively, the NCR 910 may determine to apply one or multiple TX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. The said channel may be a direct channel between the base station 904 and the UE 912 or an indirect channel through the NCR 910.

A potential issue that appears in this case is that, due to channel reciprocity, the antenna panel(s) used to apply the NCR 910 TX beam(s) to forward the SRS to the base station 904 may be identical to, or overlap with, the antenna panel(s) used to apply the NCR 910 RX beam(s) to receive the SRS. If this is the case, the NCR 910 may not be able to perform the receiving and forwarding operations simultaneously unless at least one of the following conditions holds: the antenna panel(s) are capable of full-duplex (FD) operation; or the NCR 910 is capable of receiving the SRS through the RX beam(s), storing (buffering) samples of the SRS, and then forwarding the SRS samples through the TX beam(s) at a later time.

In one or more implementations, the base station 904 may configure/signal the NCR 910 to forward the SRS to the base station 904 if the NCR 910 has a full-duplex capability. Additionally or alternatively, the base station 904 may configure/signal the NCR 910 to forward the SRS to the base station 904 if the NCR 910 has a capability to store (buffer) signals. The base station 904 may be informed of the aforementioned capabilities (full-duplex operation and/or signal buffering) of the NCR 910 by at least one of the following: a capability signaling from the NCR 910 at the time of establishing a control link between the NCR 910 and the base station 904; a capability signaling from the NCR 910 in response to an inquiry for the capability information from the base station 904; or the base station 904 (pre-) configuration or a network configuration. Addressing this issue by performing interference measurement at the NCR 310 itself is discussed in more detail below.

With respect to NCR power/gain, the base station 904 may configure/signal the NCR 910 to apply a specific power/gain when forwarding the SRS signal to the base station 904. In some implementations, the NCR 910 may be configured/signaled to apply at least one of the following: the gain/power the NCR 910 uses when forwarding a UL signal from the UE 912 and/or to the base station 904, the gain/power the NCR 910 uses when forwarding a DL signal from the base station 904 and/or to the UE 912, or a function of either or both of the above. In one or more implementations, the NCR 910 may determine to apply a power/gain that the NCR 910 may apply to forward a UL signal from the UE 912 and/or to the base station 904. The power/gain may be indicated explicitly by the base station 904, or determined implicitly by the NCR 910 without an indication, to be identical to a power/gain that the NCR 910 may have used in a latest relaying of a UL communication from the UE 912 as a source and/or to the base station 904 as a destination.

In one example, the base station 904 may indicate to the NCR 910 to apply a power/gain used in a latest relaying of a UL communication from the UE 912 to the base station 904. The UL communication may be a control communication (e.g., a PUCCH), a data communication (e.g., a PUSCH), a downlink reference signal, or the like. In another example, the NCR 910 may apply a power/gain used in a latest relaying of a UL communication from the UE 912 to the base station 904 without receiving an explicit indication. Additionally or alternatively, the NCR 910 may determine to apply a power/gain that the NCR 910 may apply to forward a DL signal from the base station 904 and/or to the UE 912. The power/gain may be indicated explicitly by the base station 904, or determined implicitly by the NCR 910 without an indication, to be identical to a power/gain that the NCR 910 may have used in a latest relaying of a DL communication from the base station 904 as a source and/or to the UE 912 as a destination.

In one example, the base station 904 may indicate to the NCR 910 to apply a power/gain used in a latest relaying of a DL communication from the base station 904 to the UE 912. The DL communication may be a control communication (e.g., a PDCCH), a data communication (e.g., a PDSCH), a downlink reference signal, or the like. In another example, the NCR 910 may apply a power/gain used in a latest relaying of a DL communication from the base station 904 to the UE 912 without receiving an explicit indication. A potential issue with both of the above implementations is that applying the gain/power without additional information does not allow the measuring entity to obtain an estimate of interference at the victim entity. It should be noted that in some of the discussions above (e.g., the system 1000 of FIG. 10), the measuring entity is identical to, or collocated with, the victim entity. Hence, it may be assumed that the reference signal (dubbed CIRS here) transmitted by an aggressor entity experiences a similar channel as interference from the aggressor entity (provided that beamforming and power/gain parameters are applied properly). However, in the system 1400, due to the difference between the NCR 910−base station 904 channel and the NCR 910−UE 912 channel, additional information is needed in order to obtain an estimate of the actual interference at the victim entity based on the measurement on the reference signal at the measuring entity.

Let H_rb2 and H_ru2 denote the channel state of the NCR 910−base station 904 link and the NCR 910−UE 912 link, respectively. (H=channel, r=NCR, b=base station (e.g., gNB), u=UE). Provided that beamforming parameters are applied properly, their effect may be taken into account such that they may be omitted here. For example, if identical beamforming is applied for interference measurement and associated communication, their effect may cancel out. Here, the reference signal experiences an additional H_rb2 for measurement at the measuring entity (the base station 904), while the actual interfering communication will experience an additional H_ru2 at the victim entity (the UE 912) instead. Therefore, assuming that the channel state is multiplicative in the Fourier domain, the interference estimate at the base station 904 should be multiplied by H_ru2/H_rb2 in order to obtain an estimate of the actual interference at the UE 912.

In one example, if only an amplitude of the interference is desired, the relationship between the measured interference at the base station 904 and the actual interference at the UE 912 may be obtained by: I_u2=I_b2+PL_ru2−PL_rb2. In this equation: I_u2 is the actual interference at the UE 912 in dBm (or dBW); I_b2 is the measured power of the reference signal at the base station 904 in dBm (or dBW); PL_ru2 is the pathloss of the NCR 910-UE 912 link in dB; and PL_rb2 is the pathloss of the NCR 910−base station 904 link in dB. This difference can be taken into account in any of a variety of different manners.

In one or more implementations, the base station 904 obtains information of the difference, for example through CSI measurements at the base station 904, CSI measurement and reporting by the UE 912, CSI measurement and reporting by the NCR 910, or a combination thereof. Then, the base station 904 applies the difference in the interference estimation computations. Additionally or alternatively, the base station 904 obtains information of the difference, for example through CSI measurements at the base station 904, CSI measurement and reporting by the UE 912, CSI measurement and reporting by the NCR 910, or a combination thereof. Then, the base station 904 may configure/signal the NCR 910 to apply the difference in the power/gain when forwarding the SRS to the base station 904. Additionally or alternatively, the NCR 910 obtains information of the difference, for example through CSI measurement and indication by the base station 904, CSI measurement at reporting by the UE 912, CSI measurement by the NCR 910, or a combination thereof. Then, the NCR 910 may apply the difference in the power/gain when forwarding the SRS to the base station 904. This applying the difference may be with or without an indication from the base station 904.

Another potential issue appearing here is related to the full-duplex operation. As mentioned earlier, beamforming may use full-duplex operation by one or multiple antenna panel(s) at the NCR 910. In a full-duplex setup, the range of power/gain variation for transmitting a signal may be constrained by the power of the signal being received. As a result, the power/gain parameter may be constrained when forwarding the SRS to the base station 904.

In one or more implementations, the NCR 910 may apply a power/gain difference if it satisfies a constraint on power offset, self-interference, or the like. Otherwise, if the constraint is not satisfied, the NCR 910 may not apply the power/gain difference. In one implementation, the NCR 910 may transmit an error message indicating to the base station 904 that the constraint is not satisfied. Additionally or alternatively, the NCR 910 may not expect to apply a power/gain difference that does not satisfy a constraint on power offset, self-interference, or the like. In this case, the NCR 910 may inform the base station 904 of the constraint by a signaling such as a capability signaling.

With respect to the base station RX beam, the base station 904 may apply a specific RX beam when receiving the SRS signal. In some implementations, the base station 904 may apply the RX beam the base station 904 uses when receiving a UL signal from the NCR 910 or the UE 912. In one or more implementations, the base station 904 may determine to apply one or multiple RX beams associated with one or multiple RX beam parameters that the base station 904 may apply to receive a UL signal from the UE 912. The one or multiple RX beam parameters may be determined to be identical to one or multiple RX beam parameters the base station 904 may have used in a latest UL communication from the UE 912 as a source, through the NCR 910 as a relay, and/or to the base station 904 as a destination.

In one example, the base station 904 may determine to apply one or multiple RX beams associated with one or multiple RX beam parameters used in a latest UL communication from the UE 912 to the base station 904, either directly or through the NCR 910. The UL communication may be a control communication (e.g., a PUCCH), a data communication (e.g., a PUSCH), an uplink reference signal, or the like. Additionally or alternatively, the base station 904 may determine to apply one or multiple RX beams associated with a latest UE 912 beam report. The UE 912 beam report may be any CSI report comprising a beam index, such as a reference signal resource indicator (e.g., SSBRI, CRI, SRI), where the UE 912 beam report may be associated with a CSI acquisition for a channel with the base station 904. This channel may be a direct channel between the base station 904 and the UE 912 or an indirect channel through the NCR 910. Next, the base station 904 receives the forwarded SRS and performs a measurement to obtain an estimate of the interference an associated UL communication from the UE 902 may cause on any UE served by the base station 904 through the NCR 910.

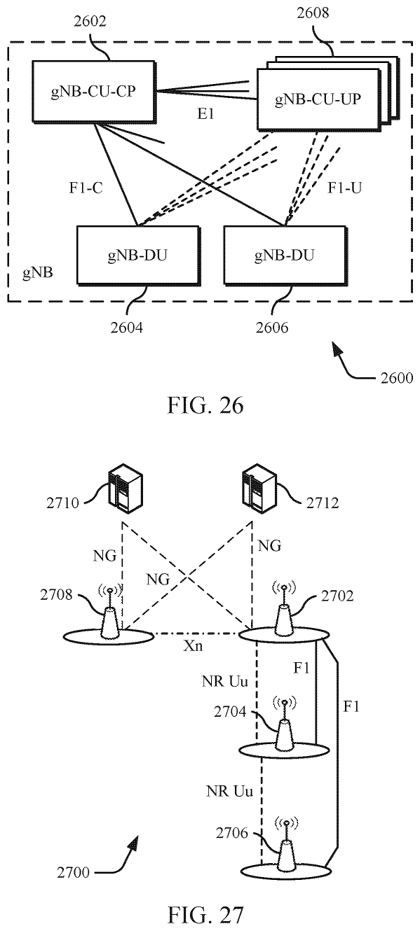

FIG. 26 illustrates an example of a system 2600 that supports interference management with NCR in accordance with aspects of the present disclosure. This example includes a 5G NR base station that supports interference management with NCR. The system 2600 illustrates base station 2600 in the 5G NR may comprise multiple functional components, with the functional split as illustrated in FIG. 26. This functional split includes a gNB central unit (CU) control plane (CP) 2602, a gNB distributed unit (DU) 2604, a gNB DU 2606, and multiple gNB CU user planes (UPs) 2608. This functional split is discussed in more detail in the 3^{rd} Generation Partnership Project (3GPP) technical specification (TS) 38.401. Various techniques discussed herein may be used with a base station 2600 (e.g., a gNB, RAN node).

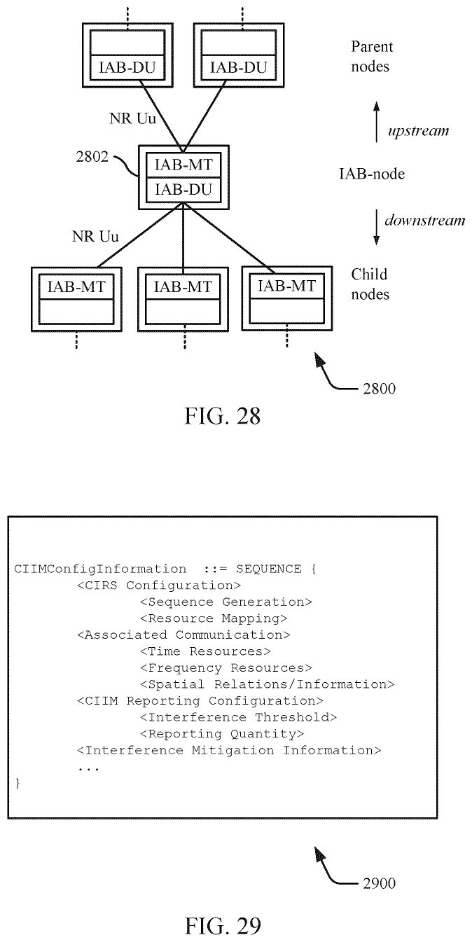

This architecture illustrated in FIG. 26 is extended in integrated access and backhaul (IAB) systems, specified in 3GPP Release 16 and 3GPP Release 17, where an IAB donor comprises at least one IAB-CU and one IAB-DU connects the rest of the IAB system to the core network. In an IAB system, the only configuration entity may be the IAB-CU in the IAB donor. The IAB system may comprise multiple other network entities called IAB nodes, where each IAB node comprises at least one IAB-MT, connecting to another IAB-DU through a Uu link, and at least one IAB-DU that may serve UEs and other IAB nodes. This extends the system architecture and interfaces as shown in FIGS. 27 and 28.

FIG. 27 illustrates an example of a system 2700 that supports interference management with NCR in accordance with aspects of the present disclosure. This example includes interfaces in an IAB system. The system 2700 illustrates an IAB system including an IAB donor node 2702, an IAB node 2704, and an IAB node 2706 is illustrated. The IAB donor node includes an integrated access and backhaul central unit (IAB-CU) that controls the IAB nodes 2704 and 2706. Communication between the IAB donor node 2702 and each of the IAB nodes 2704 and 2706 can be through an F1 interface. Communication between the IAB nodes 2704 and 2706, or between the IAB donor node and each of the IAB nodes, can be through an NR Uu interface. Communication between the IAB donor node 2702 and a gNB 2708 can be through an Xn interface. Communication between the IAB donor node 2702 (or the gNB 2708) and the core network (illustrated as AMF/UPF 2710 and 2712) can be through an NG interface. The IAB-CU hosts higher layer protocols to the UE, and terminates the control plane and user plane interfaces to the core network.

FIG. 28 illustrates an example of a system 2800 that supports interference management with NCR in accordance with aspects of the present disclosure. This includes an example of a parent-child relationship in an IAB system. The system 2800 illustrates an IAB node 2802 as well as parent IAB nodes and child IAB nodes. The IAB node 2802 comprises an integrated access and backhaul distributed unit (IAB-DU) and an integrated access and backhaul mobile terminal (IAB-MT). The IAB-DU hosts lower layers for the NR Uu interface (e.g., to the UEs). Such IAB systems are discussed in additional detail in 3GPP TS 38.300. It can be seen in FIGS. 27 and 28 that because each IAB node comprises an IAB-DU that is configured by the IAB-CU in the IAB donor, the F1 interface is extended beyond the boundary of one base station over one or multiple Uu links (each called an IAB/backhaul hop).

It should be noted that the techniques discussed herein, particularly methods that include F1 signaling, are not limited in scope to IAB. Similar methods may be adopted for signaling among gNB-CU and gNB-DU of one RAN node, e.g., in an open RAN (O-RAN) implementation. In discussions herein, the base station configures the reference signals, referred to as CIRS, for interference measurements. In an IAB system, the IAB-CU configures the reference signals and sends the configuration information to the IAB nodes over the F1 interface. IAB-DUs transmit downlink reference signals, while IAB-MTs and/or UEs transmit uplink reference signals. Accordingly, in the discussions herein and the applications incorporated by reference, references to a base station or gNB may be replaced with IAB-DU, and references to a UE may be replaced with IAB-MT. Thus, techniques discussed with reference to a base station, gNB, or UE can be adopted in IAB systems.

With respect to IAB-MT transmission, in one or more implementations the IAB-MT may be configured to transmit an uplink reference signal such as an SRS. The reference signal may be configured in association with one or multiple communication elements as described above. Then, when the IAB-MT determines to transmit a signal in association with a communication element, the IAB-MT may transmit the reference signal to indicate the signal transmission to other IAB nodes and base stations (e.g., gNBs) in the vicinity.

With respect to IAB-MT measurements, in one or more implementations the IAB-MT may be configured to receive a reference signal such as a CSI-RS for inter-cell interference (ICI) measurements or an SRS for cross-link interference (CLI) measurements. The reference signal may be configured in association with one or multiple communication elements of an aggressor entity as described above. Then, when the IAB-MT detects the reference signal, it may determine that there will be interference on the associated communication elements and potentially obtain an estimate of the interference.

With respect to soft resources, in addition to communication elements described above, a communications element in IAB systems may be a plurality of soft(S) resources in time and/or frequency domains. In some implementations, a reference signal may be configured in association with a plurality of soft resources. Then, when an IAB-DU determines that soft resources are available, the IAB-DU (or a collocated IAB-MT as explained later) may transmit the reference signal.

Each IAB node may comprise at least one IAB-DU and one IAB-MT. This is a functional split, i.e., the functional entities (IAB-DU(s) and IAB-MT(s)) have separate configurations and implementations. But they may share hardware of the IAB node, particularly antenna(s) and RF frontend(s). When the functional entities share all or part of the hardware, especially antenna(s) and RF frontend(s), they may be referred to as collocated.

The collocation property may allow one functional entity to delegate the task of simulating or measuring interference to another functional entity. In particular, if an IAB-MT and an IAB-DU of an aggressor IAB node share an antenna, the IAB-MT may simulate IAB-DU interference by transmitting a reference signal such as a CIRS, and vice versa. Similarly, if an IAB-MT and an IAB-DU of a victim IAB node share an antenna, the IAB-MT may measure interference on behalf of the IAB-DU, and vice versa.

In one or more implementations, an IAB-DU may be configured with a reference signal associated with a communication element (as described above) of a collocated IAB-MT. Then, upon determining that the IAB-MT uses the communication element for a transmission, the IAB-DU may transmit the signal while applying a transmission power and/or beamforming associated with the IAB-MT transmission. In one example, if an IAB-MT determines that it uses resources in time, frequency, and/or spatial domains while applying a transmission power and/or beamforming, the IAB-DU may transmit an associated downlink reference signal (such as a CSI-RS) while applying the transmission power and/or beamforming. This transmission indicates to victim entities in the same/different IAB system or a nearby conventional cell to expect an interference on the resources.

An advantage of this method is that a victim IAB-DU or a victim gNB may use existing ICI measurement mechanisms, or techniques similar to remote interference management (RIM), to obtain an estimate of the upcoming interference. Additionally or alternatively, an IAB-MT may be configured with a reference signal associated with a communication element (as described above) of a collocated IAB-DU. Then, upon determining that the IAB-DU uses the communication element for a transmission, the IAB-MT may transmit the signal while applying a transmission power and/or beamforming associated with the IAB-DU transmission.

In one example, if an IAB-DU determines that it uses resources in time, frequency, and/or spatial domains while applying a transmission power and/or beamforming, the IAB-MT may transmit an associated uplink reference signal (such as an SRS) while applying the transmission power and/or beamforming. This transmission indicates to victim entities in the same/different IAB system or a nearby conventional cell to expect an interference on the resources. An advantage of this method is that a victim IAB-MT or a victim UE may use existing CLI measurement mechanisms to obtain an estimate of the upcoming interference. Additionally or alternatively, the reference signal configured for the IAB-MT or the IAB-DU may be associated with simultaneous transmissions by the IAB-MT and the IAB-DU. The simultaneous transmission may be indicated by a Case A multiplexing indication configured by higher layers (e.g., an F1AP configuration specified in 3GPP TS 38.743) or signaled dynamically (e.g., by a parent IAB node).

In all such implementations and examples, information of the reference signal configurations and the associated communication elements may be shared with the victim entities that they may perform interference measurements, obtain an estimate of the upcoming interference, and determine on which resources to expect the interference. Furthermore, configuration of the interference measurement/management based on MT-DU collocation may follow a capability signaling indicating an MT-DU collocation at the IAB node. In some implementations, an IAB node may inform the IAB donor IAB-CU and/or a parent node through a signaling such as a capability signaling that indicates at least one of an IAB-DU and an IAB-MT, an IAB-DU cell and an IAB-MT, an IAB-DU and IAB-MT CC, or an IAB-DU cell and an IAB-MT CC. This signaling may follow a configuration of an IAB-DU (cell) or an IAB-MT (CC).

Signaling may be implemented in any of a variety of manners, such as using techniques described for managing interference with NCRs. This signaling is for transferring information of reference signal (CIRS) configurations and communication indication interference management (CIIM) mechanisms. In the case of conventional cells (provided by conventional bases stations), the signaling may be implemented in NG, Xn, or a combination thereof as.

In the case of IAB systems, several scenarios are possible. In one or more implementations, for interference between a conventional cell and an IAB cell, signaling among the IAB-CU of the IAB donor and the IAB-DU of the IAB cell may be performed over the F1 interface, while signaling between the gNB of the conventional cell and the IAB donor may be performed over NG and/or Xn. Additionally or alternatively, for interference between two IAB cells configured by the same IAB donor (intra-donor), signaling may be performed over the F1 interface through the IAB-CU of the IAB donor. Additionally or alternatively, for interference between two IAB cells configured by different IAB donors (inter-donor), signaling among each IAB-CU and the IAB-DU(s) it configures may be performed over the F1 interface, while signaling among the IAB donors may be performed over NG and/or Xn interfaces.

The NG/Xn signaling similar to the discussion above may be adopted for coordination among gNBs and IAB donors. The following discussion refers to F1 signaling. In one or more implementations, inter-cell coordination may be performed through F1 signaling through the IAB donor. In one or more implementations, a victim IAB node may receive a CIIM Configuration Information IE, associated with an aggressor IAB node.

FIG. 29 illustrates an example of an IE 2900 that supports interference management with NCR in accordance with aspects of the present disclosure. The information in the IE 2900 may be generated by the IAB-CU sending the IE in the case of intra-donor interference, or it may be received by the IAB-CU from a second IAB-CU directly (through Xn signaling) or indirectly (through NG-C signaling) in the case of inter-donor interference, where the second IAB-CU may configure the aggressor IAB node. In response, the victim IAB node may send a CIIM Report Information IE back to the IAB-CU.

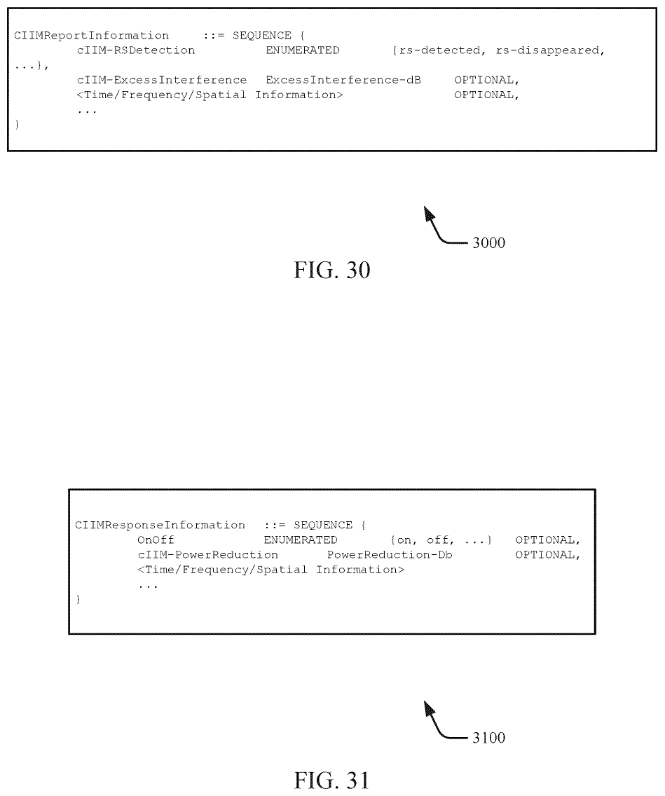

FIG. 30 illustrates an example of an IE 3000 that supports interference management with NCR in accordance with aspects of the present disclosure. The IE 3000 is an example of a CIIM Report Information IE. This information may then be forwarded by the IAB-CU to the aggressor IAB node over an F1 interface in the case of intra-donor interference, or it may be forwarded directly (through Xn signaling) or indirectly (through NG-C signaling) to the second IAB-CU in the case of inter-donor interference. Then, in response to the report, the aggressor IAB node may send a CIIM Response Information IE to the victim IAB node.

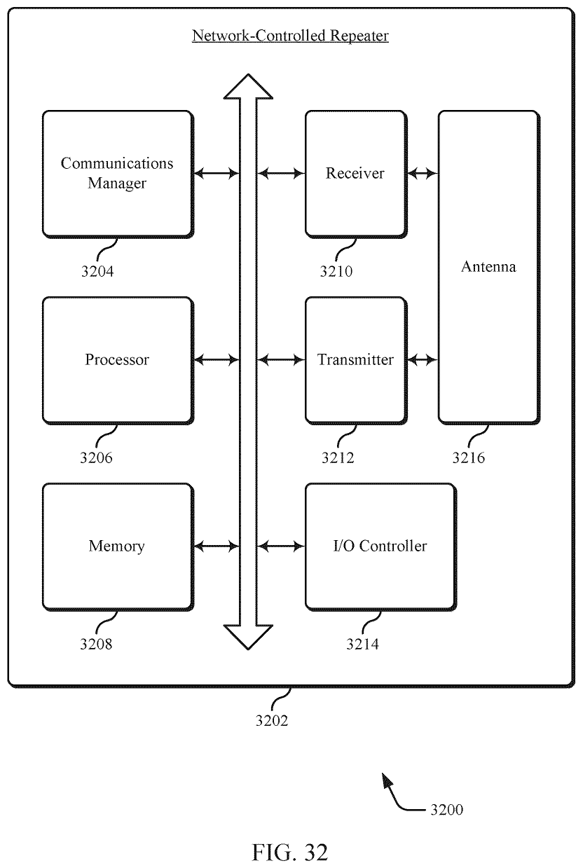

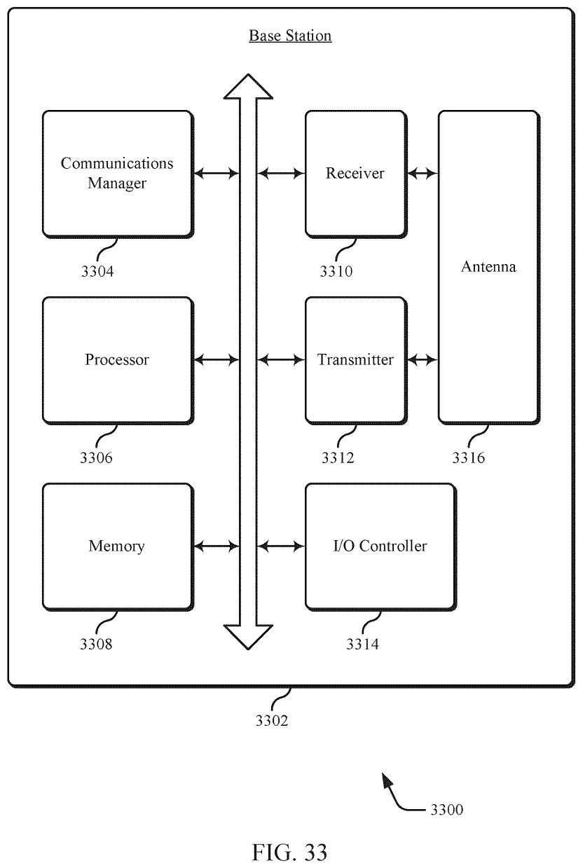

FIG. 31 illustrates an example of an IE 3100 that supports interference management with NCR in accordance with aspects of the present disclosure. The IE 3100 is an example of a CIIM Response Information IE. In the above descriptions, each IAB node may instead be a conventional gNB or an IAB donor. Descriptions for these examples are similar to those of the examples described for signaling through the AMF. Additionally or alternatively, a CIIM signaling may be initiated by a victim IAB node rather than an IAB donor. In this case, an IAB node that detects a high interference may inform its IAB donor of the high interference. In response, the IAB donor may configure a CIRS and send the CIIM Configuration Information, or alternatively, it may inform one or multiple IAB donors in a vicinity (e.g., through Xn/NG signaling). Other signaling and methods may then follow as described above. The discussions above and in the cases incorporated by reference discuss methods of setting beamforming and power/gain based on the scenario including DL/UL direction for the interfering communication at the aggressor cell, DL/UL direction for the interfered communication in the victim cell, and whether the measuring entity is the victim entity, other entity, or the NCR at the victim cell.

The methods proposed for setting beamforming and power/gain in the discussions above and in the cases incorporated by reference may be adopted in IAB systems with the following adjustments. Instead of a gNB transmitting a downlink signal or receiving/measuring an uplink signal, an IAB-DU may transmit the downlink signal or receive/measure the uplink signal. Instead of a UE transmitting an uplink signal or receiving/measuring a downlink signal, an IAB-MT may transmit the uplink signal or receive/measure the downlink signal. Instead of a base station (e.g., gNB) sending a configuration to an NCR or a UE for setting a beam or power/gain, an IAB-CU may send the configuration. The configuration may be transmitted to the NCR or the UE by an IAB-DU of the IAB donor comprising the IAB-CU. Additionally or alternatively, the configuration may be sent over an F1 interface to an IAB node, through one or multiple IAB hops (Uu links), and then an IAB-DU comprised by the IAB node may transmit the configuration to the NCR or the UE. Instead of a dynamic signaling (e.g., L1/L2, DCI, MAC control element (CE)) comprising beamforming and/or power/gain information from a gNB to the NCR or the UE, the IAB-DU serving the NCR or the UE may transmit the dynamic signaling.

After configuration information transfer interference measurement/reporting, interference mitigation actions may be taken by different entities in the network/system including the IAB system. Several implementations are proposed herein as behavior of the network/system in response to large interference. In the proposed methods, an IAB-CU may receive a report of large interference on an F1 interface (in the case of intra-donor interference) or on an NG/Xn interface (in the case of inter-donor interference). Then, the IAB-CU may take at least one of the following actions. In some implementations, the IAB-CU may indicate a change of beamforming and/or power/gain parameters to an aggressor cell in order to reduce the transmitted interference. The indication may be through a signaling such as a configuration or reconfiguration.

Additionally, or alternatively, in some implementations, the IAB-CU may indicate a change of beamforming and/or power/gain parameters to a victim cell in order to reduce the amount of interference received from the interfering signals. The indication may be through a signaling such as a configuration or reconfiguration. In response, the IAB node receiving the indication may apply the information through signaling from an IAB-DU to an NCR and/or a UE.

In one or more implementations, the IAB-CU may indicate to an IAB node that one or multiple TX beams are restricted. The beam restriction indication may be associated with one or multiple communication elements, e.g., a plurality of resources in time and/or frequency domains, a reference signal, an IAB-DU cell, an IAB-MT CC, an IAB multiplexing case, or a combination thereof. The restricted beams may be indicated by a reference signal ID, a reference signal resource indicator (synchronization signal and physical broadcast channel block resource indicator (SSBRI), CSI-RS resource indicator (CRI), SRS resource indicator (SRI)), a TCI state ID, or a combination thereof. The signaling may occur for an aggressor cell.

In one or more implementations, the restricted TX beam(s) may be associated with an IAB-DU comprised by an IAB node. In response, the IAB node may avoid applying the restricted TX beam(s) when transmitting a DL signal. Additionally or alternatively, the restricted TX beam(s) may be associated with an NCR when relaying a DL/UL signal. In response, the IAB node may reconfigure or signal the NCR to avoid applying the restricted TX beam(s) when a relaying a DL/UL signal. In some implementations, if a communication between the NCR and the IAB-DU is disrupted or degraded due to the NCR TX beam restriction, the IAB-DU may inform the IAB-CU of the disruption/degradation. The IAB-DU may then not follow the TX beam restriction indicated by the IAB-CU.

Additionally or alternatively, the restricted TX beam(s) may be associated with a UE or an IAB-MT. In response, the IAB node serving the UE or the IAB-MT (i.e., the parent node of the IAB-MT) may receive the beam restriction indication from the IAB-CU and apply the restriction when indicating a beam for a UL transmission by the UE or the IAB-MT. In one or more implementations, the IAB-CU may indicate to an IAB node that one or multiple RX beams are restricted. The beam restriction indication may be associated with one or multiple communication elements, e.g., a plurality of resources in time and/or frequency domains, a reference signal, an IAB-DU cell, an IAB-MT CC, an IAB multiplexing case, or a combination thereof. The restricted beams may be indicated by a reference signal ID, a reference signal resource indicator (SSBRI, CRI, SRI), a TCI state ID, or a combination thereof. The signaling may occur for a victim cell.

In one or more implementations, the restricted RX beam(s) may be associated with an IAB-DU comprised by an IAB node. In response, the IAB node may avoid applying the restricted RX beam(s) when receiving a UL signal. Additionally or alternatively, the restricted RX beam(s) maybe associated with an NCR when relaying a DL/UL signal. In response, the IAB node may reconfigure or signal the NCR to avoid applying the restricted RX beam(s) when a relaying a DL/UL signal. In some implementations, if a communication between the NCR and the IAB-DU is disrupted or degraded due to the NCR RX beam restriction, the IAB-DU may inform the IAB-CU of the disruption/degradation. The IAB-DU may then not follow the RX beam restriction indicated by the IAB-CU.

Additionally or alternatively, the restricted RX beam(s) may be associated with a UE or an IAB-MT. In response, the IAB node serving the UE or the IAB-MT (i.e., the parent node of the IAB-MT) may receive the beam restriction indication from the IAB-CU and apply the restriction when indicating a beam for a DL reception by the UE or the IAB-MT. In one or more implementations, the IAB-CU may indicate to an IAB node to restrict a power/gain of an NCR. The power/gain restriction indication may be associated with one or multiple communication elements, e.g., a plurality of resources in time and/or frequency domains, a reference signal, an IAB-DU cell, an IAB-MT CC, an IAB multiplexing case, or a combination thereof. The restricted power/gain may be indicated as a range of power (e.g., in dBm), a range of gains (e.g., in dB), an amount of gain reduction compared to a previous relaying (e.g., in dB), or a combination thereof. The signaling may occur for an aggressor cell.

In one or more implementations, in response, the IAB node may apply the power/gain restriction by reconfiguring or signaling to the NCR to apply a power/gain. In some implementations, if a communication between the NCR and the IAB-DU is disrupted or degraded due to the NCR power/gain restriction, the IAB-DU may inform the IAB-CU of the disruption/degradation. The IAB-DU may then not follow the power/gain restriction indicated by the IAB-CU.

In U.S. Patent Application No. 63/318,732 entitled “Frequency Adjustment for Network-Controlled Repeaters” filed Mar. 10, 2022, the full disclosure of which is incorporated by reference herein in its entirety, methods are proposed for applying a frequency offset by a network-controlled repeater (NCR) for purposes of frequency planning and interference management. The proposed methods may be extended to the application in IAB systems, which may be adopted here in response to detection of a large interference in the methods discussed herein. It should be noted, in general, that if NCRs are to be deployed in an IAB system, the IAB donor configures the NCRs, while lower layer signaling (L1/L2) is provided by the IAB nodes to which the NCRs are directly connected. As a result, semi-static signaling and dynamic signaling for controlling an NCR may originate from different physical entities.

As a result, the configuration and signaling in step 2 and step 3 in U.S. Patent Application No. 63/318,732 entitled “Frequency Adjustment for Network-Controlled Repeaters” filed Mar. 10, 2022 are to be distinguished for the case of an NCR connected to a (non-donor) IAB node. For example, configurations from the IAB-CU may experience a larger delay as each configuration message may be transmitted on one or multiple hops before reaching the IAB node that is connected to the NCR. Dynamic (lower-layer, L1/L2 signaling), however, may be delivered to the NCR immediately as there is no additional entities between the origin/source of the signaling (DU) and the NCR. Furthermore, since the IAB node transmits L1/L2 control messages in association with configuration of the NCR performed by the IAB-CU, the IAB-CU may inform the IAB node of the configuration of the NCR. This signaling may be performed over an F1 interface connecting the IAB-CU of the IAB donor and the IAB-DU in the IAB node, for example.

In one or more implementations, in response to detection of a large interference, the IAB-CU may send an F1 message to the IAB node, where the message comprises information of configuration of an NCR. The message may comprise information of a frequency offset configuration for the NCR. The IAB-CU may inform the IAB node, through same or different messages, information related configuration or application of a frequency offset, e.g., timing configuration, BWP configuration, beamforming configuration (beam directions, beam-widths, etc.), power/gain configurations, and so on. Additionally or alternatively, an F1 message from the IAB-CU to the IAB node may comprise an association between a message from the IAB node to the NCR and another parameter such as a timing parameter, a frequency parameter (such as BWP), a beamforming parameter, and so on. According to this implementation, the IAB node may not be informed of the configuration of the NCR, fully or partially. Instead, the IAB node may transmit a particular message as generated by the IAB-CU in association with a particular transmission or reception.

As described in this disclosure, an NCR may be implemented as a measuring entity. When an NCR in the victim cell receives the reference signal for interference measurement, it may perform interference measurement on the signal and report the result to the base station, instead of forwarding the signal to the base station or a UE. Therefore, the NCR should be capable of performing a measurement on the reference signal, which may comprise down-converting the signal to baseband, sampling the baseband signal, processing the baseband samples, and so on. These functionalities are not considered typical repeater/relay functionalities, as the function of a repeater/relay is to receive and forward the signals, potentially with little to no processing. However, network-controlled repeaters (NCRs) are already equipped with certain processing capabilities for implementing the control link that receives configuration and signaling from one or more serving base stations. The capabilities may include down-converting and up-converting signals, decoding and encoding control messages, and so on.

In an implementation, an NCR can process reference signals for interference measurement. The NCR may be expected to receive the reference signal and perform a measurement on the reference signal to obtain an estimate of the reference signal strength (e.g., a RSRP). The NCR may be further expected to perform additional measurement on another reference signal to obtain an estimate of the desired signal strength, such as an RSRP or reference signal received quality (RSSQ). Since it is the ratio of the signals that may ultimately matter to the network, the NCR may further compute an SIR or SINR based on the received signal strengths associated with interference measurement and channel measurement. Finally, the NCR may be expected to produce and transmit a CSI report comprising information of the measurements, for example an SINR parameter, to a base station or a UE.

The NCR is typically expected to be capable of receiving configuration and/or signaling that comprise information of resources associated with the reference signals, other configuration information associated with the reference signals such as the reference signal sequence, CSI reporting configuration, and the like. In another implementation, an NCR may not be fully or partially capable of performing all the aforementioned tasks-performing interference and channel measurements, computing a CSI quantity, producing a CSI report, and so on. However, the NCR may be collocated with an entity that may be capable of performing some or all the aforementioned tasks. Alternatively, the measuring entity may not be necessarily collocated with the NCR, but instead communicate with the NCR via a wired or wireless connection. The connection is normally expected to be low-latency such that the measurement results may be provided to the NCR before the information becomes obsolete.

In all such implementations, information of the capability of the NCR to perform measurements and produce reports, or the capability of a collocated entity that is capable of performing the aforementioned tasks fully or partially, may be communicated to the network (e.g., the base station). Then, the base station may use the information to configure the NCR to perform interference measurement, or instead, forward the reference signal samples to the base station or to a UE such that the base station or UE performs interference measurement on the forwarded signals.

With regard to reference signals for interference measurement in 5G NR, interference measurement may be performed by a measuring entity on resources of a non-zero-power reference signal, such as an SS/PBCH block, non-zero power (NZP) CSI-RS, or SRS, or channel state information interference measurement (CSI-IM) resources. Throughout the disclosure, performing a measurement on a reference signal may include receiving signals on resources associated with the reference signal (according to a configuration and/or signaling from the network) and performing a measurement on the received signals. An alternative to receiving reference signals is performing measurements on resources such as CSI-IM resources where the measuring entity may assume that the received signals are interference. Therefore, any of the techniques discussed herein may be extended to cases that CSI-IM resources are configured instead of reference signals for interference measurement.

Furthermore, for the sake of generality, techniques are described in this disclosure based on interference measurement on reference signals that are associated with communication elements, such as specific resources, time intervals, frequency ranges, configured or scheduled channels, signals, and so on. The reference signals are referred to as communication indication reference signals (CIRS), which may be any existing or new reference signal, such as SS/PBCH, CSI-RS, or SRS. The CIRS associated with a communication element is expected to be transmitted when the associated communication element is used for a transmission, potentially with beamforming, power, and/or timing identical to, or associated with, the transmission.

However, in one case, the reference signal is not associated with a particular communication element. In this case, the reference signal may be transmitted according to a configuration and/or signaling (e.g., in a period, semi-persistent, or aperiodic manner). Parameters related to beamforming, power, timing, and the like for transmitting the reference signal may be determined according to a configuration/signal and/or beamforming, power, timing, etc. used for a current, recent, or upcoming communication.

In several implementations, an SS/PBCH or CSI-RS may be configured for interference measurement associated with DL transmissions from an aggressor base station (e.g., gNB). Similarly, in several implementations, an SRS may be configured for interference measurement associated with UL transmissions from an aggressor UE. Then, once the base station and/or the UE transmits the configured reference signal, an NCR in the victim cell may relay the reference signal to a victim/measuring entity, and/or perform an interference measurement and report the result according to the techniques described herein.

As discussed in some implementations, a base station (e.g., a gNB) or a UE transmits at least two replicas of a message, where a first replica of the message is transmitted directly to a UE (downlink) or to a base station (uplink), respectively, and at least a second replica of the message is repeated/relayed by an NCR. The purpose of this method may be to be provide diversity, i.e., the intended receiver may combine multiple replicas of a signal in order to improve the resulting signal quality and/or reliability. However, there are other techniques for diversity. In one example, multiple messages, each comprising fully or partially similar information as that of the original message may be transmitted by a base station or UE.

In each case, the multiple replicas or messages may be transmitted while applying the same or different beams by the transmitter (base station or UE). Similarly, the NCR may apply the same or different beams when receiving and/or forwarding the signals of each replica or message. As a result, the interference from transmitting each of the replicas or messages may be different as experienced by a victim entity and/or measured by a measuring entity. In one or more implementations, if multiple replicas or messages are associated with one communication, multiple reference signals associated with the multiple replicas or messages may be configured and transmitted. Additionally or alternatively, one or multiple of the replicas or messages may be considered the main replicas or messages, and the one or multiple reference signals associated with the main replicas or messages may be configured and transmitted.

With regard to beam sweeping, implementation of the techniques discussed herein may include applying an RX and/or TX beam. The articulation may imply that there is one RX beam and/or TX beam associated with a communication or reference signal. However, when multiple beams are used for transmitting a reference signal or an associated communication, or in the case that multiple candidate beams exist for transmitting and/or receiving a reference signal or an associated communication, and it is not known which beam is going to be used, the methods of the present disclosure may be extended to the case of beam sweeping. In these methods, multiple reference signals may be transmitted and/or multiple antenna panels and/or beams may be used to receive and/or forward the reference signals. As a result, multiple interference measurements may be obtained by the victim entity or the measuring entity.

In one or more implementations, multiple estimates of interference may be obtained by the victim or measuring entity. Then, an average or a maximum of the multiple estimates may be taken as a combined interference estimate. The combined interference estimate may then be reported to the network, used for link adaptation, and so on. Additionally or alternatively, multiple estimates of interference may be obtained by the victim or measuring entity. All interference estimates may be stored until it is known which beam(s) are going to be used for a particular communication. Once the beam(s) are known, the associated interference estimate may be used. For example, an interference estimate obtained by applying a beam associated with the particular communication may be reported to the network, used for link adaptation, and so on.

In this disclosure pertaining to interference measurement, performing a measurement on a reference signal may include performing a measurement on resources associated with the reference signal, potentially in accordance with other information such as the reference signal sequence. Therefore, the term “performing a measurement on a reference signal” is still valid if the reference signal, or an instance of the reference signal, is not transmitted by the subject transmitter, or if the reference signal does not reach the entity performing the measurement due to a large attenuation. For example, if the subject transmitter does not transmit the reference signal to indicate to any measuring entity that an associated communication is not going to be transmitted, the measuring entity may still perform a measurement to determine whether it detects the reference signal. In the present disclosure, this is called a measurement on the reference signal even though the reference signal was not actually transmitted.

In this disclosure, a beam may be indicated by a spatial parameter, such as a reference signal ID, a reference signal resource indicator, a spatial QCL parameter such as a QCL Type D, a TCI state, a geographical direction of communication, a range of geographical directions for communication, an associated beam-width, or the like. A beam parameter may be a beam direction, a beam-width, a TCI state ID, an RS ID, a QCL Type D parameter comprising an RS ID as a resource, or a combination thereof.

In this disclosure, there are mentions of configuring an NCR or signaling to an NCR. These indications to an NCR may be performed by a higher-layer (e.g., radio resource control (RRC)) semi-static configuration or may be transmitted by lower-layer (e.g., L1/L2) dynamic signaling. Therefore, when the focus is on a functionality of an indication rather than the format and the originating network layer (e.g., RRC vs. L1/L2), the general terms “configuration/signaling” or “configured/signaled” may be used.

In this disclosure, there are mentions of power/gain in the description of the proposed techniques. The control link indications to an NCR from the network (base station) may be to control the output power, the gain applied to a received signal before forwarding the signal, or both. The effect of these different approaches is similar for realizing methods in this disclosure. If an input signal x is received, with a received power P_x, by applying a gain G to the signal, the transmission power of the output signal will be P_y=G×P_x. An indication to the NCR may intend to control P_y, G, or both. The general term power/gain in this disclosure may refer to either or both of these parameters.

With respect to amplify-and-forward (A&F) relaying performed by a repeater, including an NCR, different terms may be used herein in different contexts. It should be noted that these terms may be used interchangeably, and emphasis on using certain terms in this disclosure is not to limit the scope. Repeating or relaying a signal by a repeater or relay may include receiving the signal, potentially processing the signal, and transmitting the processed signal. The processing may include amplifying the signal, denoising the signal, and so on. According to the techniques discussed herein, the processing may include applying a frequency offset, also known as applying a frequency shift or shifting the frequency. Transmitting the processed signal may also be referred to as forwarding the signal, hence the term amplify-and-forward. This term may not be used widely herein and, instead, the more generic term transmitting may be used.

Furthermore, despite emphasis on the terms repeater, analog repeater, RF repeater, amplify-and-forward (A&F) relay, and NCR in the present disclosure, it should be noted that the techniques discussed herein are not limited in scope to those devices that are referred to by those terms in specifications and implementation. For example, many implementations are applicable to other types of network nodes such as digital repeaters, baseband repeaters, digital relays, decode-and-forward (D&F) relays, and the like. In particular, the techniques discussed herein may be applied to the following examples: a repeater, such as an analog/RF repeater, without a network control channel, where a configuration of applying a frequency offset is provided by a pre-configuration on a hardware, software, firmware, or a combination thereof, accessible by the repeater; or a digital/D&F/baseband repeater with a network control channel, a pre-configuration on a hardware/software/firmware, or a combination thereof.

Aspects of this disclosure take into account antenna panel, antenna port, quasi-collocation, TCI state, and spatial relation. In some implementations, the terms antenna, panel, and antenna panel are used interchangeably. An antenna panel may be a hardware that is used for transmitting and/or receiving radio signals at frequencies lower than 6 GHz (e.g., in frequency range 1 (FR1)), higher than 6 GHz (e.g., in frequency range 2 (FR2)), or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some implementations, an antenna panel may or may not be virtualized as an antenna port in the specifications. An antenna panel may be connected to a baseband processing module through a RF chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices such as a central unit (CU), it can be used for signaling or local decision making.

In some implementations, an antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, a panel can have at least one of the following functionalities as an operational role of a unit of antenna group to control its Tx beam independently: unit of antenna group to control its transmission power independently; unit of antenna group to control its transmission timing independently. The panel may be transparent to another node (e.g., next hop neighbor node). For certain condition(s), another node or network entity can assume the mapping between device's physical antennas to the logical entity panel may not be changed. For example, the condition may include until the next update or report from a device or comprise a duration of time over which the network entity assumes there will be no change to the mapping. The device may report its capability with respect to the panel to the network entity, and the device capability may include at least the number of panels. In one or more implementations, the device may support transmission from one beam within a panel, and with multiple panels, more than one beam (one beam per panel) may be used for transmission. Additionally or alternatively, more than one beam per panel may be supported/used for transmission.

In one or more implementations, an antenna port is defined such that the channel over which a symbol on the antenna port is conveyed can be inferred from the channel over which another symbol on the same antenna port is conveyed. Two antenna ports are said to be quasi co-located if the large-scale properties of the channel over which a symbol on one antenna port is conveyed can be inferred from the channel over which a symbol on another antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, QCL-Type may take one of the following values. Other QCL-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation, etc. The QCL-TypeA, QCL-TypeB, and QCL-TypeC may be applicable for all carrier frequencies, but the QCL-TypeD may be applicable only in higher carrier frequencies (e.g., mmWave, FR2, and beyond), where essentially the device may not be able to perform omni-directional transmission, i.e. the device would need to form beams for directional transmission. For a QCL-TypeD between two reference signals A and B, the reference signal A is considered to be spatially co-located with reference signal B and the device may assume that the reference signals A and B can be received with the same spatial filter (e.g., with the same RX beamforming weights).

An antenna port according to one or more implementations may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or an antenna set, an antenna array, or an antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In one or more of the described implementations, a TCI-state (transmission configuration indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some of the implementations described herein, a TCI state comprises at least one source RS to provide a reference (device assumption) for determining QCL and/or spatial filter.

In some of the implementations described herein, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In one or more of the described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with QCL-Type set to ‘typeD’ in the joint TCI state.

In one or more of the described implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

The different steps described for the example implementations, in the text and in the figures, may be permuted. Each configuration discussed herein may be provided by one or multiple configurations in practice. An earlier configuration may provide a subset of parameters while a later configuration may provide another subset of parameters. Alternatively, a later configuration may override values provided by an earlier configuration or a pre-configuration.

A configuration may be provided by a RRC signaling, a medium-access control (MAC) signaling, a physical layer signaling such as a DCI message, a combination thereof, or other methods. A configuration may include a pre-configuration or a semi-static configuration provided by the standard, by the vendor, and/or by the network/operator. Each parameter value received through configuration or indication may override previous values for a similar parameter.

The L1/L2 control signaling may refer to control signaling in layer 1 (physical layer) or layer 2 (data link layer). Particularly, an L1/L2 control signaling may refer to an L1 control signaling such as a DCI message or a uplink control information (UCI) message, an L2 control signaling such as a MAC message, or a combination thereof. A format and an interpretation of an L1/L2 control signaling may be determined by the standard, a configuration, other control signaling, or a combination thereof.

Any parameter discussed herein may appear, in practice, as a linear function of that parameter in signaling or specifications. Techniques are described in this disclosure to perform measurements for beam training on reference signals. Alternatively, in some implementations, a measurement may be performed on resources that are not necessarily configured for reference signals, but rather a node may measure a receive signal power and obtain a RSSI or the like. In the disclosure, reference is made to beam indication. In practice, according to a standard specification, a beam indication may refer to an indication of a reference signal by an ID or indicator, a resource associated with a reference signal, a spatial relation information comprising information of a reference signal or a reciprocal of a reference signal (in the case of beam correspondence).

FIG. 32 illustrates an example of a block diagram 3200 of a device 3202 that supports interference measurement by an NCR in accordance with aspects of the present disclosure. The device 3202 may be an example of a NCR as described herein. The device 3202 may support wireless communication and/or network signaling with one or more base stations 102, UEs 104, other NCRs, network entities and devices, or any combination thereof. The device 3202 may include components for bi-directional communications including components for transmitting and receiving communications, such as a communications manager 3204, a processor 3206, a memory 3208, a receiver 3210, a transmitter 3212, and an I/O controller 3214. These components may be in electronic communication or otherwise coupled (e.g., operatively, communicatively, functionally, electronically, electrically) via one or more interfaces (e.g., buses).

The communications manager 3204, the receiver 3210, the transmitter 3212, or various combinations thereof or various components thereof may be examples of means for performing various aspects of the present disclosure as described herein. For example, the communications manager 3204, the receiver 3210, the transmitter 3212, or various combinations or components thereof may support a method for performing one or more of the functions described herein.

In some implementations, the communications manager 3204, the receiver 3210, the transmitter 3212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 3206 and the memory 3208 coupled with the processor 3206 may be configured to perform one or more of the functions described herein (e.g., by executing, by the processor 3206, instructions stored in the memory 3208).

Additionally or alternatively, in some implementations, the communications manager 3204, the receiver 3210, the transmitter 3212, or various combinations or components thereof may be implemented in code (e.g., as communications management software or firmware) executed by the processor 3206. If implemented in code executed by the processor 3206, the functions of the communications manager 3204, the receiver 3210, the transmitter 3212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 3204 may be configured to perform various operations (e.g., receiving, monitoring, transmitting) using or otherwise in cooperation with the receiver 3210, the transmitter 3212, or both. For example, the communications manager 3204 may receive information from the receiver 3210, send information to the transmitter 3212, or be integrated in combination with the receiver 3210, the transmitter 3212, or both to receive information, transmit information, or perform various other operations as described herein. Although the communications manager 3204 is illustrated as a separate component, in some implementations, one or more functions described with reference to the communications manager 3204 may be supported by or performed by the processor 3206, the memory 3208, or any combination thereof. For example, the memory 3208 may store code, which may include instructions executable by the processor 3206 to cause the device 3202 to perform various aspects of the present disclosure as described herein, or the processor 3206 and the memory 3208 may be otherwise configured to perform or support such operations.

For example, the communications manager 3204 may support wireless communication and/or network signaling at a device (e.g., the device 3202, an NCR) in accordance with examples as disclosed herein. The communications manager 3204 and/or other device components may be configured as or otherwise support an apparatus, such as an NCR, including a transceiver; a processor coupled to the transceiver, the processor and the transceiver configured to cause the apparatus to: receive, from a base station, a first signaling indicating a reception beam; receive a first reference signal from the base station; receive a second reference signal from an interfering communication device; perform a channel measurement on the first reference signal with the reception beam applied; perform an interference measurement on the second reference signal with the reception beam applied; determine a signal strength comparison based at least in part on the channel measurement and the interference measurement; and transmit a second signaling as a report of the signal strength comparison to the base station.

Additionally, the apparatus (e.g., an NCR) includes any one or combination of: the processor is configured to cause the apparatus to determine the signal strength comparison as a ratio of signal strengths associated with the first reference signal and the second reference signal. The processor is configured to cause the apparatus to determine the signal strength comparison as a SIR. The processor is configured to cause the apparatus to determine the signal strength comparison as a SINR. The processor is configured to cause the apparatus to perform the channel measurement to determine a RSRP of the first reference signal. The processor is configured to cause the apparatus to perform the interference measurement to determine a RSRP of the second reference signal. The processor and the transceiver are configured to cause the apparatus to transmit the second signaling as a CSI report of the signal strength comparison to the base station. The interfering communication device is an interfering base station. The interfering communication device is an interfering user equipment. The first reference signal is at least one of a SS/PBCH block, a CSI-RS, or a SRS.

The communications manager 3204 and/or other device components may be configured as or otherwise support a means for wireless communication and/or network signaling at an NCR, including receiving, from a base station, a first signaling indicating a reception beam; receiving a first reference signal from the base station; receiving a second reference signal from an interfering communication device; performing a channel measurement on the first reference signal with the reception beam applied; performing an interference measurement on the second reference signal with the reception beam applied; determining a signal strength comparison based at least in part on the channel measurement and the interference measurement; and transmitting a second signaling as a report of the signal strength comparison to the base station.

Additionally, wireless communication and/or network signaling at the NCR includes any one or combination of: the signal strength comparison is determined as a ratio of signal strengths associated with the first reference signal and the second reference signal. The signal strength comparison is determined as a SIR. The signal strength comparison is determined as a SINR. The channel measurement is performed to determine a RSRP of the first reference signal. The interference measurement is performed to determine a RSRP of the second reference signal. The second signaling is transmitted as a CSI report of the signal strength comparison to the base station. The interfering communication device is an interfering base station. The interfering communication device is an interfering user equipment. The first reference signal is at least one of a SS/PBCH block, a CSI-RS, or a SRS.

The processor 3206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 3206 may be configured to operate a memory array using a memory controller. In some other implementations, a memory controller may be integrated into the processor 3206. The processor 3206 may be configured to execute computer-readable instructions stored in a memory (e.g., the memory 3208) to cause the device 3202 to perform various functions of the present disclosure.

The memory 3208 may include random access memory (RAM) and read-only memory (ROM). The memory 3208 may store computer-readable, computer-executable code including instructions that, when executed by the processor 3206 cause the device 3202 to perform various functions described herein. The code may be stored in a non-transitory computer-readable medium such as system memory or another type of memory. In some implementations, the code may not be directly executable by the processor 3206 but may cause a computer (e.g., when compiled and executed) to perform functions described herein. In some implementations, the memory 3208 may include, among other things, a basic I/O system (BIOS) which may control basic hardware or software operation such as the interaction with peripheral components or devices.

The I/O controller 3214 may manage input and output signals for the device 3202. The I/O controller 3214 may also manage peripherals not integrated into the device 3202. In some implementations, the I/O controller 3214 may represent a physical connection or port to an external peripheral. In some implementations, the I/O controller 3214 may utilize an operating system such as iOS®, ANDROID®, MS-DOS®, MS-WINDOWS®, OS/2®, UNIX®, LINUX®, or another known operating system. In some implementations, the I/O controller 3214 may be implemented as part of a processor, such as the processor 3206. In some implementations, a user may interact with the device 3202 via the I/O controller 3214 or via hardware components controlled by the I/O controller 3214.

In some implementations, the device 3202 may include a single antenna 3216. However, in some other implementations, the device 3202 may have more than one antenna 3216, which may be capable of concurrently transmitting or receiving multiple wireless transmissions. The receiver 3210 and the transmitter 3212 may communicate bi-directionally, via the one or more antennas 3216, wired, or wireless links as described herein. For example, the receiver 3210 and the transmitter 3212 may represent a wireless transceiver and may communicate bi-directionally with another wireless transceiver. The transceiver may also include a modem to modulate the packets, to provide the modulated packets to one or more antennas 3216 for transmission, and to demodulate packets received from the one or more antennas 3216.

FIG. 33 illustrates an example of a block diagram 3300 of a device 3302 that supports interference measurement by an NCR in accordance with aspects of the present disclosure. The device 3302 may be an example of a base station 102, such as a gNB as described herein. The device 3302 may support wireless communication and/or network signaling with one or more base stations 102, UEs 104, NCRs, core network devices and functions (e.g., core network 106), or any combination thereof. The device 3302 may include components for bi-directional communications including components for transmitting and receiving communications, such as a communications manager 3304, a processor 3306, a memory 3308, a receiver 3310, a transmitter 3312, and an I/O controller 3314. These components may be in electronic communication or otherwise coupled (e.g., operatively, communicatively, functionally, electronically, electrically) via one or more interfaces (e.g., buses).

The communications manager 3304, the receiver 3310, the transmitter 3312, or various combinations thereof or various components thereof may be examples of means for performing various aspects of the present disclosure as described herein. For example, the communications manager 3304, the receiver 3310, the transmitter 3312, or various combinations or components thereof may support a method for performing one or more of the functions described herein.

In some implementations, the communications manager 3304, the receiver 3310, the transmitter 3312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 3306 and the memory 3308 coupled with the processor 3306 may be configured to perform one or more of the functions described herein (e.g., by executing, by the processor 3306, instructions stored in the memory 3308).

Additionally or alternatively, in some implementations, the communications manager 3304, the receiver 3310, the transmitter 3312, or various combinations or components thereof may be implemented in code (e.g., as communications management software or firmware) executed by the processor 3306. If implemented in code executed by the processor 3306, the functions of the communications manager 3304, the receiver 3310, the transmitter 3312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 3304 may be configured to perform various operations (e.g., receiving, monitoring, transmitting) using or otherwise in cooperation with the receiver 3310, the transmitter 3312, or both. For example, the communications manager 3304 may receive information from the receiver 3310, send information to the transmitter 3312, or be integrated in combination with the receiver 3310, the transmitter 3312, or both to receive information, transmit information, or perform various other operations as described herein. Although the communications manager 3304 is illustrated as a separate component, in some implementations, one or more functions described with reference to the communications manager 3304 may be supported by or performed by the processor 3306, the memory 3308, or any combination thereof. For example, the memory 3308 may store code, which may include instructions executable by the processor 3306 to cause the device 3302 to perform various aspects of the present disclosure as described herein, or the processor 3306 and the memory 3308 may be otherwise configured to perform or support such operations.

For example, the communications manager 3304 may support wireless communication and/or network signaling at a device (e.g., the device 3302, a base station) in accordance with examples as disclosed herein. The communications manager 3304 and/or other device components may be configured as or otherwise support an apparatus, such as a base station, including a transceiver; a processor coupled to the transceiver, the processor and the transceiver configured to cause the apparatus to: receive a first signaling indicating a reference signal and an associated communication element; determine that the communication element potentially interferes with a UE communication via a NCR; determine a reception beam associated with the UE communication via the NCR; and transmit a second signaling indicating the reception beam to the NCR.

Additionally, the apparatus (e.g., a base station) includes any one or combination of: the communication element is at least one of a plurality of time resources, a plurality of frequency resources, one or more spatial relations, a communication channel, or a reference signal. The plurality of time resources comprises at least one of a plurality of OFDM symbols, a plurality of slots, or a time duration. The plurality of frequency resources comprises at least one of a frequency band, a frequency sub-band, a carrier frequency, a component carrier, a bandwidth part, or a plurality of PRBs. Each of the one or more spatial relations comprises at least one of a RS ID, a QCL relationship with a reference signal as a source, a TCI, or a spatial relation information parameter. The communication channel comprises at least one of a PDCCH, a PDSCH, a PUCCH, or a PUSCH. The reference signal is at least one of a SS/PBCH block, a CSI-RS, or a SRS. The processor and the transceiver are configured to cause the apparatus to transmit a second reference signal to the NCR with an applied transmission beam associated with the UE communication; and receive a third signaling as a report from the NCR, the third signaling indicating an estimate of a SINR based at least in part on an interference measurement on the reference signal and a channel measurement on the second reference signal. The processor and the transceiver are configured to cause the apparatus to transmit, to the UE, a third signaling indicating the UE to transmit a second reference signal to the NCR with an applied transmission beam associated with the UE communication; and receive a fourth signaling as a report from the NCR, the fourth signaling indicating an estimate of a SINR based at least in part on an interference measurement on the reference signal and a channel measurement on the second reference signal.

The communications manager 3304 and/or other device components may be configured as or otherwise support a means for wireless communication and/or network signaling at a base station, including receiving a first signaling indicating a reference signal and an associated communication element; determining that the communication element potentially interferes with a UE communication via a network-controlled repeater NCR; determining a reception beam associated with the UE communication via the NCR; and transmitting a second signaling indicating the reception beam to the NCR.

Additionally, wireless communication at the base station includes any one or combination of: the communication element is at least one of a plurality of time resources, a plurality of frequency resources, one or more spatial relations, a communication channel, or a reference signal. The plurality of time resources comprises at least one of a plurality of OFDM symbols, a plurality of slots, or a time duration. The plurality of frequency resources comprises at least one of a frequency band, a frequency sub-band, a carrier frequency, a component carrier, a bandwidth part, or a plurality of PRBs. Each of the one or more spatial relations comprises at least one of a RS ID, a QCL relationship with a reference signal as a source, a TCI, or a spatial relation information parameter. The communication channel comprises at least one of a PDCCH, a PDSCH, a PUCCH, or a PUSCH. The reference signal is at least one of a SS/PBCH block, a CSI-RS, or a SRS. The method further comprising transmitting a second reference signal to the NCR with an applied transmission beam associated with the UE communication; and receiving a third signaling as a report from the NCR, the third signaling indicating an estimate of a SINR based at least in part on an interference measurement on the reference signal and a channel measurement on the second reference signal. The method further comprising transmitting, to the UE, a third signaling indicating the UE to transmit a second reference signal to the NCR with an applied transmission beam associated with the UE communication; and receiving a fourth signaling as a report from the NCR, the fourth signaling indicating an estimate of a SINR based at least in part on an interference measurement on the reference signal and a channel measurement on the second reference signal.

The processor 3306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 3306 may be configured to operate a memory array using a memory controller. In some other implementations, a memory controller may be integrated into the processor 3306. The processor 3306 may be configured to execute computer-readable instructions stored in a memory (e.g., the memory 3308) to cause the device 3302 to perform various functions of the present disclosure.

The memory 3308 may include random access memory (RAM) and read-only memory (ROM). The memory 3308 may store computer-readable, computer-executable code including instructions that, when executed by the processor 3306 cause the device 3302 to perform various functions described herein. The code may be stored in a non-transitory computer-readable medium such as system memory or another type of memory. In some implementations, the code may not be directly executable by the processor 3306 but may cause a computer (e.g., when compiled and executed) to perform functions described herein. In some implementations, the memory 3308 may include, among other things, a basic I/O system (BIOS) which may control basic hardware or software operation such as the interaction with peripheral components or devices.

The I/O controller 3314 may manage input and output signals for the device 3302. The I/O controller 3314 may also manage peripherals not integrated into the device 3302. In some implementations, the I/O controller 3314 may represent a physical connection or port to an external peripheral. In some implementations, the I/O controller 3314 may utilize an operating system such as iOS®, ANDROID®, MS-DOS®, MS-WINDOWS®, OS/2®, UNIX®, LINUX®, or another known operating system. In some implementations, the I/O controller 3314 may be implemented as part of a processor, such as the processor 3306. In some implementations, a user may interact with the device 3302 via the I/O controller 3314 or via hardware components controlled by the I/O controller 3314.

In some implementations, the device 3302 may include a single antenna 3316. However, in some other implementations, the device 3302 may have more than one antenna 3316, which may be capable of concurrently transmitting or receiving multiple wireless transmissions. The receiver 3310 and the transmitter 3312 may communicate bi-directionally, via the one or more antennas 3316, wired, or wireless links as described herein. For example, the receiver 3310 and the transmitter 3312 may represent a wireless transceiver and may communicate bi-directionally with another wireless transceiver. The transceiver may also include a modem to modulate the packets, to provide the modulated packets to one or more antennas 3316 for transmission, and to demodulate packets received from the one or more antennas 3316.

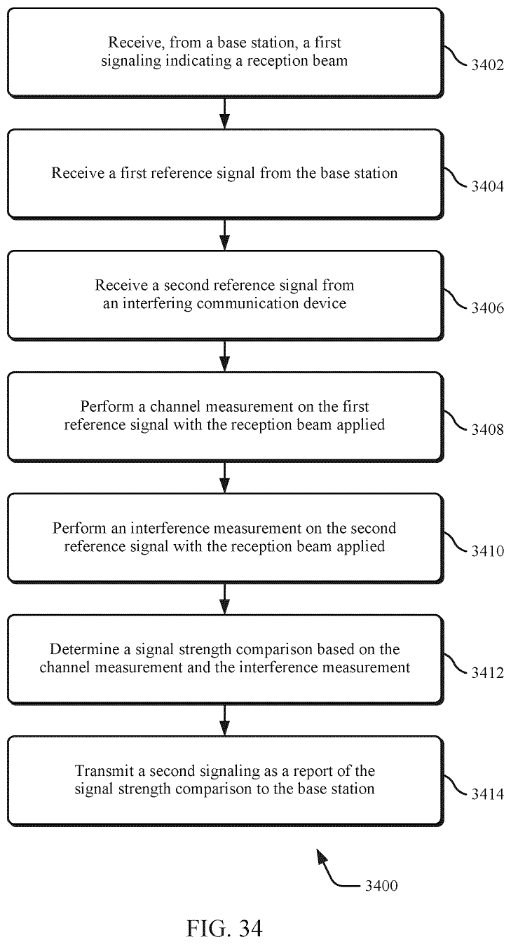

FIG. 34 illustrates a flowchart of a method 3400 that supports interference measurement by an NCR in accordance with aspects of the present disclosure. The operations of the method 3400 may be implemented and performed by a device or its components, such as an NCR as described with reference to FIGS. 1 through 12. In some implementations, the device may execute a set of instructions to control the function elements of the device to perform the described functions. Additionally, or alternatively, the device may perform aspects of the described functions using special-purpose hardware.

At 3402, the method may include receiving, from a base station, a first signaling indicating a reception beam. The operations of 3402 may be performed in accordance with examples as described herein. In some implementations, aspects of the operations of 3402 may be performed by a device as described with reference to FIG. 1.

At 3404, the method may include receiving a first reference signal from the base station. The operations of 3404 may be performed in accordance with examples as described herein. In some implementations, aspects of the operations of 3404 may be performed by a device as described with reference to FIG. 1.

At 3406, the method may include receiving a second reference signal from an interfering communication device. The operations of 3406 may be performed in accordance with examples as described herein. In some implementations, aspects of the operations of 3406 may be performed by a device as described with reference to FIG. 1.

At 3408, the method may include performing a channel measurement on the first reference signal with the reception beam applied. The operations of 3408 may be performed in accordance with examples as described herein. In some implementations, aspects of the operations of 3408 may be performed by a device as described with reference to FIG. 1.

At 3410, the method may include performing an interference measurement on the second reference signal with the reception beam applied. The operations of 3410 may be performed in accordance with examples as described herein. In some implementations, aspects of the operations of 3410 may be performed by a device as described with reference to FIG. 1.

At 3412, the method may include determining a signal strength comparison based at least in part on the channel measurement and the interference measurement. The operations of 3412 may be performed in accordance with examples as described herein. In some implementations, aspects of the operations of 3412 may be performed by a device as described with reference to FIG. 1.

At 3414, the method may include transmitting a second signaling as a report of the signal strength comparison to the base station. The operations of 3414 may be performed in accordance with examples as described herein. In some implementations, aspects of the operations of 3414 may be performed by a device as described with reference to FIG. 1.

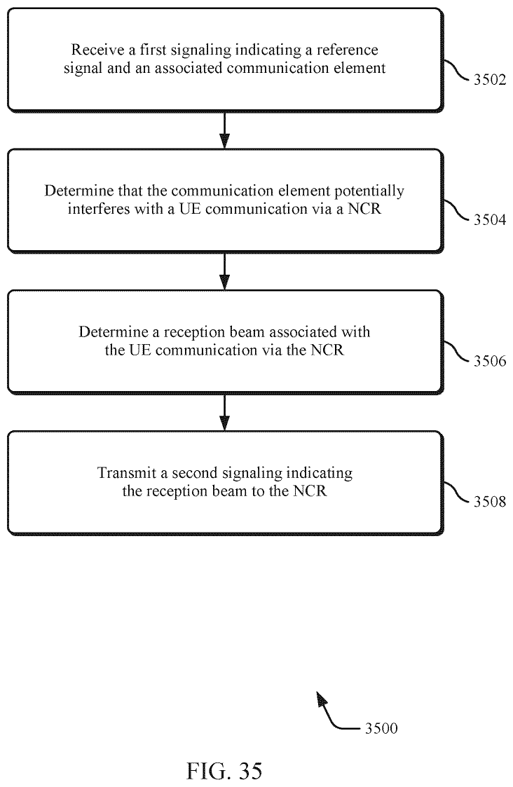

FIG. 35 illustrates a flowchart of a method 3500 that supports interference measurement by an NCR in accordance with aspects of the present disclosure. The operations of the method 3500 may be implemented and performed by a device or its components, such as a base station 102 (e.g., a gNB) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 3502, the method may include receiving a first signaling indicating a reference signal and an associated communication element. The operations of 3502 may be performed in accordance with examples as described herein. In some implementations, aspects of the operations of 3502 may be performed by a device as described with reference to FIG. 1.

At 3504, the method may include determining that the communication element potentially interferes with a UE communication via a NCR. The operations of 3504 may be performed in accordance with examples as described herein. In some implementations, aspects of the operations of 3504 may be performed by a device as described with reference to FIG. 1.

At 3506, the method may include determining a reception beam associated with the UE communication via the NCR. The operations of 3506 may be performed in accordance with examples as described herein. In some implementations, aspects of the operations of 3506 may be performed by a device as described with reference to FIG. 1.

At 3508, the method may include transmitting a second signaling indicating the reception beam to the NCR. The operations of 3508 may be performed in accordance with examples as described herein. In some implementations, aspects of the operations of 3508 may be performed by a device as described with reference to FIG. 1.

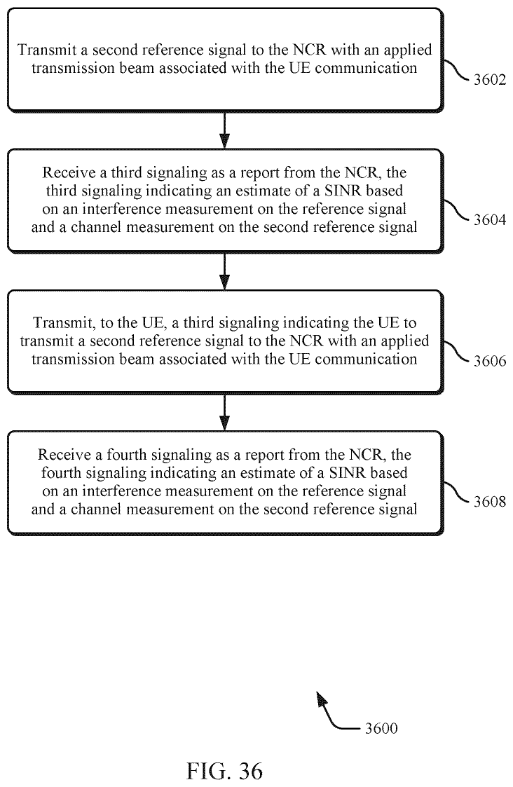

FIG. 36 illustrates a flowchart of a method 3600 that supports interference measurement by an NCR in accordance with aspects of the present disclosure. The operations of the method 3600 may be implemented and performed by a device or its components, such as a base station 102 (e.g., a gNB) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 3602, the method may include transmitting a second reference signal to the NCR with an applied transmission beam associated with the UE communication. The operations of 3602 may be performed in accordance with examples as described herein. In some implementations, aspects of the operations of 3602 may be performed by a device as described with reference to FIG. 1.

At 3604, the method may include receiving a third signaling as a report from the NCR, the third signaling indicating an estimate of a SINR based on an interference measurement on the reference signal and a channel measurement on the second reference signal. The operations of 3604 may be performed in accordance with examples as described herein. In some implementations, aspects of the operations of 3604 may be performed by a device as described with reference to FIG. 1.

At 3606, the method may include transmitting, to the UE, a third signaling indicating the UE to transmit a second reference signal to the NCR with an applied transmission beam associated with the UE communication. The operations of 3606 may be performed in accordance with examples as described herein. In some implementations, aspects of the operations of 3606 may be performed by a device as described with reference to FIG. 1.

At 3608, the method may include receiving a fourth signaling as a report from the NCR, the fourth signaling indicating an estimate of a SINR based at least in part on an interference measurement on the reference signal and a channel measurement on the second reference signal. The operations of 3608 may be performed in accordance with examples as described herein. In some implementations, aspects of the operations of 3608 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network-controlled repeater (NCR), comprising:
at least one memory; and
at least one processor coupled with the at least one memory and configured to cause the NCR to:
receive, from a base station, a first signaling indicating a reception beam;
receive a first reference signal from the base station;
receive a second reference signal from an interfering communication device;
perform a channel measurement on the first reference signal with the reception beam applied;
perform an interference measurement on the second reference signal with the reception beam applied;
determine a signal strength comparison based at least in part on the channel measurement and the interference measurement; and
transmit a second signaling as a report of the signal strength comparison to the base station.

2. The NCR of claim 1, wherein the at least one processor is configured to cause the NCR to determine the signal strength comparison as a ratio of signal strengths associated with the first reference signal and the second reference signal.

3. The NCR of claim 1, wherein the at least one processor is configured to cause the NCR to determine the signal strength comparison as at least one of a signal-to-interference ratio (SIR) or a signal-to-interference-plus-noise ratio (SINR).

4. The NCR of claim 1, wherein the at least one processor is configured to cause the NCR to at least one of:
perform the channel measurement to determine a reference signal received power (RSRP) of the first reference signal; or
perform the interference measurement to determine the RSRP of the second reference signal.

5. The NCR of claim 1, wherein the at least one processor is configured to cause the NCR to transmit the second signaling as a channel state information (CSI) report of the signal strength comparison to the base station.

6. The NCR of claim 1, wherein the interfering communication device is at least one of an interfering base station or an interfering user equipment.

7. A base station for wireless communication, comprising:
at least one memory; and
at least one processor coupled with the at least one memory and configured to cause the base station to:
receive a first signaling indicating a reference signal and an associated communication element;
determine that the associated communication element potentially interferes with a user equipment (UE) communication via a network-controlled repeater (NCR);
determine a reception beam associated with the UE communication via the NCR; and
transmit a second signaling indicating the reception beam to the NCR.

8. The base station of claim 7, wherein the associated communication element is at least one of a plurality of time resources, a plurality of frequency resources, one or more spatial relations, a communication channel, or a reference signal.

9. The base station of claim 8, wherein:
the plurality of time resources comprises at least one of a plurality of orthogonal frequency division multiplexing (OFDM) symbols, a plurality of slots, or a time duration; and
the plurality of frequency resources comprises at least one of a frequency band, a frequency sub-band, a carrier frequency, a component carrier, a bandwidth part, or a plurality of physical resource blocks (PRBs).

10. The base station of claim 8, wherein each of the one or more spatial relations comprises at least one of a reference signal identifier (RS ID), a quasi-collocation (QCL) relationship with a reference signal as a source, a transmission configuration indication (TCI), or a spatial relation information parameter.

11. The base station of claim 8, wherein the communication channel comprises at least one of a physical downlink control channel (PDCCH), a physical downlink shared channel (PDSCH), a physical uplink control channel (PUCCH), or a physical uplink shared channel (PUSCH).

12. The base station of claim 8, wherein the reference signal is at least one of a synchronization signal/physical broadcast channel (SS/PBCH) block, a channel state information-reference signal (CSI-RS), or a sounding reference signal (SRS).

13. The base station of claim 7, wherein the at least one processor is configured to cause the base station to:
transmit a second reference signal to the NCR with an applied transmission beam associated with the UE communication; and
receive a third signaling as a report from the NCR, the third signaling indicating an estimate of a signal-to-interference-plus-noise ratio (SINR) based at least in part on an interference measurement on the reference signal and a channel measurement on the second reference signal.

14. The base station of claim 7, wherein the at least one processor is configured to cause the base station to:
transmit, to the UE, a third signaling indicating the UE to transmit a second reference signal to the NCR with an applied transmission beam associated with the UE communication; and
receive a fourth signaling as a report from the NCR, the fourth signaling indicating an estimate of a SINR based at least in part on an interference measurement on the reference signal and a channel measurement on the second reference signal.

15. A method performed by a network-controlled repeater (NCR), the method comprising:
receiving, from a base station, a first signaling indicating a reception beam;
receiving a first reference signal from the base station;
receiving a second reference signal from an interfering communication device;
performing a channel measurement on the first reference signal with the reception beam applied;
performing an interference measurement on the second reference signal with the reception beam applied;
determining a signal strength comparison based at least in part on the channel measurement and the interference measurement; and
transmitting a second signaling as a report of the signal strength comparison to the base station.

16-20. (canceled)

21. A processor for wireless communication, comprising:
at least one controller coupled with at least one memory and configured to cause the processor to:
receive, from a base station, a first signaling indicating a reception beam;
receive a first reference signal from the base station;
receive a second reference signal from an interfering communication device;
perform a channel measurement on the first reference signal with the reception beam applied;
perform an interference measurement on the second reference signal with the reception beam applied;
determine a signal strength comparison based at least in part on the channel measurement and the interference measurement; and
transmit a second signaling as a report of the signal strength comparison to the base station.

22. The processor of claim 21, wherein the at least one controller is configured to cause the processor to determine the signal strength comparison as a ratio of signal strengths associated with the first reference signal and the second reference signal.

23. The processor of claim 21, wherein the at least one controller is configured to cause the processor to determine the signal strength comparison as at least one of a signal-to-interference ratio (SIR) or a signal-to-interference-plus-noise ratio (SINR).

24. The processor of claim 21, wherein the at least one controller is configured to cause the processor to at least one of:
perform the channel measurement to determine a reference signal received power (RSRP) of the first reference signal; or
perform the interference measurement to determine the RSRP of the second reference signal.

25. The processor of claim 21, wherein the at least one controller is configured to cause the processor to transmit the second signaling as a channel state information (CSI) report of the signal strength comparison to the base station.
